(19) United States
(12) Patent Application Publication
(10) Pub. No.: US 2025/0200588 A1
(43) Pub. Date: Jun. 19, 2025

(54) GLOBAL BAG TAG SYSTEM AND METHOD OF USE

(71) Applicant: Craig MATEER, Orlando, FL (US)

(72) Inventor: Craig MATEER, Orlando, FL (US)

(21) Appl. No.: 18/851,208

(22) PCT Filed: Jan. 31, 2024
(86) PCT No.: PCT/US2024/013788

§ 371 Date: Sep. 26, 2024

Related U.S. Application Data
(63) Continuation-in-part of application No. 18/418,972, filed on Jan. 22, 2024.
Application No. 18/418,972 is a continuation of application No. 18/197,840, filed on May 16, 2023, now Pat. No. 11,935,072.
Application No. 18/197,840 is a continuation-in-part of application No. 18/332,377, filed on Jun. 9, 2023, now Pat. No. 11,900,732.
Application No. 18/332,377 is a continuation of application No. 18/201,908, filed on May 25, 2023, now Pat. No. 11,881,057.
Application No. 18/201,908 is a continuation of application No. 18/311,566, filed on May 3, 2023, now Pat. No. 11,948,404.
Application No. 18/311,566 is a continuation of application No. 18/104,359, filed on Feb. 1, 2023, now Pat. No. 11,682,241.
Application No. PCT/US2024/013788 is a continuation-in-part of application No. PCT/US2024/013083, filed on Jan. 26, 2024.
Application No. PCT/US2024/013083 is a continuation-in-part of application No. PCT/US2024/013221, filed on Jan. 26, 2024.
Application No. PCT/US2024/013221 is a continuation-in-part of application No. PCT/US2024/013226, filed on Jan. 26, 2024.
Application No. PCT/US2024/013226 is a continuation-in-part of application No. PCT/US2024/012226, filed on Jan. 19, 2024.
Application No. PCT/US2024/012226 is a continuation-in-part of application No. PCT/US2024/012231, filed on Jan. 19, 2024.
Application No. PCT/US2024/012231 is a continuation-in-part of application No. PCT/US2024/013257, filed on Jan. 27, 2024.
Application No. PCT/US2024/013257 is a continuation-in-part of application No. PCT/US2024/013258, filed on Jan. 27, 2024.
Application No. PCT/US2024/013258 is a continuation-in-part of application No. PCT/US2024/013259, filed on Jan. 27, 2024.
Application No. PCT/US2024/013259 is a continuation-in-part of application No. PCT/US2024/013261, filed on Jan. 27, 2024.
Application No. PCT/US2024/013261 is a continuation-in-part of application No. PCT/US2024/013262, filed on Jan. 27, 2024.
Application No. PCT/US2024/013262 is a continuation-in-part of application No. PCT/US2024/013263, filed on Jan. 27, 2024.
Application No. PCT/US2024/013263 is a continuation-in-part of application No. PCT/US2024/013594, filed on Jan. 30, 2024.
Application No. PCT/US2024/013594 is a continuation-in-part of application No. PCT/US2024/013597, filed on Jan. 30, 2024.
Application No. PCT/US2024/013597 is a continuation-in-part of application No. PCT/US2024/013599, filed on Jan. 30, 2024.
Application No. PCT/US2024/013599 is a continuation-in-part of application No. 18/529,705, filed on Dec. 5, 2023, now Pat. No. 12,014,580.
Application No. 18/529,705 is a continuation-in-part of application No. 18/421,581, filed on Jan. 24, 2024.
Application No. 18/421,581 is a continuation-in-part of application No. 18/421,595, filed on Jan. 24, 2024, now Pat. No. 12,277,806.
Application No. 18/421,595 is a continuation-in-part of application No. 18/421,601, filed on Jan. 24, 2024.
Application No. 18/421,601 is a continuation-in-part of application No. 18/406,785, filed on Jan. 8, 2024, now Pat. No. 12,254,719.
Application No. 18/406,785 is a continuation-in-part of application No. 18/514,015, filed on Nov. 20, 2023, now Pat. No. 12,266,220.
Application No. 18/514,015 is a continuation-in-part of application No. 18/514,826, filed on Nov. 20, 2023, now Pat. No. 12,112,576.
Application No. 18/514,826 is a continuation-in-part of application No. 18/514,195, filed on Nov. 20, 2023.
Application No. 18/514,195 is a continuation-in-part of application No. 18/514,877, filed on Nov. 20, 2023, now Pat. No. 12,112,577.
Application No. 18/514,877 is a continuation-in-part of application No. 18/514,914, filed on Nov. 20, 2023.
Application No. 18/514,914 is a continuation-in-part of application No. 18/514,937, filed on Nov. 20, 2023, now Pat. No. 12,112,578.
Application No. 18/514,937 is a continuation-in-part of application No. 18/514,924, filed on Nov. 20, 2023.
Application No. 18/514,924 is a continuation-in-part of application No. 18/514,295, filed on Nov. 20, 2023, now Pat. No. 12,272,179.
Application No. 18/514,295 is a continuation-in-part of application No. 18/515,004, filed on Nov. 20, 2023, now Pat. No. 12,266,221.
Application No. 18/515,004 is a continuation-in-part of application No. 18/514,369, filed on Nov. 20, 2023.
Application No. 18/514,369 is a continuation-in-part of application No. 18/515,060, filed on Nov. 20, 2023, now Pat. No. 12,131,588.
Application No. 18/515,060 is a continuation-in-part of application No. 18/427,323, filed on Jan. 30, 2024.
Application No. 18/427,323 is a continuation-in-part of application No. 18/427,396, filed on Jan. 30, 2024, now Pat. No. 12,260,681.
Application No. 18/427,396 is a continuation-in-part of application No. 18/427,438, filed on Jan. 30, 2024, now Pat. No. 12,266,219.
Application No. 18/427,438 is a continuation-in-part of application No. 18/427,469, filed on Jan. 30, 2024.
Application No. 18/427,469 is a continuation-in-part of application No. 18/427,516, filed on Jan. 30, 2024.
(60) Provisional application No. 63/598,824, filed on Nov. 14, 2023.
(60) Provisional application No. 63/543,667, filed on Oct. 11, 2023.
(60) Provisional application No. 18/337,288, filed on Jun. 19, 2023.

(51) Int. Cl. G06Q 30/018; G01N 23/046; G01N 23/10; G06K 7/10; G06K 7/14

(52) U.S. Cl. CPC G06Q 30/018; G01N 23/046; G01N 23/10; G06K 7/1413; G06K 2007/10524

(57) ABSTRACT

Provided is a global bag tag system and method of use, the method including: generating, by at least one of at least one processor, a global multi-mode travel (GMMT) bag tag number for a luggage item of a registered passenger, wherein the GMMT bag tag number comprises a permanently assigned license plate compatible with International Air Transport Association (IATA) regulations for a duration that expires after a predetermined useful life; generating, by at least one of the at least one processor, a global tracking expanded baggage source message (GTE-BSM) comprising the GMMT bag tag number and a passenger name of the registered passenger; and forming, by a printing device, a GMMT code indicum representative of the GMMT bag tag number on a substrate configured to be affixed to the luggage item.

### CROSS REFERENCE TO RELATED APPLICATIONS

This application claims the priority benefit of U.S. Provisional Patent Application No. 63/598,824, filed Nov. 14, 2023, and U.S. Provisional Patent Application No. 63/543,667, filed Oct. 11, 2023. This application is also a continuation-in-part of, and claims the priority benefit of, each of: U.S. patent application Ser. No. 18/418,972, filed Jan. 22, 2024, which is a continuation of U.S. patent application Ser. No. 18/197,840, filed May 16, 2023.

This application is also a continuation-in-part of, and claims the priority benefit of, each of: U.S. patent application Ser. No. 18/337,288, filed Jun. 19, 2023, which is a continuation-in-part of U.S. patent application Ser. No. 18/332,377, filed Jun. 9, 2023, which is a continuation of U.S. patent application Ser. No. 18/201,908 filed May 25, 2023 (now U.S. Pat. No. 11,881,057), which is a continuation of U.S. patent application Ser. No. 18/311,566, filed May 3, 2023. Wherein each of application Ser. No. 18/337,288, as a continuation-in-part of, and application Ser. Nos. 18/332,377, 18/201,908, and 18/311,566, as continuations that directly claim the priority benefit of, U.S. patent application Ser. No. 18/104,359 (now U.S. Pat. No. 11,682,241), filed Feb. 1, 2023; and, wherein for the avoidance of doubt and without limiting the generality of the foregoing, application Ser. No. 18/311,566 is a continuation of application Ser. No. 18/104,359.

This application is also based on and claims the priority benefit of the following co-pending applications: International Application Nos. PCT/US2024/013083, PCT/US24/13221, and PCT/US24/13226, all filed on Jan. 26, 2024; International Application Nos. PCT/US2024/012226 and PCT/US2024/012231, both filed on Jan. 19, 2024; International Application Nos. PCT/US24/13257, PCT/US24/13258, PCT/US24/13259, PCT/US24/13261, PCT/US24/13262, and PCT/US24/13263, all filed on Jan. 27, 2024; and International Application Nos. PCT/US24/13594, PCT/US24/13597 and PCT/US24/13599, all filed on Jan. 30, 2024.

This application is also a continuation-in-part of, and claims the priority and benefit of the following co-pending applications: U.S. patent application Ser. No. 18/529,705, filed on Dec. 5, 2023, and U.S. patent application Ser. Nos. 18/421,581, 18/421,595, and 18/421,601, all filed on Jan. 24, 2024, which are continuations of U.S. patent application Ser. No. 18/337,288; U.S. patent application Ser. No. 18/418,972, filed on Jan. 22, 2024; U.S. patent application Ser. No. 18/406,785, filed Jan. 8, 2024; and U.S. patent applications Ser. Nos. 18/514,015, 18/514,826, 18/514,195, 18/514,877, 18/514,914, 18/514,937, 18/514,924, 18/514,295, 18/515,004, 18/514,369 and 18/515,060, all filed on Nov. 20, 2023; and U.S. patent application Ser. Nos. 18/427,323, 18/427,396, 18/427,438, 18/427,469, and 18/427,516, all filed on Jan. 30, 2024.

All of the foregoing are incorporated herein by reference in full.

### BACKGROUND

### 1. Field

The embodiments relate to the field of baggage handling and delivery, and more specifically, to a global bag tag system and method of use.

### 2. Description of the Related Art

Millions of passengers travel daily using various modes of transportation. When families or groups travel, their luggage items can impact their travel experience and limit short excursions at a destination point. The challenge impacting the travel experience is the handling of luggage items. Families often have trouble fitting all the family members and their luggage items into a single vehicle (i.e., rental car or taxi). Another challenge for traveling families can be security of their luggage items before arriving at a lodging entity or cruise ship, for example, left unattended while experiencing an excursion.

Lodging entities or resorts can provide storage of luggage items until official check-in to the accommodations. However, arriving at the lodging entity or resort may not be convenient relative to an excursion prior to check-in.

### SUMMARY

According to an aspect of the disclosure, a method includes: generating, by at least one of at least one processor, a global multi-mode travel (GMMT) bag tag number for a luggage item of a registered passenger, wherein the GMMT bag tag number includes a permanently assigned license plate compatible with International Air Transport Association (IATA) regulations for a duration that expires after a predetermined useful life; generating, by at least one of the at least one processor, a global tracking expanded baggage source message (GTE-BSM) including the GMMT bag tag number and a passenger name of the registered passenger; and forming, by a printing device, a GMMT code indicum representative of the GMMT bag tag number on a substrate configured to be affixed to the luggage item.

The method may further include: receiving, by at least one of the at least one processor, current journey information representative of at least one travel membership number for the registered passenger, a passenger name record (PNR) number for the registered passenger, or an itinerary confirmation (IC) number for the registered passenger; and building, by at least one of the at least one processor, a baggage travel journey record based on the current journey information for the luggage item of the registered passenger, wherein the baggage travel journey record includes a luggage delivery location and a luggage pickup location.

The method may further include: determining, by at least one of the at least one processor, a number of luggage items associated with the registered passenger for the current journey information; and linking, by at least one of the at least one processor, the GMMT bag tag number to each luggage item associated with the registered passenger for the current journey information.

The method may further include: accessing, by at least one of the at least one processor, a database associated with the at least one travel membership number, the PNR number, or the IC number to obtain other passenger names associated with the current journey information of the registered passenger; and linking, by at least one of the at least one processor, the GMMT bag tag number with the other passenger names associated with the current journey information.

The building, by at least one of the at least one processor, the baggage travel journey record based on the current journey information may include: building, by at least one of the at least one processor, the baggage travel journey record based on the current journey information for luggage items of the other passenger names.

The method may further include: receiving, by at least one of the at least one processor, preferential multi-mode (PMM) travel information from a computing device of the registered passenger; and generating, by at least one of the at least one processor, a database of stored passenger information associated with the luggage item identifying the PMM travel information linked to the GMMT bag tag number, wherein the generating, by at least one of the at least one processor, the GMMT bag tag number, may further include: generating, by at least one of the at least one processor, at least one PMM travel code.

The forming, by the printing device, the GMMT code indicum on the substrate may further include: forming, by the printing device, at least one PMM travel code indicum representative of the at least one PMM travel code in series with or adjacent to the GMMT code indicum on the substrate.

The PMM travel information may include one or more travel management system numbers of the registered passenger or an online travel booking engine number of the registered passenger.

The the PMM travel information may include one or more travel membership numbers of the registered passenger.

The one or more travel membership numbers may include one or more of: a frequent flyer number of an airline company; a hotel membership number of a hotel company; a rental car membership number of a rental car company; and a cruise line membership number of a cruise line company.

The method may further include: receiving, by at least one of the at least one processor, current journey information representative of a travel membership number, a PNR number or an itinerary confirmation number; and building, by at least one of the at least one processor, a baggage travel journey record based on the PMM travel information and the current journey information.

The building of the baggage travel journey record based on the PMM travel information may include one or more of: querying, by at least one of the at least one processor, a reservation system associated with the airline company for a destination airport location of a baggage travel journey; querying, by at least one of the at least one processor, a reservation system associated with the hotel company for a hotel reservation location for the baggage travel journey; and querying, by at least one of the at least one processor, a reservation system associated with the cruise line company for a cruise reservation location for the baggage travel journey, and wherein the method may further include: populating, by at least one of the at least one processor, the baggage travel journey record with one or more of the destination airport location, the hotel reservation location, or the cruise reservation location.

The duration may be renewable.

The predetermined useful life may be coextensive with a lifetime of the registered passenger.

According to an aspect of the disclosure, a system includes: at least one processor; and at least one non-transitory, tangible memory communicatively coupled to the at least one processor, the at least one memory storing at least one instruction, wherein the at least one processor is configured to execute the at least one instruction to: generate a global multi-mode travel (GMMT) bag tag number for a luggage item of a registered passenger, wherein the GMMT bag tag number includes a permanently assigned license plate compatible with International Air Transport Association (IATA) regulations for a duration that expires after a predetermined useful life, generate a global tracking expanded baggage source message (GTE-BSM) that includes the GMMT bag tag number and a passenger name of the registered passenger, and cause a printing device to form a GMMT code indicum representative of the GMMT bag tag number on a substrate to be affixed to the luggage item.

The at least one processor of the system may be further configured to execute the at least one instruction to: receive current journey information representative of at least one travel membership number for the registered passenger, a passenger name record (PNR) number for the registered passenger, or an itinerary confirmation (IC) number for the registered passenger, and build a baggage travel journey record based on the current journey information for the luggage item of the registered passenger, wherein the baggage travel journey record may include a luggage delivery location and a luggage pickup location.

The at least one processor of the system may be further configured to execute the at least one instruction to: determine a number of luggage items associated with the registered passenger for the current journey information, and link the GMMT bag tag number to each luggage item associated with the registered passenger for the current journey information.

The at least one processor of the system may be further configured to execute the at least one instruction to: access a database associated with the at least one travel membership number, the PNR number, or the IC number to obtain other passenger names associated with the current journey information of the registered passenger, and link the GMMT bag tag number with the other passenger names associated with the current journey information.

The at least one processor of the system may be further configured to execute the at least one instruction to: build the baggage travel journey record based on the current journey information for luggage items of the other passenger names.

The at least one processor of the system may be further configured to execute the at least one instruction to: receive preferential multi-mode (PMM) travel information from a computing device of the registered passenger, generate a database of stored passenger information associated with the luggage item identifying the PMM travel information linked to the GMMT bag tag number, and generate at least one PMM travel code contemporaneously with the generation of the GMMT bag tag number.

The at least one processor of the system may be further configured to execute the at least one instruction to: cause the printing device to form at least one PMM travel code indicum representative of the at least one PMM travel code in series with or adjacent to the GMMT code indicum on the substrate.

The PMM travel information may include one or more travel management system numbers of the registered passenger or an online travel booking engine number of the registered passenger.

The PMM travel information may include one or more travel membership numbers of the registered passenger.

The one or more travel membership numbers may include one or more of: a frequent flyer number of an airline company, a hotel membership number of a hotel company, a rental car membership number of a rental car company, and a cruise line membership number of a cruise line company.

The at least one processor of the system may be further configured to execute the at least one instruction to: receive current journey information representative of at least one travel membership number, a PNR number, or an itinerary confirmation number, and build a baggage travel journey record based on the PMM travel information and the current journey information.

The at least one processor of the system may be further configured to execute the at least one instruction to: build the baggage travel journey record based on the PMM travel information by: querying a reservation system associated with the airline company for a destination airport location of a baggage travel journey, querying a reservation system associated with the hotel company for a hotel reservation location for the baggage travel journey, and querying a reservation system associated with the cruise line company for a cruise reservation location for the baggage travel journey, and wherein the at least one processor of the system may be further configured to execute the at least one instruction to: populate the baggage travel journey record with one or more of the destination airport location, the hotel reservation location, or the cruise reservation location.

The duration may be renewable.

The predetermined useful life may be coextensive with a lifetime of the registered passenger.

According to an aspect of the disclosure, a non-transitory computer readable medium having instructions stored therein, which when executed by at least one processor cause the at least one processor to execute a method including: generating, by at least one of the at least one processor, a global multi-mode travel (GMMT) bag tag number for a luggage item of a registered passenger, wherein the GMMT bag tag number includes a permanently assigned license plate compatible with International Air Transport Association (IATA) regulations for a duration that expires after a predetermined useful life; generating, by at least one of the at least one processor, a global tracking expanded baggage source message (GTE-BSM) including the GMMT bag tag number and a passenger name of the registered passenger; and forming, by a printing device, a GMMT code indicum representative of the GMMT bag tag number on a substrate configured to be affixed to the luggage item.

With regard to the method executed in response to the instructions stored in the non-transitory computer readable medium, the method may further include: receiving, by the processor, current journey information representative of at least one travel membership number for the registered passenger, a passenger name record (PNR) number for the registered passenger, or an itinerary confirmation (IC) number for the registered passenger; and building, by at least one of the at least one processor, a baggage travel journey record based on the current journey information for the luggage item of the registered passenger, wherein the baggage travel journey record may include a luggage delivery location and a luggage pickup location.

With regard to the method executed in response to the instructions stored in the non-transitory computer readable medium, the method may further include: determining, by at least one of the at least one processor, a number of luggage items associated with the registered passenger for the current journey information; and linking, by at least one of the at least one processor, the GMMT bag tag number to each registered luggage item of the registered passenger for the current journey information.

With regard to the method executed in response to the instructions stored in the non-transitory computer readable medium, the method may further include: accessing, by at least one of the at least one processor, a database associated with the at least one travel membership number, the PNR number, or the IC number to obtain other passenger names associated with the current journey information of the registered passenger; and linking, by at least one of the at least one processor, the GMMT bag tag number with the other passenger names associated with the current journey information.

With regard to the method executed in response to the instructions stored in the non-transitory computer readable medium, the building, by at least one of the at least one processor, the baggage travel journey record based on the current journey information may include: building, by at least one of the at least one processor, the baggage travel journey record based on the current journey information for luggage items of the other passenger names.

With regard to the method executed in response to the instructions stored in the non-transitory computer readable medium, the method may further include: receiving, by at least one of the at least one processor, preferential multi-mode (PMM) travel information from a computing device of the registered passenger; and generating, by at least one of the at least one processor, a database of stored passenger information associated with the luggage item identifying the PMM travel information linked to the GMMT bag tag number; wherein the generating, by at least one of the at least one processor, the GMMT bag tag number, may further include: generating, by at least one of the at least one processor, at least one PMM travel code.

With regard to the method executed in response to the instructions stored in the non-transitory computer readable medium, the forming, by the printing device, the GMMT code indicum on the substrate may further include: forming, by the printing device, at least one PMM travel code indicum representative of the PMM travel code in series with or adjacent to the GMMT code indicum on the substrate.

With regard to the method executed in response to the instructions stored in the non-transitory computer readable medium, the PMM travel information may include one or more travel management system numbers of the registered passenger or an online travel booking engine number of the registered passenger.

With regard to the method executed in response to the instructions stored in the non-transitory computer readable medium, the PMM travel information may include one or more travel membership numbers of the registered passenger.

With regard to the method executed in response to the instructions stored in the non-transitory computer readable medium, the one or more travel membership numbers may include one or more of: a frequent flyer number of an airline company; a hotel membership number of a hotel company; a rental car membership number of a rental car company; and a cruise line membership number of a cruise line company.

With regard to the method executed in response to the instructions stored in the non-transitory computer readable medium, the method may further include: receiving, by at least one of the at least one processor, current journey information representative of at least one travel membership number, a PNR number or an itinerary confirmation number; and building, by at least one of the at least one processor, a baggage travel journey record based on the PMM travel information and the current journey information.

With regard to the method executed in response to the instructions stored in the non-transitory computer readable medium, the building of the baggage travel journey record based on the PMM travel information may include one or more of: querying, by at least one of the at least one processor, a reservation system associated with the airline company for a destination airport location of a baggage travel journey; querying, by at least one of the at least one processor, a reservation system associated with the hotel company for a hotel reservation location for the baggage travel journey; and querying, by at least one of the at least one processor, a reservation system associated with the cruise line company for a cruise reservation location for the baggage travel journey, and the method may further include: populating, by at least one of the at least one processor, the baggage travel journey record with one or more of the destination airport location, the hotel reservation location, or the cruise reservation location.

With regard to the method executed in response to the instructions stored in the non-transitory computer readable medium, the duration may be renewable.

With regard to the method executed in response to the instructions stored in the non-transitory computer readable medium, the predetermined useful life may be coextensive with a lifetime of the registered passenger.

According to an aspect of the disclosure, a method includes: electronically acquiring, by at least one electronic acquiring device, an electronic representation of a global multi-mode travel (GMMT) code indicum from a substrate associated with a global bag tag on a first luggage item of a registered passenger to create a digital GMMT data record linked to the registered passenger, wherein the GMMT code indicum is an International Air Transport Association (IATA) compatible license plate; accessing, by a first processor, a global tracking expanded baggage source message (GTE-BSM) containing a passenger name record (PNR) number of the registered passenger using a unique identifier representative of the digital GMMT data record from a computer system associated with a multi-mode baggage handling service; receiving, by the first processor, information that confirms an identity of the registered passenger associated with the PNR number; and linking, by at least one second processor in communication with the first processor, the GTE-BSM of the registered passenger to each different airline baggage source message (A-BSM) associated with each different luggage item associated with a traveling passenger name associated with the PNR number in the GTE-BSM.

The method may further include: checking in, by at least one of the at least one second processor, the first luggage item of the registered passenger within a check-in window, for a leg of travel with an air carrier; and causing, by at least one of the at least one second processor, creation of an originating IATA license plate for the first luggage item associated with the leg of travel with the air carrier.

Each A-BSM may be an IATA compatible baggage source message (BSM).

The method may further include: accessing, by at least one of the at least one second processor, a database associated with the PNR number to obtain names of non-registered passengers associated with current journey information of the registered passenger; generating, by at least one of the at least one second processor, separate temporary baggage source messages (T-BSMs) respectively corresponding to each separate luggage item of each non-registered passenger based on the PNR number; and linking the separate T-BSM corresponding to each separate luggage item of each non-registered passenger to the GTE-BSM.

The method may further include: checking-in, by at least one of the at least one second processor, each different luggage item of the non-registered passengers identified in the database associated with the PNR number, wherein each different luggage item associated with the non-registered passengers has a different A-BSM; and causing, by at least one of the at least one second processor, a printing device to print an IATA luggage bag tag with a created IATA license plate for each checked-in luggage item of the non-registered passengers.

The receiving, by the first processor, the information that confirms the identity of the registered passenger may include: capturing, by an imaging device in communication with the first processor, an image of the registered passenger; and performing facial recognition based on the image of the registered passenger and a stored image of the registered passenger.

The method may further include: capturing, by the imaging device in communication with the first processor, an image of each separate luggage item of other traveling passenger names associated with the PNR number, prior to departing a luggage pickup location.

The method may further include, prior to the electronically acquiring: registering, by at least one of the at least one second processor, a passenger with the multi-mode baggage handling service; and generating, by at least one of the at least one second processor, a GTE-BSM including a passenger name of the registered passenger and the unique identifier, wherein the unique identifier may include a GMMT bag tag number representative of the GMMT code indicum, wherein the GMMT bag tag number includes a permanently assigned license plate compatible with an IATA license plate format for a duration that expires after a predetermined useful life.

The method may further include: automatically creating, by at least one of the at least one second processor, a luggage item manifest record from the digital GMMT data record and the PNR number.

The duration may be renewable and the predetermined useful life may be in a range of one month to 10 years or one month to 20 years.

The predetermined useful life may be coextensive with a lifetime of the registered passenger.

According to an aspect of the disclosure, a system includes: at least one processor; and at least one non-transitory, tangible memory communicatively coupled to the at least one processor, the at least one memory storing at least one instruction, wherein the at least one processor is configured to execute the at least one instruction to: obtain, from at least one electronic acquiring device, an electronic representation of a global multi-mode travel (GMMT) code indicum associated with a global bag tag on a first luggage item of a registered passenger to create a digital GMMT data record linked to the registered passenger, wherein the GMMT code indicum is an International Air Transport Association (IATA) compatible license plate; access a global tracking expanded baggage source message (GTE-BSM) containing a passenger name record (PNR) number of the registered passenger using a unique identifier representative of the digital GMMT data record from a computer system associated with a multi-mode baggage handling service; receive information that confirms an identify of the registered passenger associated with the PNR number; and link the GTE-BSM of the registered passenger to each different airline baggage source message (A-BSM) for each different luggage item associated with a traveling passenger name associated with the PNR number in the GTE-BSM.

The at least one processor of the system may be further configured to execute the at least one instruction to: check in the first luggage item of the registered passenger within a check-in window, for a leg of travel with an air carrier; and cause creation of an originating IATA license plate for the first luggage item associated with the leg of travel with the air carrier.

Each A-BSM is an IATA compatible baggage source message (BSM).

The at least one processor of the system may be further configured to execute the at least one instruction to: access a database associated with the PNR number to passenger names of non-registered passengers associated with current journey information of the registered passenger; generate separate temporary baggage source messages (T-BSMs) respectively corresponding to each separate luggage item of each non-registered passenger based on the PNR number; and link the separate T-BSMs corresponding to each separate luggage item of each non-registered passenger to the GTE-BSM.

The at least one processor of the system may be further configured to execute the at least one instruction to: check in each separate luggage item of the non-registered passengers identified in the database associated with the PNR number; and cause a printing device to print an IATA luggage bag tag with a created IATA license plate for each checked-in luggage item of the non-registered passengers.

The information that confirms an identify of the registered passenger may include an image of the registered passenger captured by an imaging device in communication with the at least one processor, and the at least one processor of the system may be further configured to execute the at least one instruction to: perform facial recognition based on the image of the registered passenger and a stored image of the registered passenger.

The at least one processor of the system may be further configured to execute the at least one instruction to: receive, from the imaging device in communication with the at least one processor, a captured image of each luggage item of the traveling passenger name associated with the PNR number, prior to departing a luggage pickup location.

The at least one processor of the system may be further configured to execute the at least one instruction to, prior to the obtaining the electronic representation of the GMMT: register a passenger with the multi-mode baggage handling service; and generate a GTE-BSM including a passenger name of the registered passenger and the unique identifier, wherein the unique identifier may include a GMMT bag tag number representative of the GMMT code indicum, and wherein the GMMT bag tag number may include a permanently assigned license plate compatible with an IATA license plate format for a duration that expires after a predetermined useful life.

The at least one processor of the system may be further configured to execute the at least one instruction to: automatically create a luggage item manifest record from the digital GMMT data record and the PNR number.

The duration may be renewable and the predetermined useful life may be in a range of one month to 10 years or one month to 20 years.

The predetermined useful life may be coextensive with a lifetime of the registered passenger.

According to an aspect of the disclosure, a non-transitory computer readable medium having instructions stored therein, which when executed by at least one processor cause the at least one processor to execute a method including: obtaining, from at least one electronic acquiring device, an electronic representation of a global multi-mode travel (GMMT) code indicum from a substrate associated with a global bag tag on a first luggage item of a registered passenger to create a digital GMMT data record linked to the registered passenger, wherein the GMMT code indicum is an International Air Transport Association (IATA) compatible license plate; accessing, by a first processor, a global tracking expanded baggage source message (GTE-BSM) containing a passenger name record (PNR) number of the registered passenger using a unique identifier representative of the digital GMMT data record from a computer system associated with a multi-mode baggage handling service; receiving, by the first processor, information that confirms an identity of the registered passenger associated with the PNR number; and linking, by at least one second processor in communication with the first processor, the GTE-BSM of the registered passenger to each different airline baggage source message (A-BSM) associated with each different luggage item associated with a traveling passenger name associated with the PNR number in the GTE-BSM.

With regard to the method executed in response to the instructions stored in the non-transitory computer readable medium, the method may further include: checking in, by at least one of the at least one second processor, the first luggage item of the registered passenger within a check-in window, for a leg of travel with an air carrier; and causing, by at least one of the at least one second processor, creation of an originating IATA license plate for the first luggage item associated with the leg of travel with the air carrier.

With regard to the method executed in response to the instructions stored in the non-transitory computer readable medium, each A-BSM may be an IATA compatible baggage source message (BSM).

With regard to the method executed in response to the instructions stored in the non-transitory computer readable medium, the method may further include: accessing, by at least one of the at least one second processor, a database associated with the PNR number to obtain names of non-registered passengers associated with the current journey information of the registered passenger; generating, by at least one of the at least one second processor, separate temporary baggage source messages (T-BSMs) respectively corresponding to each separate luggage item of each non-registered passenger based on the PNR number; and linking the separate T-BSM corresponding to each separate luggage item of each non-registered passenger to the GTE-BSM.

With regard to the method executed in response to the instructions stored in the non-transitory computer readable medium, the method may further include: checking in, by at least one of the at least one second processor, each separate luggage item of the non-registered passengers identified in the database associated with the PNR number wherein each luggage item associated with the non-registered passengers has a different A-BSM; and causing, by at least one of the at least one second processor, a printing device to print an IATA luggage bag tag with a created IATA license plate for each checked-in luggage item of the non-registered passengers.

With regard to the method executed in response to the instructions stored in the non-transitory computer readable medium, the receiving, by the first processor, the information that confirms the identity of the registered passenger may include: receiving, from an imaging device in communication with the first processor, a captured image of the registered passenger; and performing facial recognition based on the captured image of the registered passenger and a stored image of the registered passenger.

With regard to the method executed in response to the instructions stored in the non-transitory computer readable medium, the method may further include: receiving, from the imaging device in communication with the first processor, a captured image of each different luggage item of the traveling passenger name associated with the PNR number, prior to departing a luggage pickup location.

With regard to the method executed in response to the instructions stored in the non-transitory computer readable medium, the method may further include, prior to the obtaining: registering, by at least one of the at least one second processor, a passenger with the multi-mode baggage handling service; and generating, by at least one of the at least one second processor, a GTE-BSM including a passenger name of the registered passenger and the unique identifier, wherein the unique identifier may include a GMMT bag tag number representative of the GMMT code indicum, and wherein the GMMT bag tag number may include a permanently assigned license plate compatible with an IATA license plate format for a duration that expires after a predetermined useful life.

With regard to the method executed in response to the instructions stored in the non-transitory computer readable medium, the method may further include: automatically creating, by at least one of the at least one second processor, a luggage item manifest record from the digital GMMT data record and the PNR number.

With regard to the method executed in response to the instructions stored in the non-transitory computer readable medium, the duration may be renewable and the predetermined useful life may be in a range of one moth to 10 years or one month to 20 years.

With regard to the method executed in response to the instructions stored in the non-transitory computer readable medium, the predetermined useful life may be coextensive with a lifetime of the registered passenger.

According to an aspect of the disclosure, a system includes: at least one processor; and at least one non-transitory, tangible memory communicatively coupled to the at least one processor, the at least one memory storing at least one instruction, wherein the at least one processor is configured to execute the at least one instruction to: link a global multi-mode travel (GMMT) bag tag number to at least one travel membership number for a registered passenger to access reservation information associated with at least one vehicle of travel associated with the at least one travel membership number; collect reservation information in a registered passenger profile linked to the GMMT bag tag number for a current travel journey of at least one luggage item to travel independently of or parallel to the registered passenger; and build a baggage travel journey record (BTJR) for pickup and delivery of the at least one luggage item based on the collected reservation information, wherein the BTJR is linked to the GMMT bag tag number.

The system may further include: an electronic acquiring device configured to acquire an electronic representation of the GMMT bag tag number on a substrate of a permanent bag tag on a first luggage item of the at least one luggage item, wherein the at least one processor may be further configured to execute the at least one instruction to: obtain from the electronic acquiring device the electronic representation of the GMMT bag tag number; retrieve information from at least one luggage handling field of the BTJR associated with the GMMT bag tag number; and cause a display device to display the the retrieved information.

The permanent bag tag may include a GMMT code indicum including the GMMT bag tag number, and the GMMT bag tag number may be compatible with an International Air Transport Association (IATA) license plate.

The GMMT code indicum may include at least one code that is representative of the at least one travel membership number.

The at least one travel membership number may include one or more of: a frequent flyer number of an airline company; a hotel membership number of a hotel company; a rental car membership number of a rental car company; or a cruise line membership number of a cruise line company.

The at least one processor of the system may be further configured to execute the at least one instruction to: collect the reservation information by performing one or more of: querying a reservation system associated with the airline company for a destination airport location of a baggage travel journey; querying a reservation system associated with the hotel company for a hotel reservation location for the baggage travel journey; or querying a reservation system associated with the cruise line company for a cruise reservation location for the baggage travel journey; and populate the BTJR with one or more of the destination airport location, the hotel reservation location, or the cruise reservation location.

The system may further include: an electronic acquiring device configured to acquire an electronic representation of the GMMT bag tag number from a permanent bag tag on a first luggage item of the at least one luggage item, and to send the electronic representation of the GMMT bag tag number, location data, and a time stamp of the electronic acquiring device to the registered passenger profile, wherein the location data may be representative of a current location of the first luggage item at the time the GMMT bag tag number is acquired.

The at least one processor of the system may be further configured to execute the at least one instruction to: perform data analytics to push advertisements to a mobile communication device associated with the registered passenger.

The at least one processor of the system may be further configured to execute the at least one instruction to: link the GMMT bag tag number to an International Air Transport Association (IATA) license plate number for a leg of travel in the current travel journey; and link the GMMT bag tag number to a passenger name record (PNR) number of a reservation system for the leg of travel associated with the current travel journey.

The at least one processor of the system may be further configured to execute the at least one instruction to: assign a tracking device to a first luggage item of the at least one luggage item of the registered passenger.

According to an aspect of the disclosure, a method includes: linking, by at least one of at least one processor, a global multi-mode travel (GMMT) bag tag number to at least one travel membership number for a registered passenger to access reservation information associated with at least one vehicle of travel associated with at least one travel membership number; collecting, by at least one of the at least one processor, reservation information, in a registered passenger profile linked to the GMMT bag tag number, for a current travel journey of at least one luggage item to travel independently of or parallel to the registered passenger; and building, by at least one of the at least one processor, a baggage travel journey record (BTJR) for pickup and delivery of the at least one luggage item based on the collected reservation information, wherein the BTJR is linked to the GMMT bag tag number.

The method may further include: obtaining from an electronic acquiring device, by at least one of the at least one processor, an electronic representation of the GMMT bag tag number on a permanent bag tag; retrieving, by at least one of the at least one processor, information from at least one luggage handling field of the BTJR associated with the GMMT bag tag number; and causing, by at least one of the at least one processor, a display device to display the retrieved information.

The permanent bag tag may include a GMMT code indicum that includes the GMMT bag tag number, and the GMMT bag tag number may be compatible with an International Air Transport Association (IATA) license plate.

The GMMT code indicum may include at least one code that is representative of the at least one travel membership number.

The at least one travel membership number may include one or more of: a frequent flyer number of an airline company; a hotel membership number of a hotel company; a rental car membership number of a rental car company; or a cruise line membership number of a cruise line company.

The collecting the reservation information may include: querying, by at least one of the at least one processor, a reservation system associated with the airline company for a destination airport location of a baggage travel journey; querying, by at least one of the at least one processor, a reservation system associated with the hotel company for a hotel reservation location for the baggage travel journey; or querying, by at least one of the at least one processor, a reservation system associated with the cruise line company for a cruise reservation location for the baggage travel journey; and the method may further include: populating, by at least one of the at least one processor, the BTJR with one or more of the destination airport location, the hotel reservation location, or the cruise reservation location.

The method may further include: obtaining, by at least one of the at least one processor, an electronic representation of the GMMT bag tag number acquired by an electronic acquiring device, wherein the GMMT bag tag number may be associated with a permanent bag tag on a first luggage item of the at least one luggage item of the registered passenger, location data, and a time stamp of the electronic acquiring device to the registered passenger profile, wherein the location data may be representative of a current location of the first luggage item at the time the GMMT bag tag number is acquired.

The method may further include: performing, by at least one of the at least one processor, data analytics to push advertisements to a mobile communication device associated with the registered passenger.

The method may further include: linking, by at least one of the at least one processor, the GMMT bag tag number to an International Air Transport Association (IATA) license plate number for a leg of travel in the current travel journey; and linking, by at least one of the at least one processor, the GMMT bag tag number to a passenger name record (PNR) number of a reservation system for the leg of travel associated with the current travel journey.

The method may further include: assigning, by at least one of the at least one processor, a tracking device to a first luggage item of the at least one luggage item of the registered passenger.

According to an aspect of the disclosure, a non-transitory computer readable medium having instructions stored therein, which when executed by at least one processor cause the at least one processor to execute a method including: linking, by at least one of at least one processor, a global multi-mode travel (GMMT) bag tag number to at least one travel membership number for a registered passenger to access reservation information associated with at least one vehicle of travel associated with at least one travel membership number; collecting, by at least one of the at least one processor, reservation information, in a registered passenger profile linked to the GMMT bag tag number, for a current travel journey of at least one luggage item to travel independently of or parallel to the registered passenger; and building, by at least one of the at least one processor, a baggage travel journey record (BTJR) for pickup and delivery of the at least one luggage item based on the collected reservation information, wherein the BTJR is linked to the GMMT bag tag number.

With regard to the method executed in response to the instructions stored in the non-transitory computer readable medium, the method may further include: obtaining from an electronic acquiring device, by at least one of the at least one processor, an electronic representation of the GMMT bag tag number on a permanent bag tag; retrieving, by at least one of the at least one processor, information from at least one luggage handling field of the BTJR associated with the GMMT bag tag number; and causing, by at least one of the at least one processor, a display device to display the retrieved information.

With regard to the method executed in response to the instructions stored in the non-transitory computer readable medium, the permanent bag tag may include a GMMT code indicum that includes the GMMT bag tag number, and wherein the GMMT bag tag number may be compatible with an International Air Transport Association (IATA) license plate.

With regard to the method executed in response to the instructions stored in the non-transitory computer readable medium, the GMMT code indicum may include at least one code that may be representative of the at least one travel membership number.

With regard to the method executed in response to the instructions stored in the non-transitory computer readable medium, the at least one travel membership number may include one or more of: a frequent flyer number of an airline company; a hotel membership number of a hotel company; a rental car membership number of a rental car company; or a cruise line membership number of a cruise line company.

With regard to the method executed in response to the instructions stored in the non-transitory computer readable medium, the collecting the reservation information may include: querying, by at least one of the at least one processor, a reservation system associated with the airline company for a destination airport location of a baggage travel journey; querying, by at least one of the at least one processor, a reservation system associated with the hotel company for a hotel reservation location for the baggage travel journey; or querying, by at least one of the at least one processor, a reservation system associated with the cruise line company for a cruise reservation location for the baggage travel journey; and the method may further include: populating, by at least one of the at least one processor, the BTJR with one or more of the destination airport location, the hotel reservation location, or the cruise reservation location.

With regard to the method executed in response to the instructions stored in the non-transitory computer readable medium, the method may further include: obtaining, by at least one of the at least one processor, an electronic representation of the GMMT bag tag number acquired by an electronic acquiring device, wherein the GMMT bag tag number may be associated with a permanent bag tag on a first luggage item of the at least one luggage item of the registered passenger, location data, and a time stamp of the electronic acquiring device to the registered passenger profile, wherein the location data may be representative of a current location of the first luggage item at the time the GMMT bag tag number is acquired.

With regard to the method executed in response to the instructions stored in the non-transitory computer readable medium, the method may further include: performing, by at least one of the at least one processor, data analytics to push advertisements to a mobile communication device associated with the registered passenger.

With regard to the method executed in response to the instructions stored in the non-transitory computer readable medium, the method may further include: linking, by at least one of the at least one processor, the GMMT bag tag number to an International Air Transport Association (IATA) license plate number for a leg of travel in the current travel journey; and linking, by at least one of the at least one processor, the GMMT bag tag number to a passenger name record (PNR) number of a reservation system for the leg of travel associated with the current travel journey.

With regard to the method executed in response to the instructions stored in the non-transitory computer readable medium, the method may further include: assigning, by at least one of the at least one processor, a tracking device to a first luggage item of the at least one luggage item of the registered passenger.

### BRIEF DESCRIPTION OF THE DRAWINGS

For a fuller understanding of the embodiments, reference should be made to the following detailed disclosure, taken in connection with the accompanying drawings, in which:

FIGS. 1A and 1B illustrate a multi-mode baggage management (MMBM) system for managing transport of at least one luggage item on a baggage travel journey in accordance with an embodiment;

FIG. 2A illustrates a flowchart of a method for generating a permanent bag tag identifier (P-BTI) in accordance with an embodiment;

FIG. 2B illustrates a global bag tag with a P-BTI in accordance with an embodiment;

FIG. 2C illustrates a flowchart of a method for forming a global bag tag in accordance with an embodiment;

FIG. 3A illustrates a flowchart of a method for assigning a tracking device and initiating tracking of a luggage item in accordance with an embodiment;

FIG. 3B illustrates a flowchart of a method for tracking a luggage item in accordance with an embodiment;

FIG. 4A illustrates a flowchart of a method for contactless parking payment in accordance with an embodiment;

FIG. 4B illustrates a flowchart of a method for accessing B-Type messages for travelers using contactless parking payments in accordance with an embodiment;

FIG. 5 illustrates a flowchart of a method for generating and/or updating a luggage item manifest record in accordance with an embodiment;

FIG. 6A illustrates a system for digitizing luggage custody and luggage check-in in accordance with one embodiment;

FIGS. 6B, 6C and 6D illustrate flowcharts of a method for checking-in a passenger and/or generating a luggage item manifest in accordance with an embodiment;

FIG. 7 illustrates an example confirmed itinerary for an air flight in accordance with an embodiment;

FIG. 8 illustrates an airline baggage source message (BSM) format;

FIG. 9A illustrates a global tracking expanded baggage source message (GTE-BSM) format in accordance with an embodiment;

FIG. 9B illustrates a global tracking expanded baggage source message (GTE-BSM) linking structure in accordance with an embodiment;

FIGS. 10A, 10B and 10C illustrate flowcharts of a method for generating a global tracking expanded baggage source message (GTE-BSM) for a registered passenger and/or a temporary baggage source message (T-BSM) for a current travel journey for one or more non-registered passengers in accordance with an embodiment;

FIGS. 11A, 11B and 11C illustrate baggage travel journey records for different travel journeys in accordance with one or more embodiments;

FIG. 12 is a block diagram illustrating an electronic device in a network environment according to one or more embodiments;

FIGS. 13A and 13B illustrate flowcharts of a method for missing, lost, rerouted, delayed, or mishandled luggage item recovery management in accordance with an embodiment;

FIG. 14 illustrates a flowchart of a method for finding a missing, lost, rerouted, delayed, or mishandled luggage item in accordance with an embodiment;

FIG. 15 illustrates a diagram of an anomalous luggage item determination model;

FIG. 16A illustrates a block diagram of a tracking device in accordance with an embodiment;

FIG. 16B illustrates a block diagram of a contactless bag tag printing manager in accordance with an embodiment;

FIG. 16C illustrates a block diagram of a security screening manager in accordance with an embodiment;

FIG. 16D illustrates a block diagram of a mobile-to-tracker pairing manager in accordance with an embodiment;

FIG. 16E illustrates a block diagram of a non-routine reference indicator detection manager in accordance with an embodiment;

FIG. 17A illustrates a block diagram for contactless luggage bag tag printing process using a tracking device in accordance with an embodiment;

FIG. 17B illustrates a block diagram for pseudo identification (ID) recording process using a tracking device in accordance with an embodiment;

FIG. 17C illustrates a diagram for a process to communicate location information from a Global Navigation Satellite System (GNSS) platform in accordance with an embodiment;

FIG. 17D illustrates a diagram of a process of the tracking device to communicate location information with at least one radio frequency (RF) access point in accordance with an embodiment; and

FIG. 18 illustrates a block diagram of a tracking system in accordance with an embodiment.

### DETAILED DESCRIPTION

In the following detailed description, reference is made to the accompanying drawings, which form a part hereof, and within which specific embodiments are shown by way of illustration. It is to be understood that other embodiments may be utilized, and changes may be made without departing from the scope of the disclosure.

### Glossary of Terms

A-BTI means “airline bag tag identifier.” An airline bag tag identifier, also known as a baggage tag or baggage label, is a luggage tag or label attached to a passenger's luggage that contains identifying information about the passenger and their flight on an air carrier. It is used by airlines to track and handle the passenger's checked baggage. The tag carrying the A-BTI usually includes the passenger's name, flight information (flight number, departure and destination airports, and date of travel), and a unique identifier, such as a bag tag number or barcode. A-BTI corresponds to the International Air Transport Association (IATA) license plate that is unique for each luggage, and it is used as reference for the airlines to track the luggage through the baggage handling system (BHS), matching the luggage to the passenger's flight and route, and also to identify the owner of the luggage in case of misplaced, lost or delayed luggage. An A-BTI is usually issued at check-in, and the passenger attaches it to their luggage before they drop it off at the baggage drop-off counter or affixed by the counter agent.

Departure Control System (DCS) refers to the system that controls various airline operations including airport check-in, checking in baggage, generating a passenger bag tag identifier (BTID), and printing of bag tags. The bag tags are formatted based on rules published by IATA and include an IATA 10-digit license plate, for example. Typically, one or more IATA Type-B messages are created that includes the 10-digit license plate and flight information.

Type B (or B-Type) messages refer to a specific format of communication that airlines and other entities in the air travel industry use to transmit and receive critical operational data. These messages are standardized and utilized for a wide range of applications, including flight planning, passenger booking and check-in, luggage tracking, weather updates, and other crucial air transport operations. The Type B messaging standard is overseen by IATA. Compared to more modern data types and formats like XML (extensible markup language) and JSON (JavaScript Object Notation), which carry message payloads, Type B messages employ a stringent structure. Type B messages operate on a “store-and-forward” mechanism, whereby a message sender sends data via their service provider, which is then stored for a contracted period, often seven (7) days. The data is delivered directly to a chosen recipient or via a gateway provider if they exist on a different network. Should delivery fail, contractual agreements allow the data to be re-sent, a contingency reflected in the PDM (Possible Duplicate Message) header.

Lodging Entity means a business or operation providing residential hospitality services such as a hotel, resort, ferry, or cruise ship as non-limiting examples.

Mode of Transportation means a medium or mode of long-distance transport of a traveler or passenger from a point of origin to a destination point. The mode of transportation may include a car, a rental car, a bus, a train, a ferry, an airplane, or any other commercial means of transportation or carriage. A cruise ship may be a mode of transportation.

Multi-Mode Travel means functionally using a B-Type message and an IATA message and expanding the use of such messages all the way to the lodging entity. The IATA message name, the PNR number, and the piece of paper becomes a bag tag for the entire trip and for any mode of travel.

Originating Hardcopy Bag Tag Identifier (OH-BTI) means a unique identifier associated with or printed on a luggage tag from the originating airline travel carrier. In general, every piece of luggage in airline travel is tagged with a unique identifier for tracking purposes. It is typically attached to the luggage at check-in and scanned at various points throughout the journey to ensure the luggage makes it to the correct destination.

P-BTI means “permanent bag tag identifier.” The P-BTI is a special issue bag tag identifier having a portion that is compatible with IATA regulations and is associated with the global multi-mode travel (GMMT) bag tag number for a luggage item of a registered passenger. The P-BTI is an identifier linked to a registered passenger or traveler with a multi-mode baggage handling service. The special issue P-BTI is attached to a passenger's luggage that contains identifying information about the registered passenger and if grouped, traveling passengers associated with the registered passenger. The P-BTI is used by the multi-mode baggage handling service to track and handle the passenger's luggage item(s) and if grouped, those traveling passengers associated with the registered passenger for any vehicle of travel including multiple vehicles of travel. The P-BTI is assigned to the registered passenger for a predetermined useful life. The P-BTI may be renewable and may expire upon death. The portion of P-BTI that is compatible with the IATA regulations may include a character code and/or corresponding numerical code for a non-flying airline carrier.

Passenger Manifest means a record containing an array of data including data for check-in of a return leg of travel of a passenger with a designated return travel carrier.

PNR stands for “Passenger Name Record.” It is a record in the database of an airline or a travel agency that contains all the details of a passenger's itinerary and trip information. This information includes the passenger's name, contact information, flight details, seat preferences, and any special requests. PNR also contains information about the booking, such as the booking date, fare, and ticketing status. It is used by the airlines and travel agencies to manage and keep track of the passenger's itinerary and travel plans. PNR number is unique for at least one passenger, and it's used as reference for the passengers, airlines and travel agencies to the PNR. PNR is also used to check-in, check flight status, and make any changes to the reservation. The PNR number itself is typically 6 characters, often a combination of letters and numbers. While regulatory bodies like IATA do not dictate a universal format for PNRs, each PNR has five (5) mandatory fields including: (1) a phone number associated with a traveler or agent; (2) the last person who made changes in the PNR; (3) the itinerary which must include at least one segment of the journey; (4) the name of the passenger or passengers including full first and last names; and (5) information specifying how and when a ticket is to be issued. Every mode of travel may use a PNR for a travel itinerary. Travel platforms may use a Super PNR that associates several PNRs of a travel itinerary together.

PMM Travel Information stands for “preferential multi-mode” Travel Information. PMM Travel Information includes information in a database associated with travel membership numbers or membership numbers of a travel management system or online travel booking engine. The database may include instructions to access travel reservation information made by a registered passenger using the travel membership number.

Registered Passenger means a person, user or passenger registered to manage transport of at least one luggage item on a baggage travel journey using a global baggage tag identifier.

Travel Management System (TMS) is a type of service that can be accessed by a user online to book one or more reservations for a single trip by finding or offering reservations according to a cheapest rates or discounted rates from different vendors, such as airlines, hotels, and rental car companies. A TMS can include, without limitation, Travelocity®, Expedia®, Orbitz®, Priceline®, Trivago®, Booking.com®, etc. A TMS may include a vacation rental online platform, such as without limitation, Airbnb®, Vrbo®, Vacasa®, Kayak.com®, Hometogo®, etc. A TMA may be an online travel booking engine.

Travel Membership Number (TMN) means a number that is assigned to a user or member of a business entity to earn reward points or discounts that are converted into a non-transferable money value spendable only with the member business entity. The TMN may include a frequent flyer number for an airline, a hotel's membership number, rental car membership number, or cruise line membership number, which is used by a member to book a reservation.

Global Tracking Expanded Baggage Source Message (GTE-BSM) means a baggage source message that is compatible with IATA B-Type messages and which is configured to independently link to reservation information of multiple modes of travel and a global bag tag number. For an airline mode of travel, the GTE-BSM includes fields for the global bag tag number and the originating IATA license plate for a leg of travel for a current travel journey. GTE-BSM includes links to PMM travel information.

Global Multi-Mode Travel (GMMT) Bag Tag Number means a permanently assigned license plate or P-BTI for a luggage item of a registered passenger. The permanently assigned license plate is compatible with IATA regulations for a duration that is renewable or expires after a predetermined useful life of one month or upon death.

Global Bag Tag means a bag tag configured to be affixed to a luggage item for multiple uses that includes a substrate with a GMMT bag tag number printed, engraved, embossed, etched, or otherwise applied on the substrate. The permanently assigned license plate or P-BTI is applied to the substrate with a barcode or quick-response (QR) code that is compatible with IATA regulations. The Global Bag Tag may include a registered passengers name and at least one PMM code associated with the PMM travel information.

Vehicle of Travel (VOT) means a lodging entity and/or a mode of transportation upon which a passenger or luggage item enjoys during a travel journey. The term “vehicle” is not limited to locomotives, ground vehicle, air-borne vehicles, water-borne vehicles, or vehicles that move. Instead, a vehicle is a medium to move, lodge, or provide entertainment to a traveler on a travel journey based on a reservation.

In one or more embodiments, the system may be configured to link disparate travel memberships and modes of travel memberships for a passenger so that the system can access reservations for any vehicle of travel associated with a travel journey for the travel member (i.e., passenger) of the system. This allows the system to collect more accurate information for the journeys of a traveler's luggage item to travel independently of and/or parallel to the traveler.

According to an embodiment, the system may cause one or more reservation systems to provide updates to a baggage travel journey log for changes in a reservation for baggage handling. Alternately, the system may re-query a travel membership's reservation system to determine any changes to a reservation within a travel window, for example.

The system may generate a GTE-BSM which is compatible with IATA regulations. The GTE-BSM may be used by the airline baggage handling systems for handling and transporting a luggage item through the airline infrastructure, outside of the airline infrastructure, and/or where the airline infrastructure and outside of the airline infrastructure overlap.

System 100 may receive updates from a registered passenger for reservation changes or cancellations.

In one or more embodiments, the processor(s) of the system are configured to link a global multi-mode travel (GMMT) bag tag number to at least one travel membership number for a registered passenger to access reservation information associated with the at least one mode of travel associated with the at least one travel membership number associated with the registered passenger. The processor(s) of the system are configured to collect reservation information, in a registered passenger profile linked to the GMMT bag tag number, for a current travel journey of at least one luggage item to travel independently of or parallel to the registered passenger. The processor(s) of the system are configured to build a baggage travel journey record (BTJR) for pickup and delivery of the at least one luggage item based on the collected reservation information, the BTJR being linked to the GMMT bag tag number.

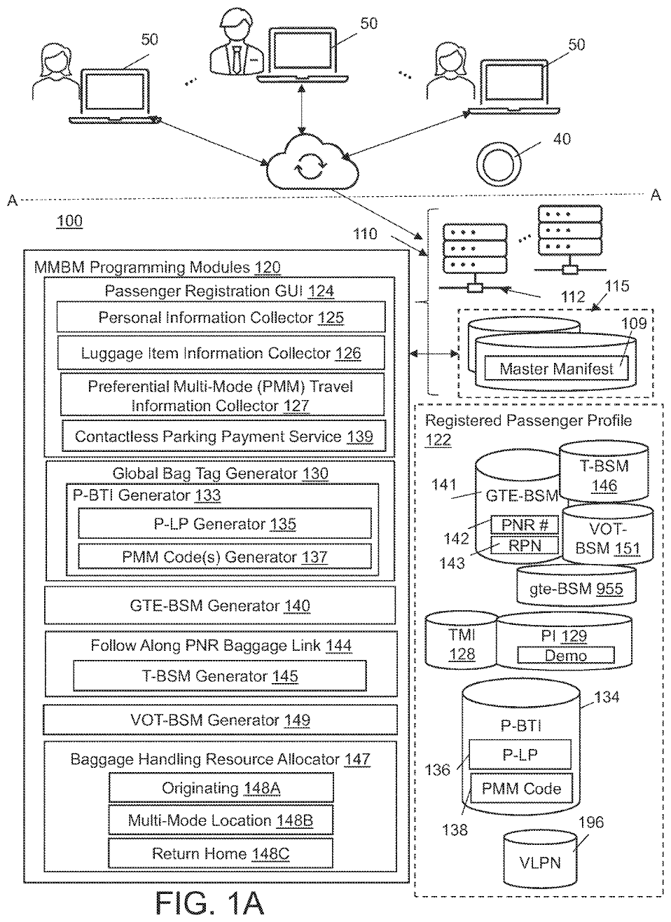

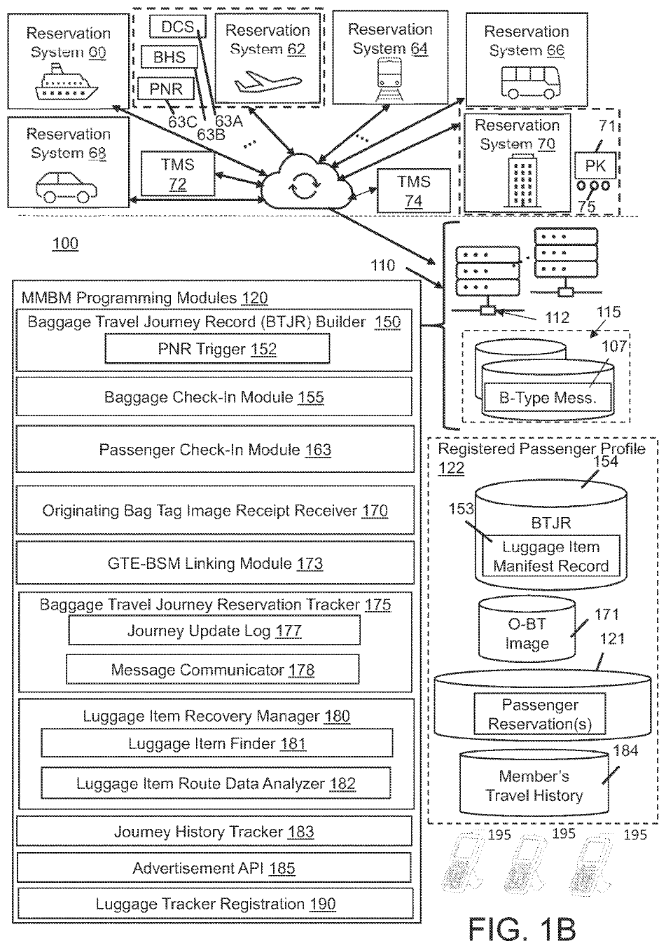

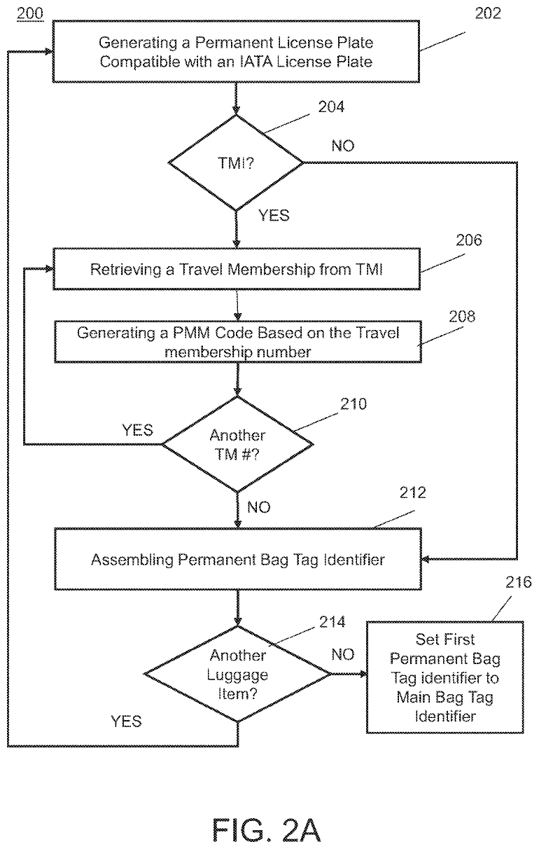

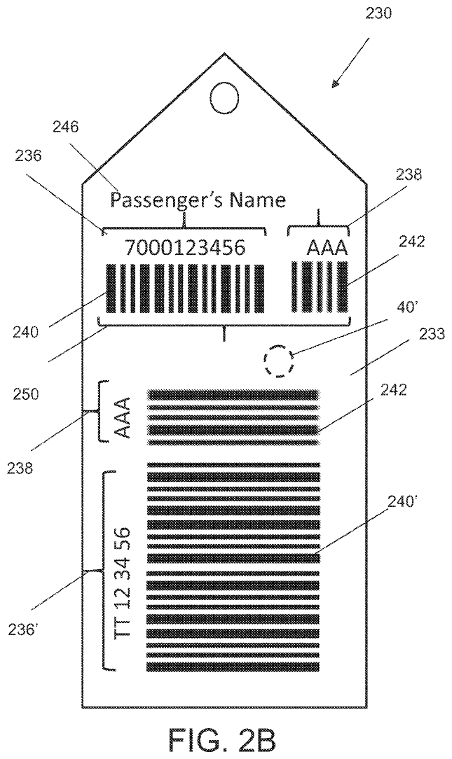

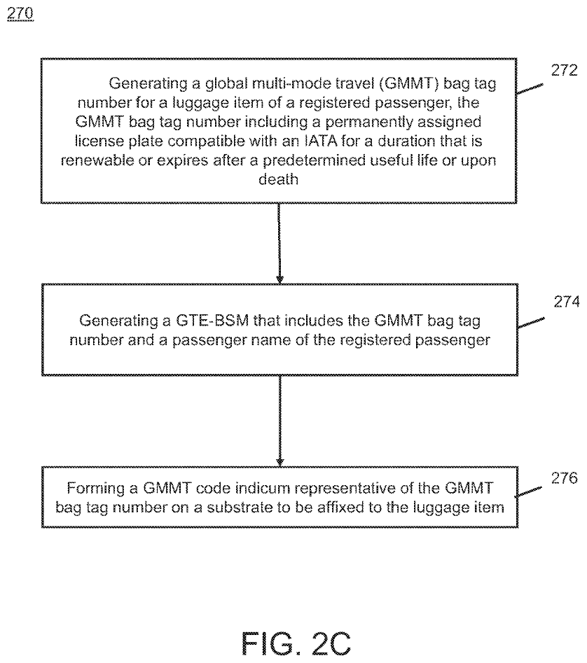

FIGS. 1A and 1B illustrate a multi-mode baggage management (MMBM) system 100 for managing transport of at least one luggage item on a baggage travel journey in accordance with an embodiment. System 100 in FIG. 1A is denoted below dotted line A-A. MMBM system 100 is designed to manage transportation of luggage items for a registered passenger using a P-BTI 134 printed, embossed, etched, engraved, or applied on a substrate 233 of a global bag tag 230 (FIG. 2B) independently and/or parallel to a journey of the passenger.

System 100 may include a website 110 having a web server 112 running a web operating system and web applications. The website 110 may include memory devices 115 having programming code stored thereon, which when executed by the one or more processors of the web server 112 carries out one or more of the method blocks described herein. The programming code may include MMBM programming modules 120. The one or more programming modules 120 may include software, hardware, firmware, or a combination of software, hardware, and firmware for carrying out the functions described herein when executed by one or more processors of the system 100.

Memory devices 115 may include a master travel manifest 109, which includes those passengers traveling on a current day. The MMBM programming modules 120 may include programming instructions, which when executed use the data in the manifest to locate traveling passengers and their luggage items. The MMBM programming modules 120 may include programming instructions, which when executed cause the master travel manifest 109 to be updated with the IATA bag tag number when a passenger's luggage is checked in by the processor(s) of the system 100, such as at home, at a lodging entity, or other locations. The MMBM programming modules 120 may include programming instructions, which when executed cause the master travel manifest 109 to be updated with baggage source message information and information generated in the development of the GTE-BSM structure 950. The MMBM programming modules 120 may include programming instructions, which when executed cause receipt of B-Type message from air travel carriers for those passengers or travelers traveling on a particular day or time window.

The website 110 may be accessed by a computing device 50 associated with a user or passenger for registering with the system 100 through an online session via web server 112.

The MMBM programming modules 120 may include programming instructions, which when executed cause a passenger registration graphical user interface (GUI) 124 to collect information to register a passenger, traveler, or user. As used therein, the user, traveler, or passenger is referred to as a registered passenger. The computing device 50 may interact with the website 110 using a passenger registration GUI 124 to register the user or passenger.

The passenger registration GUI 124 may include programming instructions, which when executed cause a personal information collector 125 to ask and receive the passenger's personal information (PI) 129 to register the passenger and create a registered passenger profile 122. The PI 129 may include one or more of the registered passenger's name, home address, phone number, date of birth, and email address. The PI 129 may include at least one of: driver's license information and passport information with a passport identifier. An image of the driver's license may be uploaded and saved to the PI 129, for example. The driver's license information and passport information each include an image of the face of the passenger/traveler. In one or more embodiments, the PI 129 may include at least one image of the passenger/traveler.

In one or more embodiments, the passenger registration GUI 124 may include data entry fields for requesting demographic information such as employment, hobbies, and other membership, such as trade memberships, social media accounts, and entertainment membership accounts. The demographic information may be stored as part of the PI 129. The system 100 may use the user's history to identify conferences or events that were attended in the past. The conferences or events may be related to the demographic information. The demographic information or the past history for predicting the use of contactless parking service without a hotel reservation, for example.

In one or more embodiments, the GUI 124 or other graphical user interfaces may receive an indication from the user to allow a processor of the system 100 to track a location of the user using their mobile communications device. In one or more embodiments, tracking the location of the user may assist in finding the fastest route to deliver an anomalous luggage item to its owner. In one or more embodiments, tracking the location of the user may assist in finding the available parking at an event where parking spots can be hard to find.

In one or more embodiments, the passenger registration GUI 124 may request permission for the system 100 via a processor to provide certain personal identifiable information such as a passenger name and date of birth with security screening images to a government agency, such as Transportation Security Administration (TSA).

The passenger registration GUI 124 may include programming instructions, which when executed cause a luggage item information collector 126 to receive an image of the luggage item, so that the luggage item may subsequently be matched to the physical luggage item if needed. The registered passenger may update the image of the luggage item, as their luggage item becomes replaced or exchanged, in memory storage.

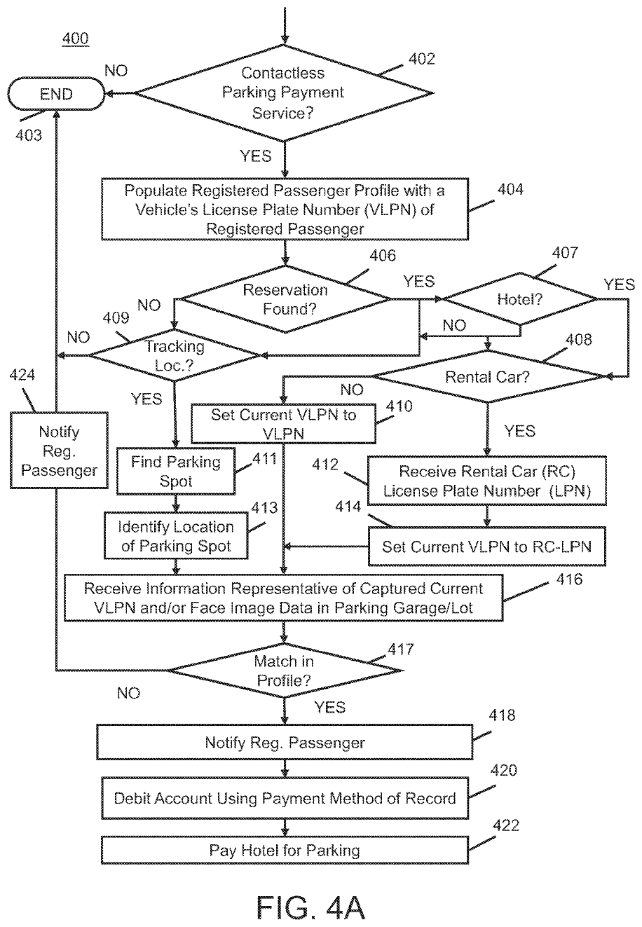

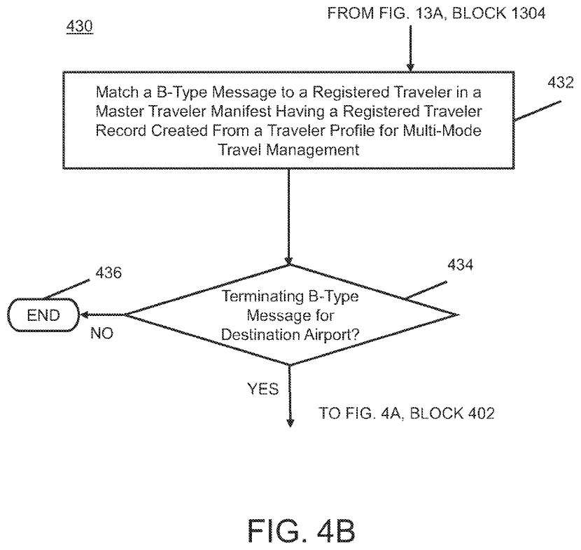

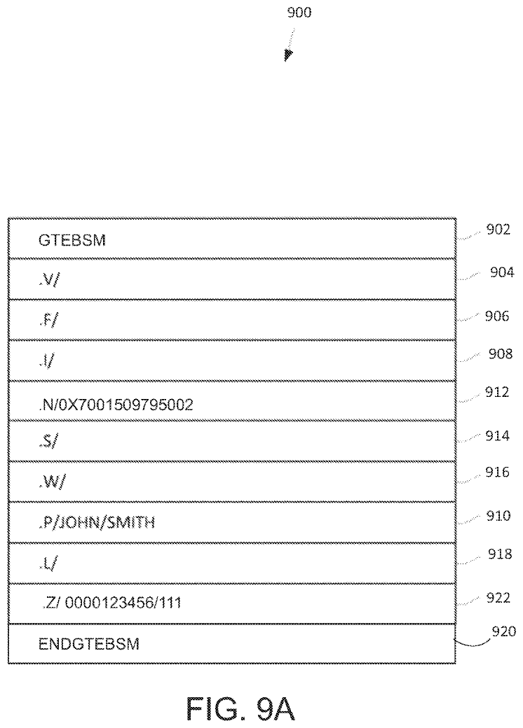

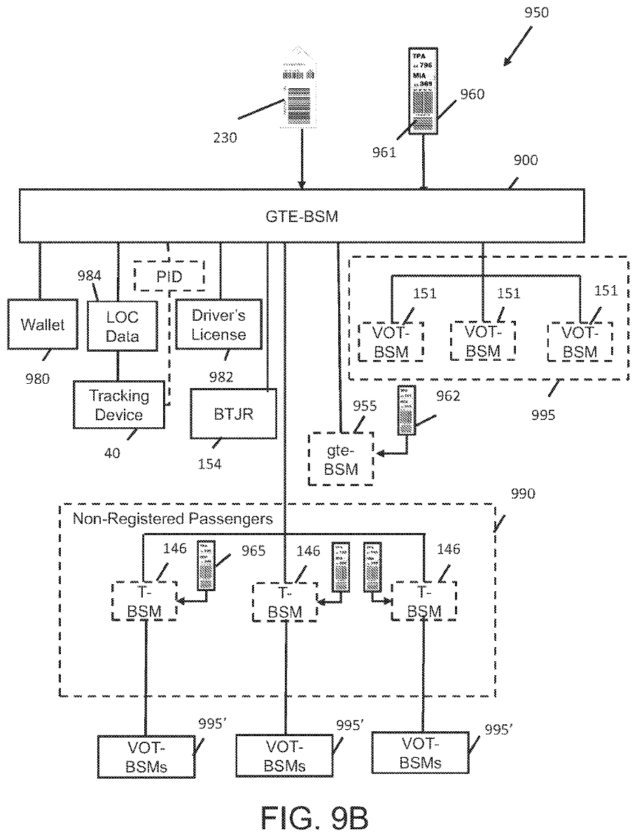

In one or more embodiments, the PI 129 may include credit card or banking information for charging baggage fees from airlines, parking fees, as described in relation to FIG. 4A, or other fees as needed to deliver and handle the luggage item(s) of the registered passenger. The banking information may be arranged in a secure wallet 980 (FIG. 9B).

The passenger registration GUI 124 may include programming instructions, which when executed cause a preferential multi-mode (PMM) travel information collector 127 to ask and receive travel preference information. The PMM travel information collector 127 will be described in relation to FIG. 2A. By way of non-limiting example, the travel preference information may include travel membership information (TMI) 128.

The collected TMI 128 may include at least one travel membership number. System 100 may autonomously retrieve other business information associated with an entered TMI 128 (i.e., travel membership number) such as a business name sponsoring the membership, the business address, and business contact information. Alternately, the passenger may enter the business information, or a portion thereof. The TMI 128 may include information associated with one or more of frequent flyer number(s), hotel membership number(s), travel membership number(s), travel management system (TMS) number and the like. The information is stored in a database to access reservation information associated with the TMI 128.

The TMI 128 may be associated with a TMS. System 100 may access the multiple reservations booked through the TMS and build a travel journey record for the luggage item independent of the passenger(s) (i.e., owner(s) of the luggage item(s)).

The MMBM programming modules 120 may include programming instructions, which when executed cause a contactless parking payment service 139 to collect information from the passenger, traveler, user for registering for contactless parking payments. This may be accomplished by using a graphical user interface where the user enters their vehicle's license plate number such as for road trips taking by the user and linked to a hotel reservation, for example, and in one or more embodiments, a rental car reservation and hotel reservation. The details of the contactless parking payment service 139 may be described in more detail in relation to FIG. 4A.

According to one or more embodiments, the MMBM programming modules 120 may include programming instructions, which when executed cause a global bag tag generator 130 to generate a P-BTI 134. The global bag tag generator 130 may include programming instructions, which when executed cause a P-BTI generator 133 to assemble the P-BTI 134. In one or more embodiments, a portion of the P-BTI 134 may be IATA compatible. The P-BTI generator 133 may include programming instructions, which when executed cause a permanent license plate (P-LP) generator 135 to generate a permanent bag tag license plate (P-LP) 136 that may be IATA compatible. The P-LP 136 may include a sequence of numbers. The P-BTI generator 133 may include programming instructions, which when executed cause a PMM code(s) generator 137 to generate at least one PMM code 138. According to an embodiment, each PMM code may be directly related to a travel membership number associated with the TMI 128.

According to an embodiment, the P-BTI 134 may include both a sequence of alphanumeric digits and related barcode or quick response (QR) code of the P-LP 136. The PMM code 138 may include a sequence of alphanumeric digits and related barcode or QR code.

According to one or more embodiments, the assembled P-BTI 134 may include a first portion that includes the P-LP 136. In some instances, a registered passenger may not enter TMI 128. In one or more embodiments, the assembled P-BTI 134 may include the first portion that includes the P-LP 136 and a section portion that includes a PMM code representative of no TMI information. However, in the event the registered passenger adds TMI information in the passenger profile, the assembled P-BTI 134 may include a second portion that includes at least one PMM code 138. By way of non-limiting example, the assembled P-BTI 134 may include a space or gap between the end of the first portion (i.e., P-LP 136) and the second portion with at least one PMM code 138. By way of non-limiting example, the assembled P-BTI 134 may include a dash between the end of the first portion (i.e., P-LP 136) and the second portion with at least one PMM code 138. By way of non-limiting example, the assembled P-BTI 134 may include the first portion (i.e., P-LP 136) arranged at a first location on the substrate 233 (FIG. 2B) and the second portion with at least one PMM code 138 arranged at a second location on the substrate 233 (FIG. 2B), where the first location is different from the second location.

The assembled P-BTI 134 may include a PMM code 138 for different TMI 128 for one or more travel membership numbers. In one or more embodiments, the assembled P-BTI 134 may include one PMM code 138 for access to all TMI 128. In one or more embodiments, the assembled P-BTI 134 may include one PMM code 138 for each different TMI 128. The assembled P-BTI 134 may include one PMM code 138 for each category of TMI 128.

The P-BTI 134 may be associated with a GTE-BSM 141, both of which may have a predetermined duration. The P-BTI 134 and the GTE-BSM 141 may expire after the predetermined useful life or renewed after the expiration, for example. The permanent duration of the P-BTI and the GTE-BSM may be for life. The predetermined useful life durations of the P-BTI 134 and the GTE-BSM 141 may be for one month to 1 year, 5 years, 10 years, or 20 years. The disclosure is not limited to the foregoing useful life durations, and other predetermined useful life durations may include greater than one month but less than 1-5 years, or less than 10 years, for example.

According to an embodiment, the passenger's P-BTI 134 may include a permanent license plate (P-LP) 136 that may be compatible with IATA regulations now and in the future. The P-BTI 134 may include at least one preferential multi-mode (PMM) travel code 138 based on at least one travel membership number of a registered passenger.

According to one or more embodiments, the MMBM programming modules 120 may include programming instructions, which when executed cause a GTE-BSM generator 140 to generate a GTE-BSM 141, as will be described in relation to FIG. 9A. The GTE-BSM generator 140 may include programming instructions, which when executed may create BSM fields, such that some fields have permanent information assigned to certain fields. For example, a GTE-BSM 141 may have a field with a registered passenger name (RPN) 143. The GTE-BSM 141 may have a field for a P-BTI 134 with at least the P-LP 136. In the GTE-BSM 141, a special character or digit may separate the P-LP 136 and the first PMM travel code 138. Likewise, a special character or digit may separate each PMM travel code 138 from the next PMM travel code. Other coding schemes to separate code sequences may be used and should not be limited to those described herein.

The GTE-BSM 141 may be updated with a current passenger name record (PNR) number 142 associated with a current travel journey within a particular travel window. The PNR number 142 may have one passenger in the passenger list or multiple passengers. However, one of the passengers is the registered passenger matched by the RPN 143.

System 100 may be configured to autonomously associate the GTE-BSM 141 with a passenger name record (PNR) number 142 for a particular travel window provided one of the passengers listed is a passenger with a P-BTI 134. For example, a registered passenger may book a current travel journey using any travel membership number where a PNR number may be created. In one or more embodiments, a Super PNR number may be created for multiple modes of travel with or without multiple passengers connected/associated with the Super PNR number. In response to a travel reservation being made a corresponding reservation system may be accessed to obtain the travel itinerary, as will be described in more detail in relation to FIG. 1B.

The MMBM programming modules 120 may include programming instructions, which when executed cause a follow-along PNR baggage link 144 to link together multiple non-registered passengers to a GTE-BSM and P-BTI of a registered passenger, all of which are associated with the same PNR number for a current travel journey. In an example, some passengers associated with a Super PNR number may be initially traveling on the same air travel carrier and/or at different times to arrive at a final destination point and disembark on a cruise ship or stay at a resort. The follow-along PNR baggage link 144 may include programming instructions, which when executed cause the A-BSM and/or A-BTI of each non-registered passenger to be linked to the GTE-BSM 141 of a registered passenger, where all passengers are associated with the PNR number of a current travel journey. Non-registered passenger names will sometimes be referred to as “other passenger names.”

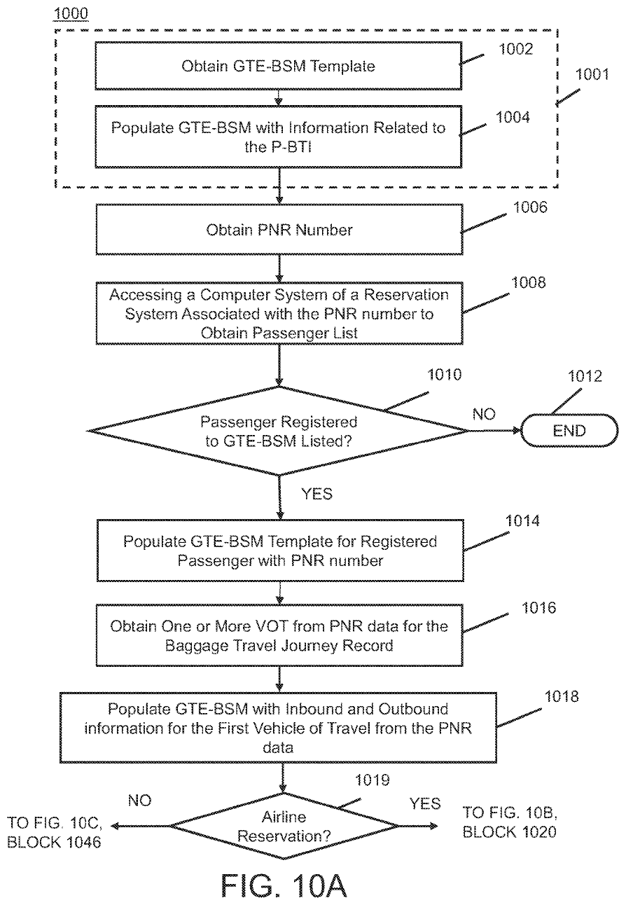

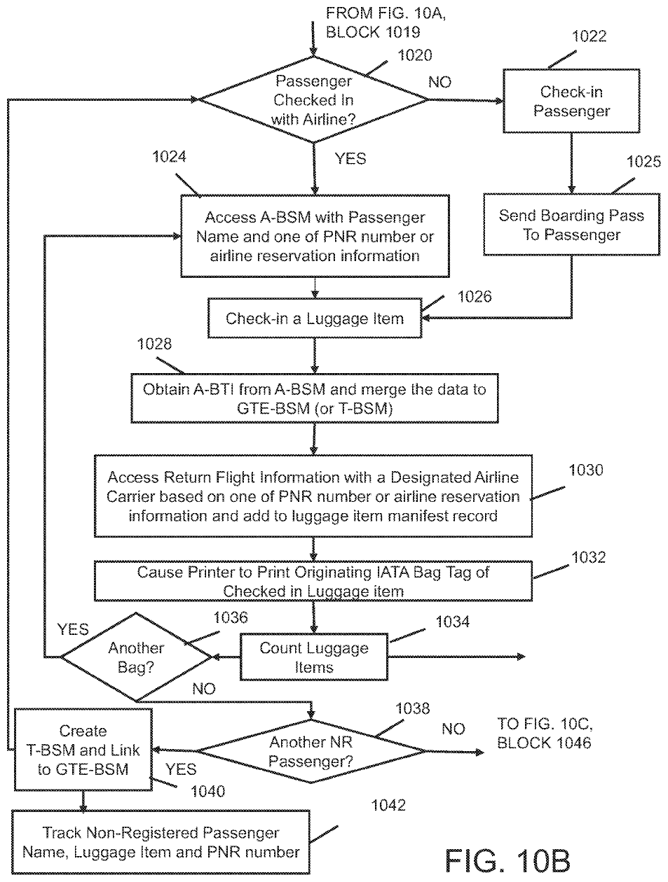

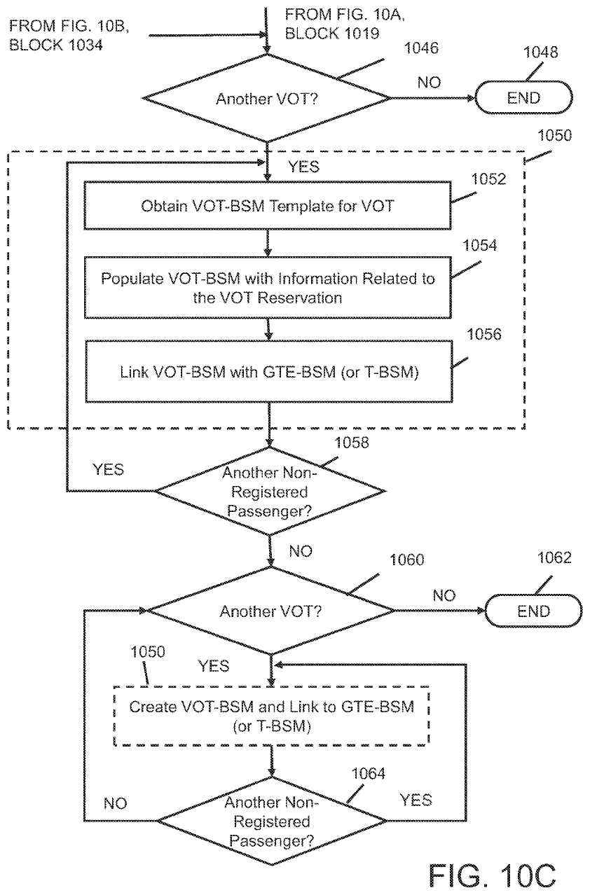

The follow-along PNR baggage link 144 may include programming instructions, which when executed cause a temporary BSM (T-BSM) generator 145 to generate a T-BSM 146, as described in relation to FIG. 10B. A T-BSM 146 is similar to a GTE-BSM but for a non-registered passenger. After a travel journey, the T-BSM 146 may be deleted in its entirety. The MMBM programming modules 120 may include programming instructions, which when executed cause a vehicle of travel BSM (VOT-BSM) generator 149 to generate a VOT-BSM 151, as described in relation to FIG. 10C. Examples of linking are described later in relation to the steps associated with block 507.

The MMBM programming modules 120 may include programming instructions, which when executed cause a baggage handling resource allocator 147 to determine resources needed to handle the tracking and/or handling of the luggage item(s) at one or more destination locations associated with the baggage travel journey. The baggage handling resource allocator 147 may include programming instructions, which when executed cause an originating allocator 148A, to allocate resources (i.e., personnel and ground vehicles) for luggage items to be picked up from a passenger's home or other designated address and delivered to an originating mode of transportation location, such as an airport, bus station, train station, ferry or cruise ship dock, or a lodging entity. Baggage handling resource allocator 147 may include programming instructions, which when executed cause a multi-mode location allocator 148B to allocate resources for luggage items to be picked up from: a first vehicle of travel and delivered to a second vehicle of travel, and/or one vehicle of travel to the next vehicle of travel. The baggage handling resource allocator 147 may include programming instructions, which when executed cause a return home allocator 148C to allocate resources for luggage items to be picked up from a vehicle of travel location and delivered to a passenger's home or other designated address.

The baggage handling resource allocator 147 may include programming instructions, which when executed may assign one or more entries in the baggage travel journey record of a luggage item for a registered passenger to one or more baggage delivery resources to deliver the luggage item to or for pickup from the location associated with the location data in the baggage travel journey.

With specific reference to FIG. 1B, the website 110 of system 100 may communicate with one or more of cruise line reservation systems 60, airline reservation systems 62, train reservation systems 64, bus reservation systems 66, rental car reservation systems 68 and lodging entity reservation systems 70. One or more of these reservation systems may be accessed to retrieve travel information for a registered passenger that is associated with TMI 128 in the registered passenger profile 122. The lodging entity reservation system 70 may be associated with a hotel, lodging entity, or resort that may have a parking entity (PK) 71 associated therewith. The parking entity 71 may include a computing system that connects to scanners 75. The scanners 75 may scan a vehicle's license plate for detecting and registering a vehicle entering a parking lot or garage. In general, the owner or user of the vehicle may be charged a fee for parking in the parking lot or garage.

In some scenarios, a parking entity may use facial recognition technology to identify an owner or user of a vehicle with or without license plate scanning.

The TMI 128 may include a travel membership to a travel management system (TMS) 72, such as Travelocity®, etc. System 100 may access the reservation system of TMS 72 to obtain the booked reservations to build the travel journey. The registered passenger may have multiple TMS accounts, such as TMS 74, for a vacation rental online platform or an online travel booking engine. System 100 may access each travel membership to determine an occurrence of a current travel journey.

In an embodiment, system 100 via web server 112 may include programming instructions, which when executed may access one or more reservation systems to acquire a PNR number or an itinerary confirmation number associated with the mode of travel carrier and allow the web server 112 to update reservation data for multi-modes of travel carriers associated with a baggage travel journey of a luggage item for a current travel journey.

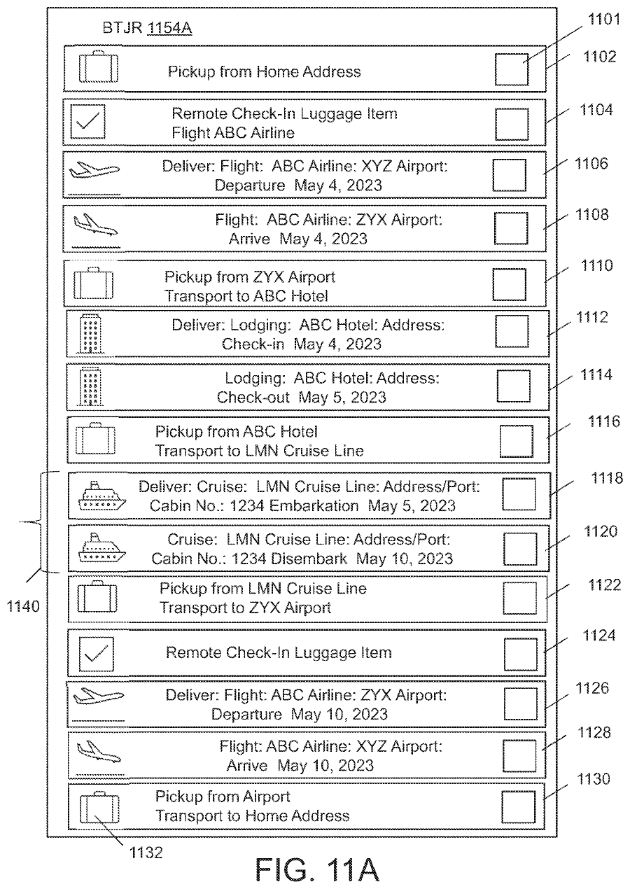

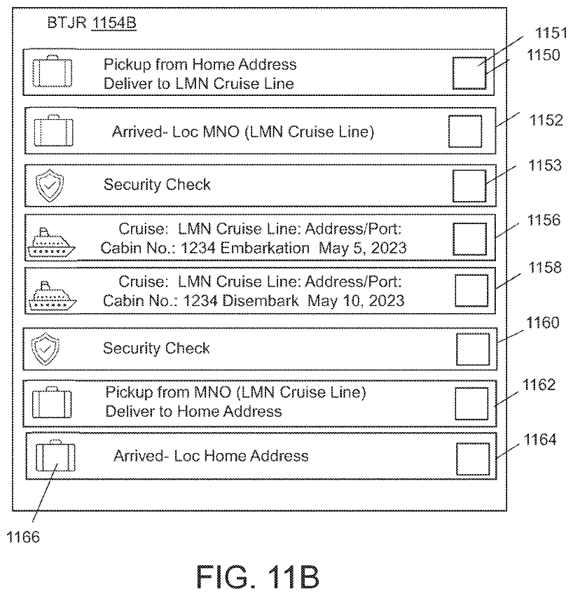

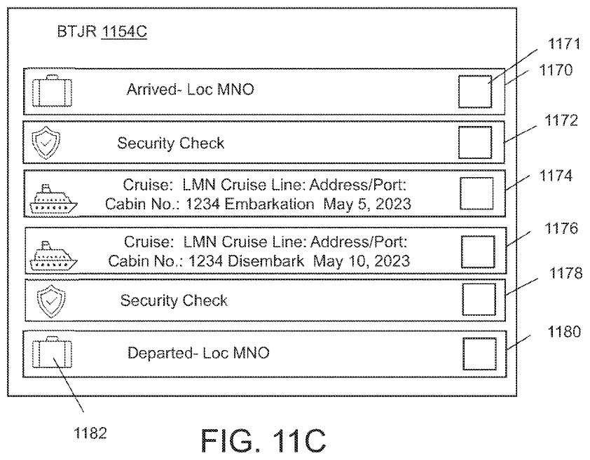

The MMBM programming modules 120 may include a baggage travel journey record (BTJR) builder 150. BTJR builder 150 may include programming instructions, which when executed cause a BTJR 154 to be generated for the luggage item of a registered passenger. BTJR 154 is created or built for a particular (current) travel journey based on a PNR number or an itinerary confirmation number. For example, the BTJR 154 may include a PNR trigger 152, which may be entered by the registered passenger or received by web server 112. Once a trigger is received the programming instructions, which when executed may cause a luggage item manifest record 153 to be created for a current travel journey. Example BTJRs are described in relation to FIGS. 11A-11C. Trigger 152 may be received from a registered passenger if the registered passenger accesses their account and enters a current travel journey. In an embodiment, this may happen the first time when registering the passenger and obtaining a global bag tag. In one or more embodiments, the web server 112 may receive information (i.e., PNR trigger) about a booked travel journey from any of the reservation systems associated with TMI 128 or the reservation system of TMS 72. For example, when a PNR number is generated for a registered passenger of system 100, by the reservation systems associated with the TMI 128 or TMS 72, a trigger may be sent to system 100 via web server 112.

BTJR 154 may be based on whether the luggage item is being picked up at the registered passenger's home, office, or other designated location. BTJR 154 may include baggage travel locations for the first leg of travel, a second leg of travel, and/or an end-to-end travel journey record. The baggage travel locations may include government clearance locations, such as Customs, and one or more security screening locations.

The BTJR builder 150 may include programming instructions, which when executed cause the BTJR 154 to be populated with BSM data for luggage items associated with the registered passenger and any non-registered passenger associated with a PNR number for which the registered passenger is associated.

Additionally, for a current travel journey, BTJR builder 150 via web server 112 may include programming instructions, which when executed may communicate with a cruise line reservation system 60, an airline reservation system 62, a train reservation system 64, and a bus reservation system 66 based on a passenger name record (PNR) number 142 or itinerary confirmation number associated with one or more of the reservations systems. BTJR builder 150 via web server 112 may include programming instructions, which when executed may retrieve the travel information details, such as flight numbers, flight date, flight inbound and outbound data from an airline reservation system 62. BTJR builder 150 via web server 112 may include programming instructions, which when executed may retrieve the travel information details, such as cruise voyage number, voyage date and time, and cabin number, by way of non-limiting example. The programming instructions may store the passenger's reservations in a passenger reservation database 121. The travel information details for a luggage item may coincide with the passenger's reservations. However, the passenger may have certain instructions, which cause the certain paths of the luggage item to be independent from the passenger's path.

BTJR builder 150 via web server 112 may include programming instructions, which when executed may access a reservation from a reservation system, by accessing at least one travel membership number for the registered passenger associated with the TMI 128. System 100 via web server 112 may include programming instructions, which when executed may automatically look-up a reservation associated with the travel membership number as the reservation system for a travel membership number may store reservations for one or more of the business locations. For example, a passenger may have a flight or mode of travel reservation to Orlando, Florida, and a travel membership with Hilton® Corporation, for example. BTJR builder 150 via web server 112 may include programming instructions, which when executed may automatically query the reservation system of Hilton® Corporation to find a reservation that coincides with the travel date reserved under the registered passenger name 143. However, if such a reservation is not found, the system may send a communication to the passenger via email, phone call, or text to determine if other reservations have been booked. The passenger may have travel memberships with more than one lodging entity. BTJR builder 150 via web server 112 may include programming instructions, which when executed may query a lodging entity reservation system with the travel membership number of record for a reservation in Orland, Florida within the travel window. BTJR builder 150 via web server 112 may include programming instructions, which when executed may also look for reservations within a certain radius of the mode of travel, such as an airline, cruise line, bus station, or train station for the registered passenger in the window of travel.

BTJR builder 150 via web server 112 may include programming instructions, which when executed may communicate with any reservation system of any vehicle of travel identified in the registered passenger profile 122.

The use of a travel membership to access reservations provides the system with addresses and contact information for many lodging entities associated with a single travel membership number. This limits the need for entering or remembering the address for lodging entities for a particular travel journey.

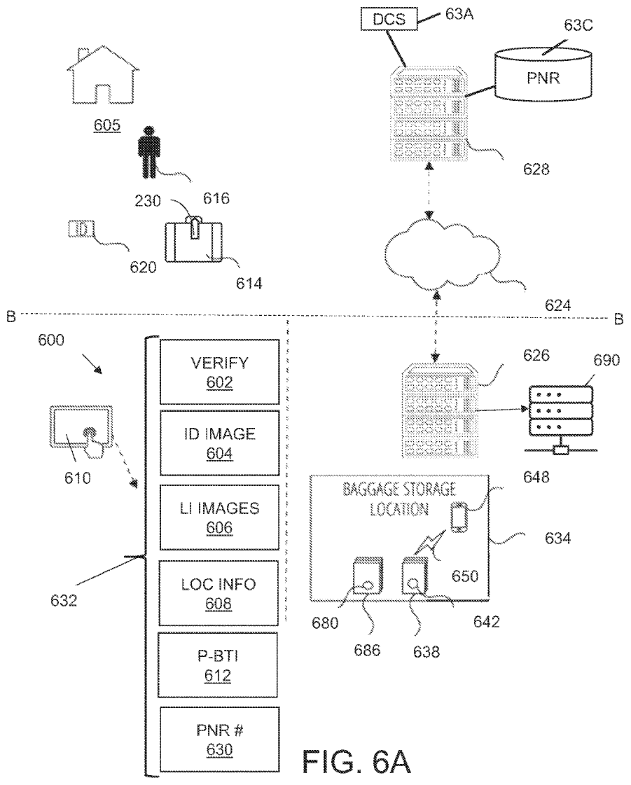

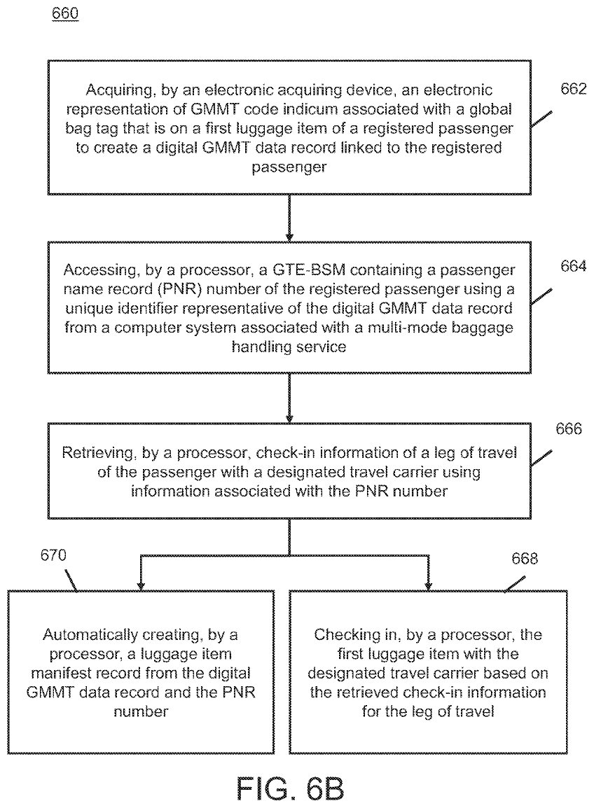

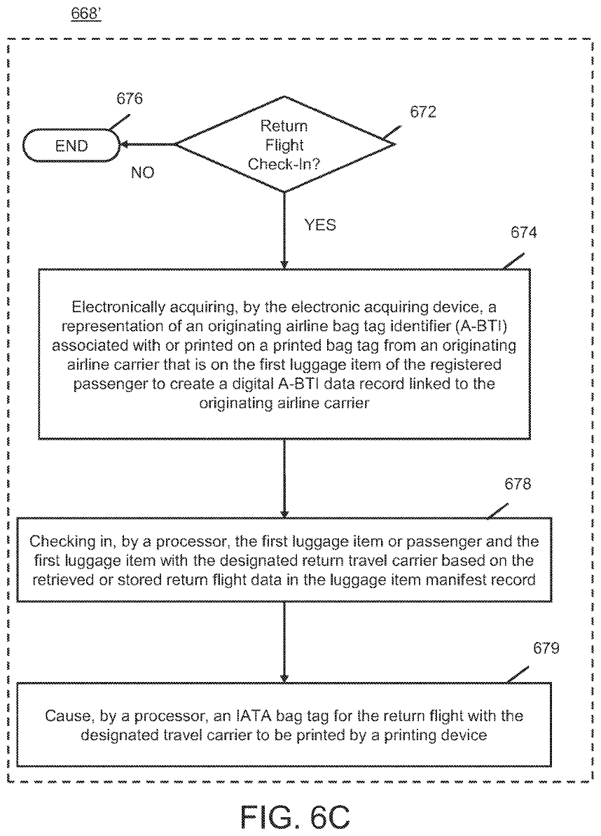

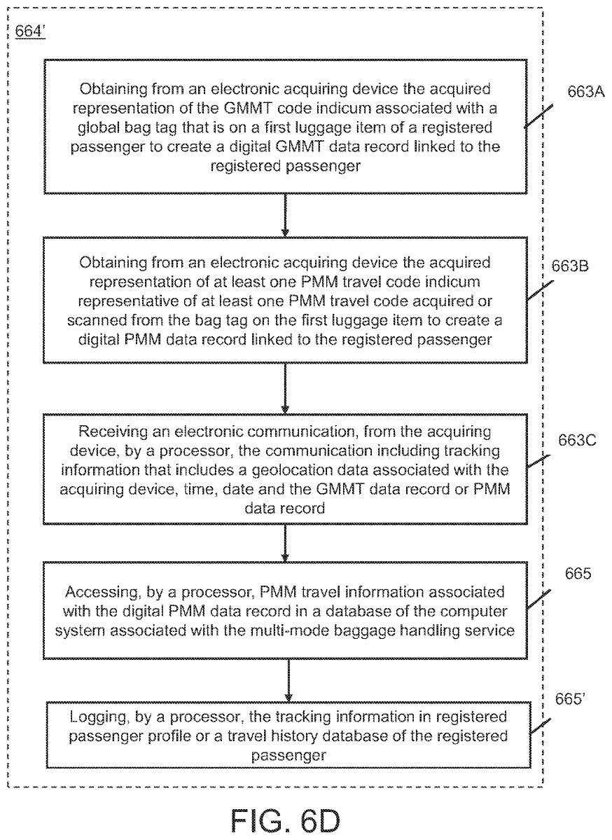

The MMBM programming modules 120 may include programming instructions, which when executed may cause a baggage check-in module 155 to check-in baggage based on a picked up from home process, as described in FIG. 6A, and a return home process using a return leg of travel, as described in FIGS. 6B-6C. The baggage check-in module 155 may access return flight data associated with the PNR number or the itinerary confirmation number. The baggage check-in module 155 may include programming instructions, which when executed may check-in the luggage item with a mode of transportation carrier such as an airline carrier for the originating flight and/or the return flight.

Passengers may check in for a flight with an airline carrier using a mobile communication device or a computing device. In some instances, a luggage item for a passenger cannot be checked in unless the passenger is checked in. In one or more embodiments, the MMBM programming modules 120 may include programming instructions, which when executed may cause a passenger check-in module 163 to check-in a passenger described in FIG. 10B. The passenger check-in module 163 may access return flight data associated with the PNR number or the itinerary confirmation number.

The MMBM programming modules 120 may include programming instructions, which when executed may cause an originating bag tag receipt receiver 170 to receive an originating bag tag (O-BT) image 171 of a registered passenger originating bag tag license plate issued by an airline carrier. The passenger may capture the O-BT image 171 of their bag tag license plate on the originating bag tag issued by a counter agent of the airline or the license plate on the marker stickers in the jacket of the boarding pass. The passenger may send the image to web server 112 of system 100 using a mobile communication device, laptop, Notebook or another computing device with a built-in camera and Internet, WI-FI, or wireless communication enabled. The received image may be used to digitally create the A-BTI and access an airline's baggage source message (A-BSM) or another B-Type message, for example. The printed A-BTI may be digitally created using optical character recognition to translate the printed text of the A-BTI into machine-encoded text of the IATA license plate number. Alternately, the passenger's mobile device may have a GUI that guides the user to scan the IATA barcode to digitally create machine-encoded text of the IATA license plate number which is sent to web server 112.

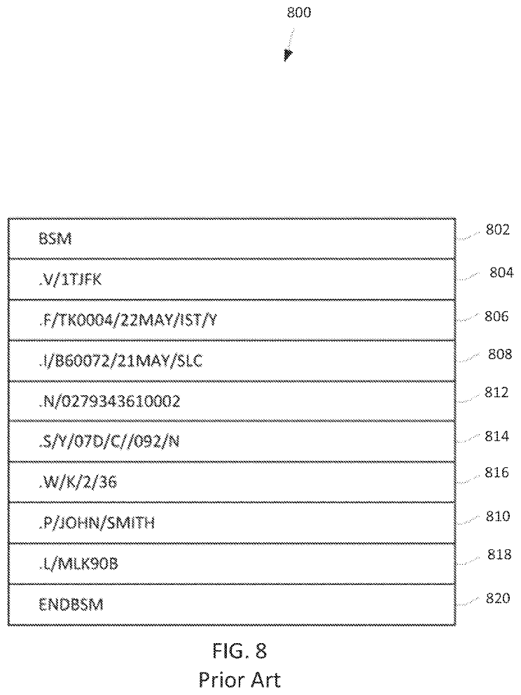

The MMBM programming modules 120 may include programming instructions, which when executed may cause a GTE-BSM linking module 173 to use the digitally created IATA license plate number from the O-BT image 171, for example, to link the GTE-BSM 141 with an airline BSM from an airline carrier. The airline BSM (A-BSM) may be populated with data in various fields described in relation to FIG. 8. The data from the originating A-BSM may be merged into fields of the GTE-BSM that are not populated with permanent information.

The GTE-BSM linking module 173 may include programming instructions which when executed may link together other messages of modes of travel of a current travel journey for the registered passenger associated with a PNR number and/or non-registered passengers associated with the PNR number for the current travel journey. The GTE-BSM linking module 173 may include programming instructions which when executed may link together information in the registered passenger profile 122 to the GTE-BSM so that when the global bag tag or the IATA license plate number of the registered passenger are scanned and the P-BTI on the global bag tag or printed A-BTI are electronically created, access to the registered passenger's travel information is available for at least one of: a) checking in the registered passenger for a return flight, b) checking in the registered passenger for a vehicle of travel; c) obtaining information for delivery of a luggage item to the next scheduled location, d) obtain information to move the luggage item in parallel and independently with its owner; and e) obtain luggage item location information. For non-registered passengers, scanning their A-BTI on an IATA bag tag provides access to location data and other information based on the link to the P-BTI of a registered passenger.

The programming instruction of the GTE-BSM linking module 173 will become more evident based on the description of FIG. 9B.

The MMBM programming modules 120 may include programming instructions, which when executed may cause a baggage travel journey reservation tracker 175 to track the details of the reservation to determine updates for any reservation fields. The baggage travel journey reservation tracker 175 may include programming instructions, which when executed may cause a journey update log 177 to update the journey update log 177 with movements of the luggage item such as when the global bag tag 230 is scanned. For example, the time of departure may change.

The baggage travel journey reservation tracker 175 may include programming instructions, which when executed may cause a message communicator 178 to communicate status messages to the system, computing devices of personnel of the system and/or a designated communication device of the passenger. The message communicator 178 may provide a message to the passenger about the change in departure or a status change in the location of the owner's luggage item. In other examples, the status of a room at a lodging entity may change from non-available to available. Message communicator 178 may provide a message to the passenger about the availability of the room. For example, a room may be in the process of being serviced or cleaned and not ready for occupancy by the passenger. For modes of travel, a flight may have a change of gate at an airport. Message communicator 178 may provide a message to the passenger about the change in gate for their flight or change in status for any vehicle of travel.

The baggage travel journey reservation tracker 175 may include programming instructions, which when executed may periodically check reservation status of reservations associated with a travel journey record. For example, the baggage travel journey reservation tracker 175 may check on updates to reservations of a lodging entity of the travel journey record. In one or more embodiments, the reservation of the lodging entity may be based on information obtained from a reservation system associated with a lodging entity travel membership of the registered passenger. The baggage travel journey reservation tracker 175 may obtain updates to a mode of travel such as a change in a gate of an airline, a station of a train, a room at a lodging entity and cancellations, for example.

In one or more embodiments, web server 112 may include programming instructions, which when executed activate the baggage travel journey reservation tracker 175 during a baggage travel journey. Message communicator 178 of the baggage travel journey reservation tracker 175 may communicate to a passenger's mobile communication device baggage handling information related to the transfer of the luggage item from the passenger to a baggage delivery resource. This may include communicating, via message communicator 178, an acknowledgement or a receipt to a passenger that their luggage item has been picked up. If at this time, a luggage item is not checked in with an airline carrier, later when the luggage item is checked in via baggage check-in module 155 with an airline carrier, an electronic receipt with an airline carrier IATA bag tag number will be electronically communicated, by message communicator 178 to a mobile communication device or computing device of the passenger.

In one or more embodiments, web server 112 may include programming instructions, which when executed activates the baggage travel journey reservation tracker 175 during the baggage travel journey to communicate to a passenger's mobile communication device a change in reservation information related to delivery of the luggage item to a designated location. This may include communicating to a passenger that their luggage item has been delivered to their room.

Message communicator 178 may send text messages or emails, for example.

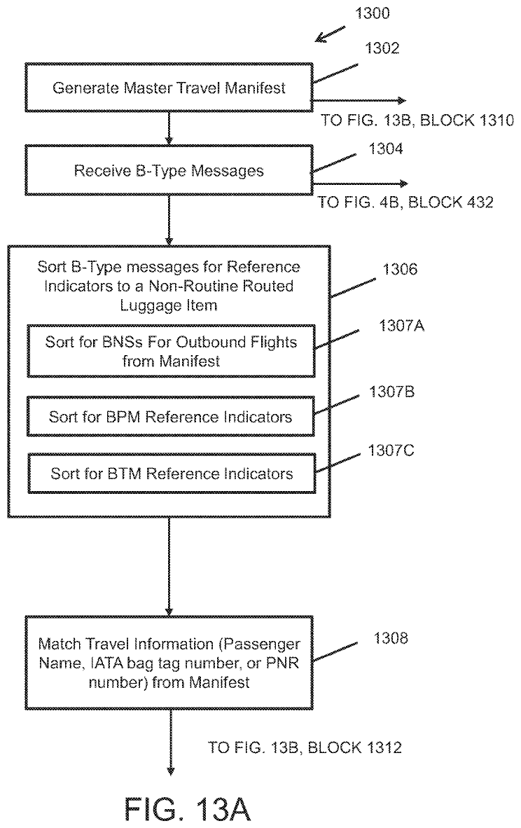

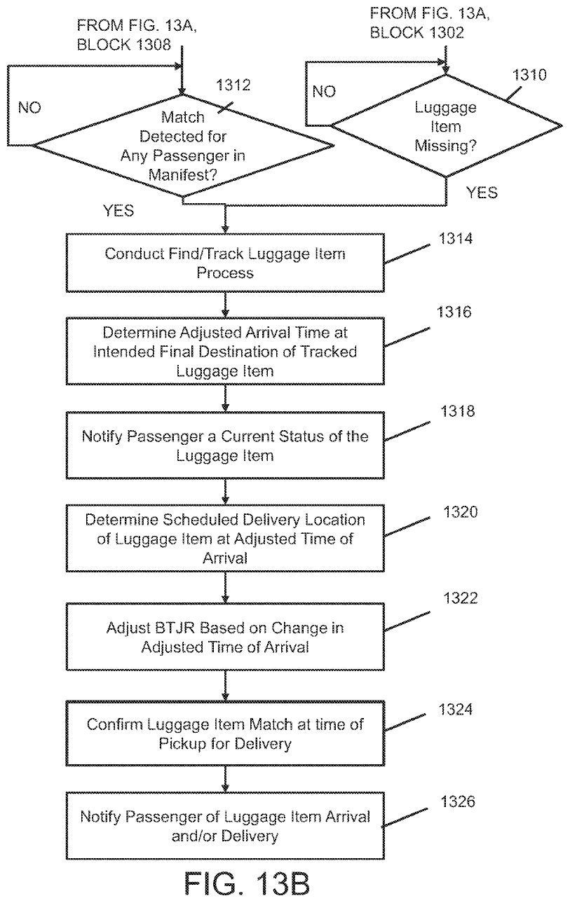

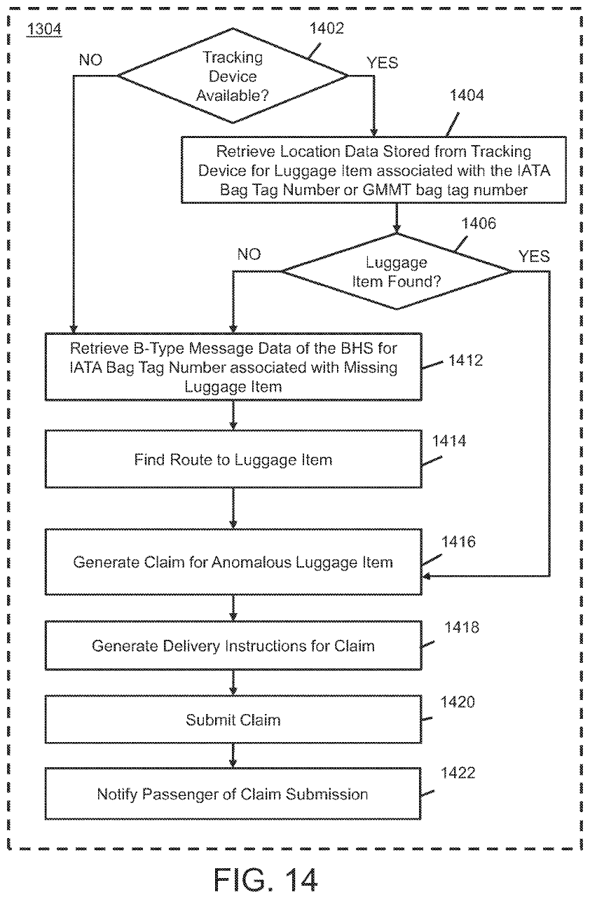

The MMBM programming modules 120 may include programming instructions, which when executed may cause a luggage item recovery manager 180 to electronically locate and recover a lost luggage item and manage rerouting of the found luggage item. As will be described in more detail in relation to FIGS. 13A, 13B and 14, luggage items become lost, missing, rerouted, delayed, or mishandled once taken into the possession of the vehicle of travel. System 100 is configured to find and locate the anomalous luggage item, keep the passenger informed of the current status, and work with the vehicle of travel to transport the found luggage item expeditiously to rendezvous with the passenger on their current route. The current route may be based on the passenger's current reservation information that is stored in the passenger reservation database 121.

The luggage item recovery manager 180 may include programming instructions, which when executed may cause a luggage item finder 181 to find an anomalous luggage items.

In one or more embodiments, those luggage items with an assigned/registered tracking device 40, for example, may be found using location data 984 (FIG. 9B) stored in the travel history 184. In one or more embodiments, system 100 may receive, access and/or store B-Type messages of those registered passengers and associated non-registered traveling on a current day using an air travel carrier from a computer system associated with the air travel carrier. The B-Type messages of those passengers in the master travel manifest 109 (FIG. 1B) may be stored in B-Type message database 107 (FIG. 1B). By way of a non-limiting example, a mishandled or rerouted luggage item may be a delayed luggage item.

When a luggage item is determined to be missing, lost, rerouted, or mishandled, the luggage item route data analyzer 182 may retrieve and sort data from one or more B-Type messages of the B-Type message database 107 or the tracking device data in the travel history 184 to find data representative of a location, airport, or other indicator for finding and recovering the luggage item, by determining a route taken by the luggage item.

A missing or not seen luggage item may be determined by a particular type of B-Type message, such as the baggage not seen message (BNS). This message may be generated when it is determined that the luggage item was not loaded (not seen) onto the same plane as the passenger. However, an anomalous luggage item may not be determined until a time when a baggage handler or passenger is to take possession of the luggage item after the luggage item should have arrived at an airport, by way of a non-limiting example. The B-Type message database 107 may have messages with data from the BHS 63B that can be used to locate where the IATA bag tag on the luggage item is currently or was last scanned. For example, a luggage item with an IATA bag tag matching a passenger name in the master travel manifest 109 may have been scanned at an airport different from the expected final destination airport for the passenger and/or the luggage item. In another example, the luggage item may have been scanned at the same airport as the originating flight of the passenger after the flight departed the airport and has not been scanned since. As can be appreciated, there are numerous scenarios of how a luggage item may go missing and to describe each and every one is prohibitive.

Alternately or in addition to the foregoing, the tracking device data in the travel history 184 may be used to locate the luggage item.

The MMBM programming modules 120 may include programming instructions, which when executed may cause a journey history tracker 183 to generate and store a member's travel history 184 that includes data for a travel journey, where the data includes flights, car rental, lodging entity, other modes of travel and more. The travel history data may be analyzed for data statistics to improve baggage allocation. The travel history data may be used for pushing advertisements based on historical travel data of the registered passenger. In one or more embodiments, the advertisements may be based on data analytics of the historical travel data for a current travel journey of the registered passenger. The data from the journey history tracker 183 may be used in data analytics for predicting future resource scheduling. The data from the journey history tracker 183 may be used in data analytics based on terminating BSM data linked to historical data of a passenger for predicting future business volume local to an airport.

The MMBM programming modules 120 may include programming instructions, which when executed may cause reception of advertisements through an advertisement application programming interface (API) 185 for communication to message communicator 178, for example, or other communication module to push advertisement to the registered passenger based on current travel data (i.e., BTJR 154) and/or data in the member's travel history 184. The data in the travel history 184 may be used by companies of travel memberships to provide membership incentives or discounts. The BTJR 154 may be used by companies to prepare advertisements for a registered passenger to restaurants, venues, hotels, or other establishments for passengers going to or passing through a location within a radius of locations identified in the BTJR 154. For example, BTJR 154 may identify a lodging entity. Restaurants within a certain radius or proximity to the location of the lodging entity may offer a discount to the registered passenger. Venues with entertainment may provide advertisements for special events or meal specials for the time the passenger may be in the area with or without a discount. Other lodging entities may provide advertisements as well. The advertisements may be sent through social media platforms linked to accounts associated with the passenger on a mobile communications device or their personal computing device. The BTJR 154 may be linked to the GTE-BSM (FIG. 9B).

The advertisements may be sent through the advertisement API 185 to message communicator 178 to communicate the advertisement to the passenger's mobile communication device via text or another computing device. The advertisements may be sent via email through message communicator 178 or another communication module. The advertisement may be sent as window overlays in applications being viewed by the passenger interacting with the mobile communication device or their personal computing device.

The MMBM programming modules 120 may include programming instructions, which when executed may cause a luggage tracker registration module 190 to register or assign a wireless tracker to be affixed to the luggage item. The tracker (i.e., tracking device) may have a tracking device identifier (ID) that is stored in the tracker or tracking device.

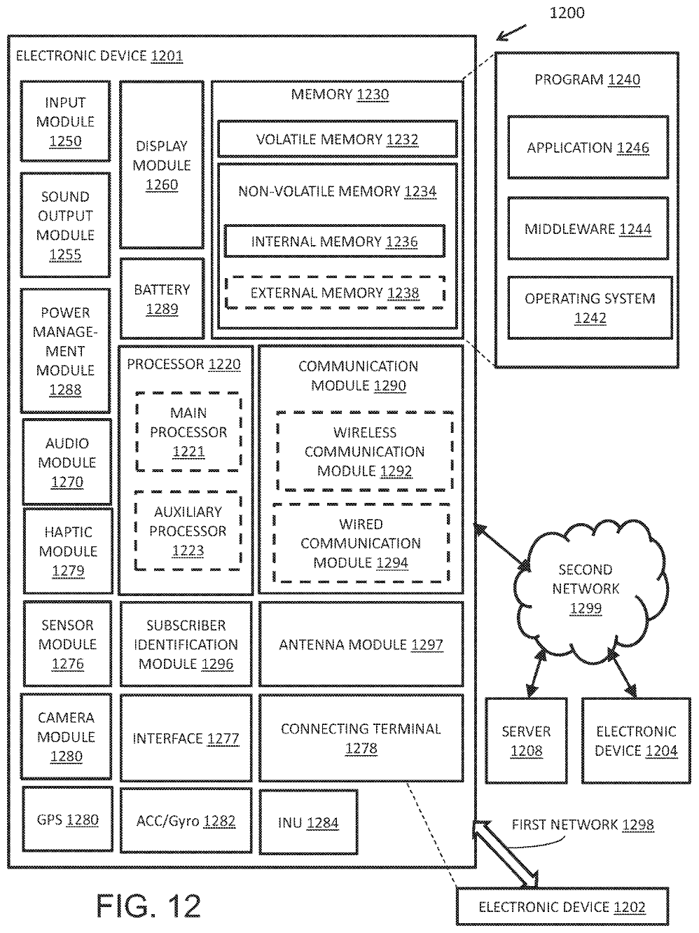

The luggage item may also have the global bag tag attached. In one or more embodiments, the luggage item may be provided with a wireless tracking device 40 (FIG. 1A) that is provided by the passenger. By way of non-limiting example, the wireless tracking device 40 may be a tracking device that may include accelerometers (ACC) and/or gyroscopes 1282 (FIG. 12), Global Positioning System (GPS) 1280 (FIG. 12) and/or an Inertial Navigation Unit (INU) 1284 (FIG. 12) to determine its own location, and such location may be sent to the journey history tracker 183 where the received geolocations of the luggage item are logged. The wireless tracking device 40 may have a unique identifier such as a registered serial number, media access control (MAC) address, or another assigned unique identifier. The wireless tracking device 40 may also be programmed with a unique identifier of the passenger and/or the luggage item, such as passenger name, a PNR number, a Super PNR number, IATA license plate number, portions of the data from a B-Type message or any combination thereof. The wireless tracking device 40 may be programmed with the GMMT bag tag number.

The wireless tracking device 40 may be a an AIRTAG by APPLE Inc., a Global Positioning System (GPS) tracker, a Global System for Mobile Communications (GSM) tracker, a GSM-5G tracker, a WI-FI-enabled communication device, a BLUETOOTH Low Energy (BLE) device, a BLUETOOTH-enabled communication device, a short-range RF communication device and/or a long-range communication device using compatible wireless communication protocols.

The wireless tracking device 40 may be configured for short-range communications, such as without limitation, WI-FI, a BLUETOOTH Low Energy (BLE), and BLUETOOTH. The vehicles of travel, carrier stations and other public infrastructure may include remote network devices that can connect to the wireless tracking device 40.

In one or more embodiments, a wireless tracking device 40 may be temporarily assigned to the luggage item by a processor of the MMBM system 100. In one or more embodiments, the wireless tracking device 40 may be permanently assigned by a processor of the MMBM system 100. In one or more embodiments, the wireless tracking device 40 may be assigned by a computer system associated with the air carrier.

The wireless tracking device 40 may include long-range communication devices, such as without limitation, an AIRTAG by APPLE Inc., a Global Positioning System (GPS) tracker, a Global System for Mobile Communications (GSM) tracker, and a GSM-5G tracker may communicate with cellular, satellite and GSM communications service providers. The geolocation signals may be sent to web server 112 or other designated computing device for access by journey history tracker 183 where the received geolocations of the luggage item are logged. In one or more embodiments, the long-range communication devices may also be configured to communicate using short-range communication protocols.

The wireless tracking device 40 may be used to track its location while traveling using any mode of travel or next mode of travel using long-range or short-range communications depending on the wireless tracking device 40 configuration.

System 100 may include acquiring devices 195 (i.e., scanning device, mobile communication device, video-enabled computing device, RF communication device) which may scan an IATA compatible license plate including on an originating hardcopy bag tag, a global bag tag, a marker tag, bingo tag, an RFID display, etc. Acquiring devices 195 may provide a geolocation code in a communication that includes a digitally created bag tag identifier (BTI) (i.e., an A-BTI or a P-BTI).

By way of non-limiting example, acquiring device 195 may communicate a registered serial number, media access control (MAC) address, or other unique identifier to web server 112 of system 100. Acquiring device 195 may electronically acquire a representation of the GMMT bag tag number on a substrate at a location associated with the location data derived by the acquiring device 195. Acquiring device 195 may be a computing device configured to generate an electronic communication to web server 112, for example, or another computing system. The communication may include tracking information that may include a global positioning system (GPS) location data associated with acquiring device 195, time, date and the GMMT bag tag number. System 100 may log the tracking information including the current location of the luggage item in journey update log 177.

### Generation of the Permanent Bag Tag Identifier (P-BTI)

FIG. 2A illustrates a flowchart of method 200 for generating a permanent bag tag identifier (P-BTI) in accordance with an embodiment. Method 200 may include, at block 202, generating, by a processor, a P-BTI generator 133 or permanent unique identifier or permanent license plate (P-LP) 136 that is compatible with an IATA license plate. At block 202, both the number and the barcode may be created.

Method 200 may include, at block 204, determining, by a processor, whether there is travel membership information (TMI). If the determination, at block 204, is “YES,” the method 200 may include retrieving, by a processor, TMI at block 206. Method 200 may include generating, by a processor, a PMM code 138 based on the TMI, at 208.

Method 200 may, at block 210, include determining, by a processor, if there is another travel membership listed in the travel membership information. If the determination, at block 210, is “YES,” the method may loop back to block 206. The blocks 206, 208, and 210 are repeated for one or more travel memberships in the travel membership information. If the determination, at block 210, is “NO,” method 200 may include assembling, by a processor, the P-BTI.

If the determination, at block 204, is “NO,” method 200 may loop to block 212, where the P-BTI is assembled by a processor.

Method 200 may, at block 214, may include determining, by a processor, whether the registered passenger has another luggage item. If the determination, at block 214, is “NO,” method 200 may include setting, by a processor, the first P-BTI to the main BTI, at block 216. If the determination, at block 214, is “YES,” method 200 may include setting, by a processor, the first P-BTI to the main BTI, at block 216. The same P-BTI may be used for multiple luggage items of a registered passenger. The luggage items may be linked virtually using an image of a second luggage item stored in the registered passenger profile 122.

FIG. 2B illustrates a global bag tag 230 with a permanent bag tag identifier (P-BTI) in accordance with an embodiment. Global bag tag 230 may include a P-BTI 236 that is compatible with the IATA rules, for example. The P-BTI 236 may be a 10-digit license plate with an adjacent barcode 240. In this example, the digits “000” are used as the carrier code, such as for a non-flying air carrier code. Other non-flying air carrier codes may be used. Furthermore, if the P-BTI is assigned by an air carrier, its IATA air carrier code would be used. The digit “7” is a leading digit used in IATA license plate numbers but may not be limited thereto. The digits “123456” may represent a permanent passenger's baggage number.

The license plate may be expanded to include other digits. In this example, the two-digit letter code “TT” in P-BTI 236′ may be representative of a two-character airline code for a non-flying airline. The digits “123456” represent a permanent passenger's baggage number. The P-BTI 236′ may be a 10-digit license plate with an adjacent barcode 240′.

The PMM code 238 uses digits “AAA” which are only representative to denote the difference between the P-BTI 236 or 236′ and the PMM code 238. The PMM code 238 may have a barcode 242 or a QR code. The PMM code may use other coding scheme such as the alphanumeric code digits of a length from 1-10 digits, such as 1-3 digits, 1-5 digits, and 1-8 digits.

When creating the P-BTI, the two-digit carrier code or three-digit code may be associated with an airline carrier code, where the airline carrier does not fly. In other embodiments, the two-digit carrier code may be an assigned code by IATA or other regulating entities for assigning carrier codes to airlines or other entities. Global bag tag 230 may include the passenger's name 246 associated with the registered passenger to which the P-BTI is assigned for repeated use over multiple carriers and multiple flights. The P-BTI may be readable by the BHS 63B of an airport infrastructure, but more importantly can be read in case the originating bag tag or other airline bag tagging system is damaged or lost.

According to one or more embodiments, the P-BTI may include a code representative of an originator of the GMMT bag tag number 250. The code may be associated with an airline carrier, a non-flying airline carrier or baggage handling service.

The GMMT bag tag number 250 may include a two-letter airline code and six digits or three-digit airline code and six digits. The six digits represent the passenger's bag number. In one or more embodiments, the passenger's bag number hides personal information of passenger. As the IATA license plate number expands, the GMMT bag tag number may expand as well. For example, the airline code two-letter code may expand. The airline code three-digit number code may expand over time. The six digits of the passenger's bag number may expand in length or instead of just digits, both alphabet characters and numerical digits may be used.

A computing device or web server 112 may communicate with a printing device or other machine to form a GMMT code indicum representative of the GMMT bag tag number 250 on a substrate 233. The GMMT code indicum may include the IATA license plate number and the IATA barcode representative of the license plate number. The GMMT code indicum may include the PMM code that may include the PMM number and a PMM barcode representative of the PMM number.

In one or more embodiment, the global bag tag 230 may include a tracking device 40′ denoted as a dashed circle. In this instance, the global bag tag 230 may include a housing with an enclosure for enclosing the tracking device 40′. The tracking device 40′ may include a patch antenna. GPS-5G tracking device can be connected to one or more in range compatible radio frequency networks for cell tower positioning, WI-FI positioning, Global Navigation Satellite System (GNSS) positioning, and BLUETOOTH Low Energy.

The tracking device may be configured to connect to an ad-hoc connection such as when WI-FI or a cellular communication tower is not available.

FIG. 2C illustrates a flowchart of a method 270 for forming a global bag tag in accordance with an embodiment.

Method 270 may include generating, by at least one of at least one processor, a global multi-mode travel (GMMT) bag tag number 250 for a luggage item of a registered passenger. The GMMT bag tag number 250 may include a permanently assigned license plate compatible with IATA regulations for a duration that is renewable or expires after a predetermined useful life or upon death, at block 272. The predetermined useful life may be in a range of one month up to 1 year, month up to 3 years, month up to 5 years, month up to 10 years, one month up to 20 years, or upon death.

Method 270 may include generating, by at least one of the at least one processor, a global tracking expanded baggage source message (GTE-BSM) 900 that includes the GMMT bag tag number 250 and a passenger name of the registered passenger, at block 274.

Method 270 may include forming, by a printing device, a GMMT code indicum representative of the GMMT bag tag number 250 on a substrate 233 to be affixed to the luggage item, at block 276, to form a global bag tag 230 (FIG. 2B).

### Tracking Devices—Geolocation

It is estimated that in the first quarter of 2022, 684,000 luggage items were lost and mishandled by the major US airlines. [Jake Hardiman and Anita Gallagher, “Luggage items g Why & How Often Does Luggage Get Lost?”, updated May 22, 2023, www.simpleflying.com/why-and-how-often-does-luggage-get-lost/.] While there have been many attempts at tracking luggage items, these have failed for various reasons.

Using RFID bag tags allows luggage items to be tracked along their route through an airport, but this solution suffers from two challenges. A first challenge is that all of the airports need to be retrofitted with RFID receivers and all bag tags need to be RFID compatible. This solution is extremely expensive and will require years to upgrade all airports to be able to track luggage items of the millions of passenger with RFID technology. The second challenge is the RFID technology may be limited to the airport infrastructure and cannot offer expanded luggage tracking outside of an airport or for tracking in structures of multi-modes of travel.

Another tracking capability is a tracking device of a user. Users can use various tracking devices which interface with a user's mobile communication device to display a location of the luggage item on a map, for example. However, this type of tracking has been known to be a challenge for the user and the airport to correlate the location in the airport infrastructure when using a GOOGLE map or another street map layout. Sometime, locating a luggage item needs to be done quickly before a passenger is off to another mode of travel. Another challenge is the ability of a user-based tracking device to be able to communicate when underground such as when being processed in the airport infrastructure.

In one or more embodiments, the global bag tag 230 may include a tracking device 40′.

In one or more embodiments, the tracking device may be configured to perform multiple modes or functions.

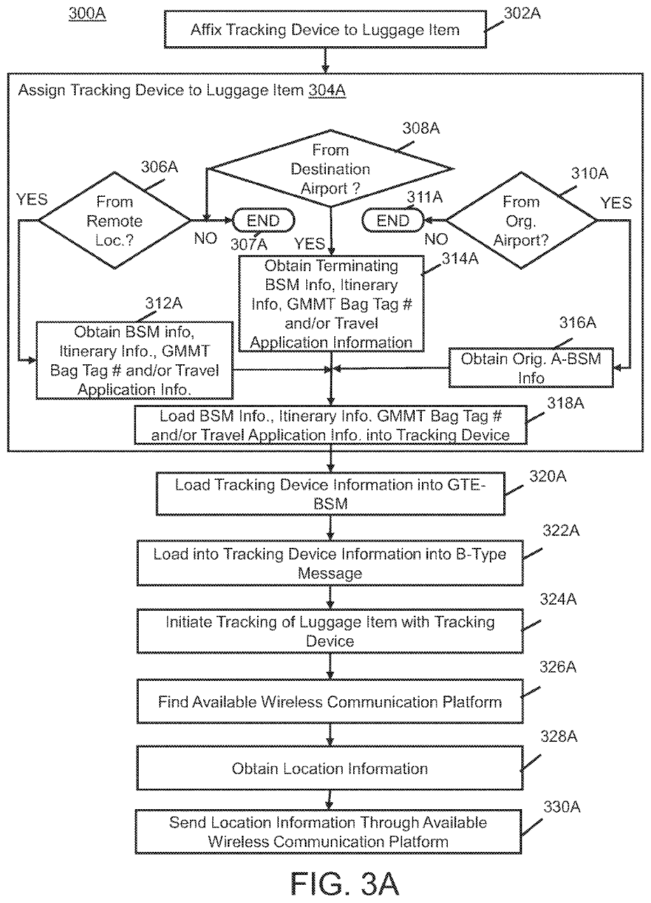

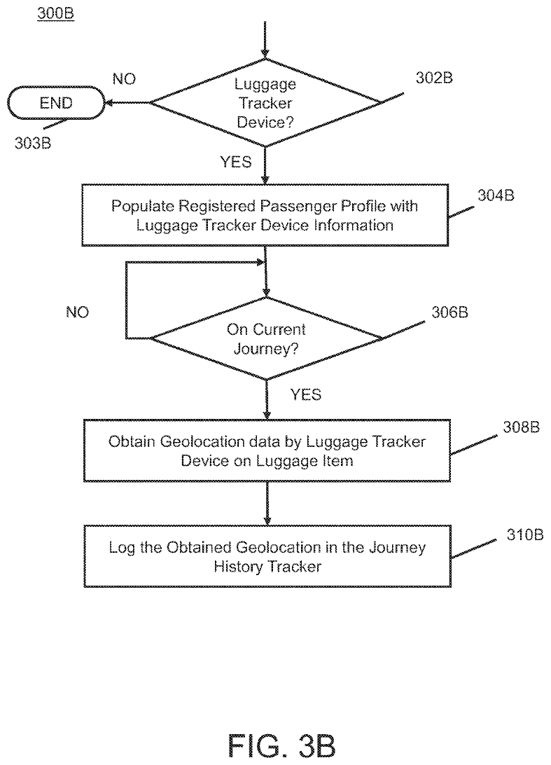

FIG. 3A illustrates a flowchart of a method 300A for assigning a tracking device 40 and initiating tracking of a luggage item in accordance with an embodiment. Method 300A may include affixing a tracking device 40 to a luggage item, at block 302A. Method 300A may include assigning, by a processor, the tracking device 40 to a luggage item, at block 304A. The assigning may include programming by the processor, the tracking device with at least one of a PNR number, an IATA license plate number or a GMMT bag tag number in memory. In an example, the assigning may include programming, by the processor, the tracking device with BSM information that includes reference indicators. The assigning may include programming, by the processor, the tracking device with a tracking device ID or, alternatively, receiving by the processor the tracking device ID from the tracking device.

The tracking device may be configured to be programmed with a travel application number or receive a travel application number. For example, a travel application number may include a PNR number in one or more embodiments. For example, a travel application number may include the IATA license plate number in one or more embodiments. For example, a travel application number may include the GMMT bag tag number in one or more embodiments.

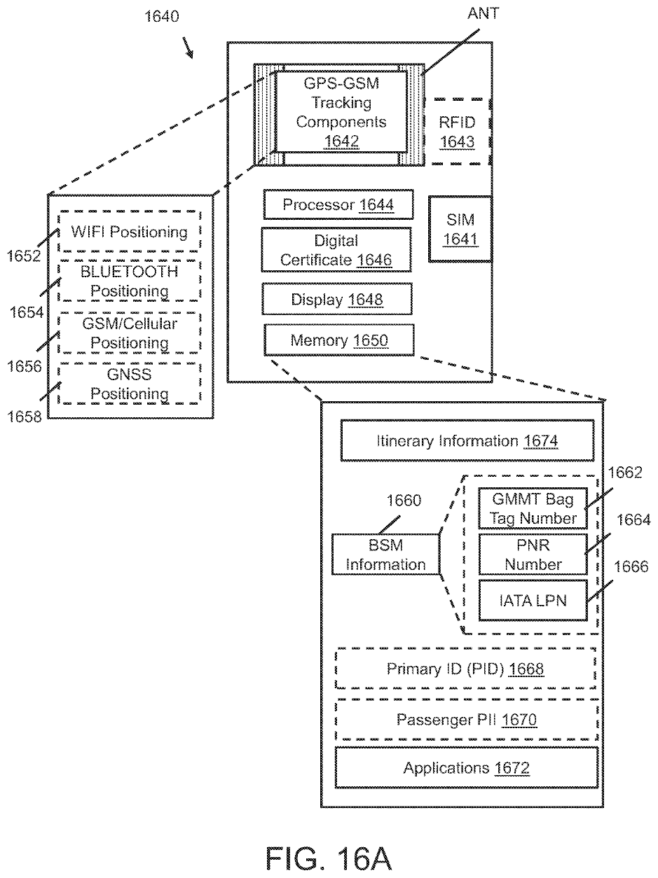

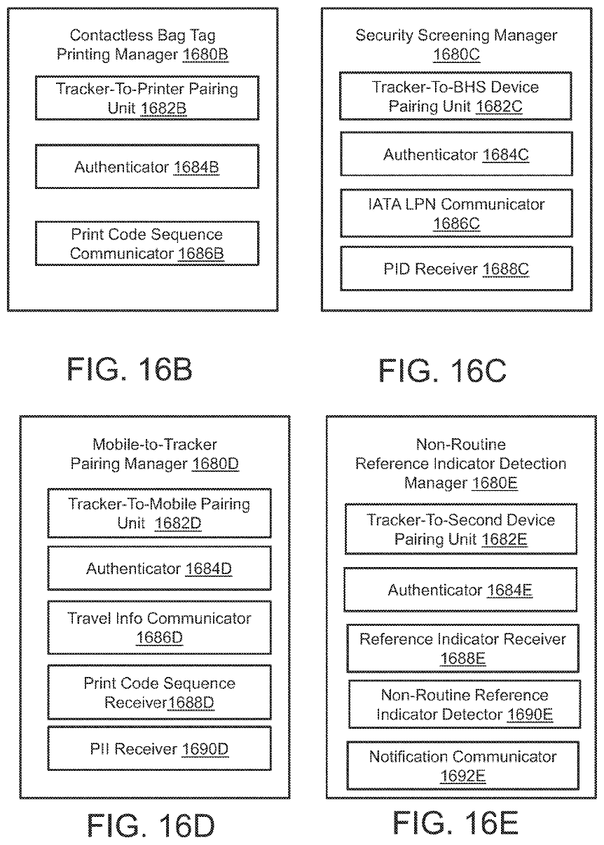

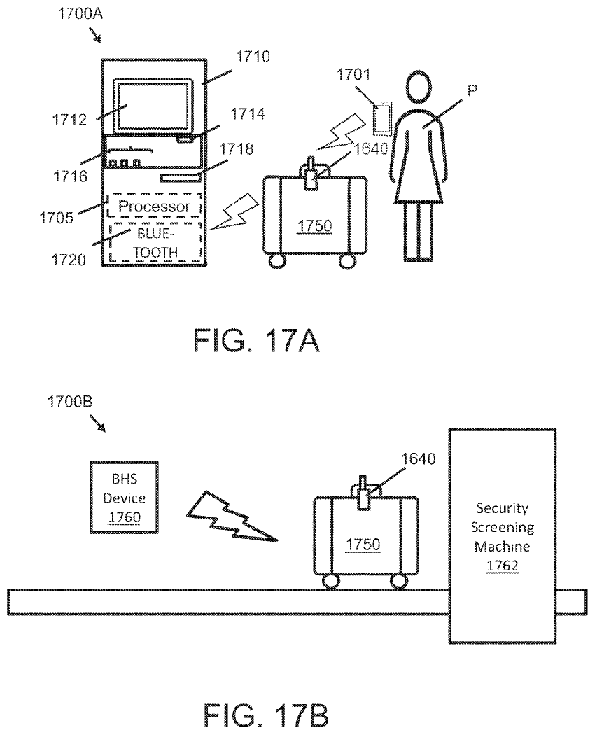

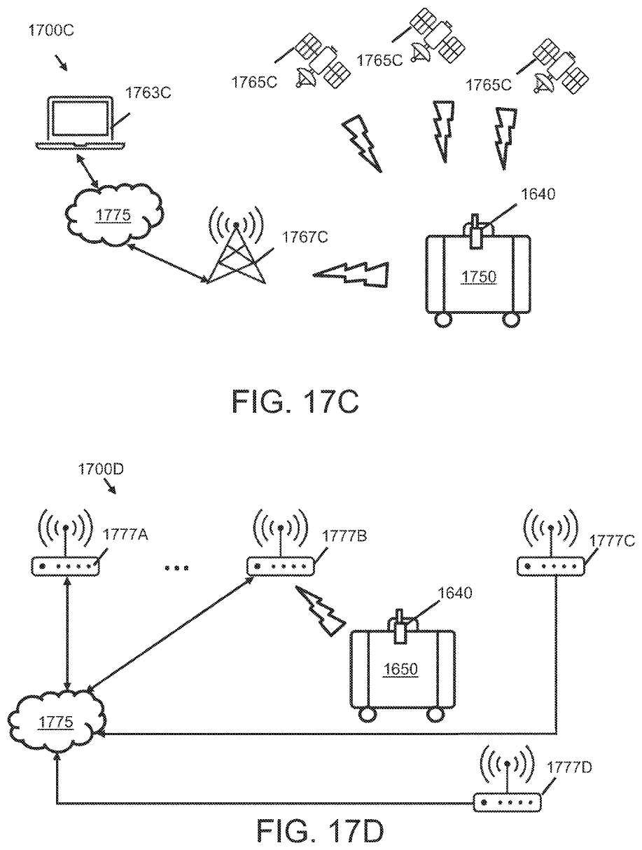

However, in operation, the travel application number (information) may be received by the tracking device after assignment or setup, as described later in relation to FIGS. 16A-16E and 17A-17D.

Block 304A may include determining, by a processor, whether the tracking device 40 is assigned at a remote location, at block 306A. For example, a tracking device may be assigned by a baggage handling service that picks up luggage items from a passenger's or traveler's home, or other designated address and transports the luggage item to an airport or another vehicle of travel. If the determination, at block 306A, is “NO,” the path from block 306A may end at block 307A. If the determination, at block 306A, is “YES,” method 300A may include obtaining, by a processor, BSM information from an airline, at block 312A. The BSM information may be from a BSM of an originating airline carrier. The BSM information may be from a global tracking expanded baggage source message (GTE-BSM) linking the global multi-mode travel (GMMT) bag tag number of the luggage item and one of the PNR number or the IATA license plate number. However, the airline BSM information is available provided the passenger has checked in with an airline carrier using a personal computing device or mobile communication device. In an example, from a remote location, the tracking device may be programed with itinerary information. The itinerary information may include a PNR number, a reservation number or other itinerary confirmation number from an itinerary of a vehicle of travel.

Method 300A may include determining, by a processor, whether the tracking device 40 is assigned from a destination airport/location, at block 308A. If the determination, at block 308A, is “NO,” the method from block 308A may end at block 307A. If the determination, at block 308A, is “YES,” method 300A may include obtaining, by a processor, BSM information from a terminating BSM, at block 314A, for example. The BSM may be an airline terminating BSM. The tracking device may be programmed with information described in relation to block 312A as well. In an embodiment, the tracking device may be provided as a service to the passenger as a reward for frequently purchasing a cruise or staying in a particular hotel (i.e., vehicle of travel).

Block 304A may include determining, by a processor of system 100, whether the tracking device 40 is assigned from an original airport, at block 310A. If the determination, at block 310A, is “NO,” the method from block 310A may end at block 311A. If the determination, at block 310A, is “YES,” method 300A may include obtaining, by a processor, A-BSM information from an originating airline BSM, at block 316A, for example. In an example, an airline carrier may provide as a service to the passenger a tracking device for a travel journey. The travel journey may be one-way or round-trip. The tracking device may be assigned at the counter by an air carrier agent. In another embodiment, the tracking device may be provided as a service to the passenger at another time, such as a reward for frequently flying. In another embodiment, the tracking device may be provided as a service to the passenger for always flying first class.

Block 304A may include, during the assigning process, loading the BSM information or information obtained in one of blocks 312A, 314A, or 316A, by a processor, into the tracking device, at block 318A.

In an example, the loaded information from the BSM may include an IATA license plate number of each luggage item associated with the registered passenger. In an example, the loaded information from the BSM includes an IATA license plate number of a luggage item associated with a non-registered passenger sharing the same PNR number. If an air carrier computing system assigned the tracking device, the tracking device would be loaded in a processor associated with a computer system of the air carrier. In an example, the processor may be a processor of system 100.

In an example, method 300A may include loading the tracking device information, by a processor of system 100, into the GTE-BSM, at block 320A.

In an example, method 300A may include loading the tracking device information, by a processor, into a B-Type message, at block 322A. The B-Type message may be a BPM, BCM, BTM or other IATA B-Type compatible message. The B-Type message may be generated by system 100 or other designated entity or computer system associated with an airline carrier or airport. The tracking device information may include the tracking device ID. The tracking device ID may be permanent or assigned.

The B-Type message carrying information associated with the tracking device may be used by the baggage handling system to be aware of the tracking device and signals emanating from such the tracking device within the baggage handling system. The B-Type message carrying information associated with the tracking device may be used in the security screening area to be aware of an approved tracking device in the area.

In an example, method 300A may include initiating tracking of the luggage item with the tracking device, by a processor of system 100 or other computer system designated for tracking, at block 324A. For example, an airline carrier may have a designated computer system for tracking the tracking device of the luggage item.

In an example, method 300A may include finding, by the tracking device, an available wireless communication platform to make a communication connection, at block 326A. The tracking device may include a GPS-GSM communication device configured to receive Global Navigational Satellite System (GNSS) signals. The tracking device may be configured to communicate with WI-FI wireless communication platforms, BLUETOOTH wireless communication platforms, long-term evolution (LTE) wireless communication platforms, cellular wireless communication platforms, GSM-5G wireless communication platforms, long-range communication platforms, short-range communication platforms, radio frequency identification communication platforms and near-field communication platforms. In one or more embodiments, the tracking device may establish a wireless RF communication connection using ad-hoc protocols or connect with Internet of Thing (IoT) devices. The tracking device may be configured to communicate using one of wireless communication platforms to send the location information to a network interface of a computing system.

In an example, method 300A may include obtaining, by the tracking device, location information, at block 328A, and sending, by the tracking device, the location information through the available wireless communication connection platform, at block 330A.

The tracking device may include an inertial navigation system (INS) for Global Navigational Satellite System (GNSS)-denied environments. In GNSS-denied environments, the obtained location information may be obtained from the INS. The tracking device may include a Global Positioning System (GPS) unit. The tracking device may include other location determination protocols or location derivable locations based on locations of surrounding devices such as IoT devices, BLUETOOTH-enabled, or RF access points when available. IoT devices BLUETOOTH-enabled, or RF access points may be found in hotels, cruise ships, airports, restaurants, stores, and buildings, for example. RF access points may support various RF communication platforms including, without limitation, WI-FI communication protocols or GSM-5G communication protocols.

When underground, the tracking device may use a mobile ad-hoc communication protocol as airport staff devices may be capable of being an ad-hoc node for delivering location information from underground out to either wired or wireless communications networks above ground.

The location information may be sent to a network interface of a computing system associated with the at least one processor of system 100, a computer system designated to track tracking devices, a computer system associated with an airline carrier or other vehicle of travel. The location information may include location coordinate data of the tracking device and the loaded information from the BSM.

In addition to providing location information, the tracking device may operate in other modes to interact with vehicle of travel devices including, without limitation, a Kiosk, RFID receiver, baggage handling system, mobile communication device of the passenger, and more.

By way of a non-limiting example, the tracking device may be collected or removed at the end of a leg of travel such as at the end of a flight, an end of a cruise, an end of a stay at a lodging entity, etc. The tracking device after removal may be reprogrammed for another luggage item of a different passenger for reuse by a mode of travel, for example.

In one or more embodiments, the tracking device may be assigned for an entire round trip that includes multiple modes of travel. At the end of the round trip, the tracking device after removal may be reprogrammed for another luggage item of a different passenger for reuse during an entire round trip, for example.

FIG. 3B illustrates a flowchart of a method 300B for tracking a luggage item in accordance with an embodiment. Method 300B may include determining whether there is a luggage tracking device (i.e., wireless tracking device 40). If the determination, at block 302B, is “NO,” method 300B may end at block 303B. If the determination, at block 302B, is “YES,” method 300B may include populating a registered passenger profile with a luggage tracking device information of a registered passenger, at block 304B.

Method 300B may include determining if the passenger is on a current travel journey, at block 306B. If the determination, at block 306B, is “NO,” method 300B may loop back to the start of block 306B. If the determination, at block 306B, is “YES,” method 300B may obtain the geolocation data by the luggage tracking device that is on the luggage item, at block 308B. Method 300B may include logging the obtained geolocation data in the journey history tracker, at 310B.

### Contactless Payment Parking

FIG. 4A illustrates a flowchart of method 400 for contactless parking payment in accordance with an embodiment. System 100 may allow the registered passenger (i.e., registered user) to store data in their registered passenger profile 122, which allows for contactless parking payment upon the registered user driving a vehicle to a hotel, resort, or lodging entity.

Currently, parking lots allow users to pay for parking in advance by exiting the vehicle and paying at a dedicated payment machine or kiosk. However, sometimes, there are long lines to wait to use the payment machine. In other instances, user's feel unsafe when it is dark or an unknown location. Still further, at other times, machines can malfunction or the user's payment method may not be accepted for various reasons. In view of these reasons, users may download an application for the parking lot to pay for parking. However, each parking lot owned by a different company can require a different application to be downloaded onto a mobile device. This can become even more of a challenge when the user is an out-of-town traveler without direct knowledge of the parking lot/garage owners to obtain the applications.

Parking can be more challenging when popular events are hosted at a venue. Nearby parking lots and garages can be filled quickly. Hunting for an available parking lot can be a challenge as it can require moving from one floor to another floor only to find out that no parking spots are available. In one or more embodiments, computing systems of parking lots or parking garages may send information representative of available parking spots to a processor of system 100.

Method 400 may include determining, at block 402, if the registered user has signed up for contactless parking payment service in the registered user profile (i.e., registered passenger profile 122 FIG. 1A-1B). The registered user profile may store a global multi-mode travel bag tag number associated with a luggage item of the registered user.

If the determination, at block 402, is “NO,” method 400 may end at block 403. If the determination, at block 402, is “YES,” method 400 may include populating a registered passenger profile 122 with a vehicle's license plate number (VLPN) 196 of the registered passenger (i.e., registered user or registered traveler), at block 404. The VLPN 196 may be entered using the passenger registration GUI 124. Method 400 may allow a user or traveler (i.e., passenger) to pre-register their own car for contactless parking payment service. However, the user or traveler may alternately rent a car, which will be discussed later.

In one or more embodiments, a user may provide an image of the license plate of their vehicle's license plate. The processor may also translate the digits into machine-encoded readable text and store the text digits as the registered VLPN using computer vision or machine learning algorithms.

For example, the registered user may be traveling to a hotel, resort, or lodging entity with their own vehicle. The hotel, resort, or lodging entity may have a vehicle license plate scanner, which determines the entry of the vehicle into the parking lot. The system 100 may pay the parking without the user needing to use a credit card or getting their parking ticket validated using the hotel, resort or lodging entity. The scanned license plate when read by a scanner 75 (FIG. 1B) of a parking garage associated with the hotel, resort, or lodging entity or vendor of the hotel, resort, or lodging entity may then be sent to web server 112 for payment of the parking fee. In one or more embodiments, system 100 may provide a discount on the parking rate or other membership value points that can be transferred to services provided directly or indirectly by system 100.

Method 400 may include determining, at block 406, if the registered user has a reservation, such as by a PNR number or from TMI information being received from reservation systems. The reservation may be for a hotel, resort, or lodging entity, for example. The reservation may be for a rental car. For the sake of brevity, in this instance “reservation” may also look for information that matches information that matches demographic information stored as PI 129. The matched information may include information that may include historical data from past events attended or registered to attend through location data, hotel reservations or the like. Method 400 may include determining, at block 407, if the registered user has a hotel reservation, at block 407. If the determination is “NO,” method 400 may proceed to block 409.

In one or more embodiments, at block 406, the TMI information may have been received prior to or after the VPLN information is received from the computing device of the parking system by a process of the system 100. The PNR database 63C (FIG. 1B) may be accessed using the PNR number. At block 406, the method 400 may include querying, by a processor of the system 100, a hotel reservation system associated with a hotel company for determining whether a hotel reservation exists for the traveler. In one or more embodiments, at block 406, the method 400 may include accessing, by a processor of the system 100, stored PMM travel information stored in the traveler profile to obtain reservation information. At block 406, the method 400 may include querying, by a processor of the system 100, demographic information, memberships and travel history 184. At block 406, the method 400 may include querying, by a processor of the system 100, recent purchases of tickets for sports events, entertainment events, conferences, trade shows, or the like. The information associated from these purchase can be used to identify date, location and a window of time a parking sport may be needed.

If the determination, at block 406, is “NO,” may determine whether the user has identified to track their location, at block 409. If the determination, at block 409, is “NO,” method 400 may end at block 403. If the determination, at block 409, is “YES,” method 400 may proceed to block 411, as will be discussed later. It should be understood, at block 409, if the user provides permission to track the location of their mobile communication device on any travel leg or locally to go to an event, for example, the system 100 may be used to find a parking spot.

If the determination, at block 407, is “YES,” method 400 may include determining, at block 408, if a rental car reservation is found. The rental car reservation may have been received from the TMI information or from a query by a processor of system 100. If the determination, at block 408, is “NO,” method 400 may set the current VLPN to the VLPN stored in the registered passenger profile 122, at block 410. If the determination, at block 408, is “YES,” method 400 may include receiving a rental car (RC) license plate number (LPN), at block 412. In one or more embodiments, a determination may be made whether there is a match of a rental car reservation and hotel reservation for a registered traveler during an overlapping time window, for example.

The rental car license plate number may be received through the reservation system, in one or more embodiments. In one or more embodiments, the rental car license plate number may be received by a processor of the system from a mobile communication device of the registered user or traveler. The license plate may be registered under the contactless parking service feature. By way of a non-limiting example, the registered user may capture an image of the license plate of the rental car and send it to the system 100 for registration under the contactless parking service feature. Since this is a rental car, the use of the license plate may be valid for a duration of the rental car reservation (i.e., window of time), for example.

The processor may use computer vision or machine vision algorithms to translate the digits in the image to machine-encoded readable text, for example. The text of the VLPN associated with the rental car may be stored in the registered passenger profile. The method 400 may include storing, by a processor, the digits of the registered VLPN associated with the rental car.

Method 400 may include setting the current VLPN to the rental car (RC) license plate number (LPN), at block 414.

Method 400 may include receiving, by a processor, information representative of a captured VLPN from a parking garage scanner 75 in communication with a computing device of a parking system of a hotel, resort, or lodging entity, at block 416.

In one or more embodiments, the parking garage may include scanners for capturing a face of a driver of the vehicle. The computing system of PK 71 may perform facial recognition to recognize and match the identity of the driver. The computing system of PK 71 may send the identity or the image of the face to a processor of system 100. In one or more embodiments, the computing system of PK 71 may send system 100 information related to parking spot availability. For the sake of brevity, processors of system 100 may communicate with computing systems of other parking lots or parking garages to determined their availability. These parking lots and garages may allow for contactless parking through system 100 by communicating the VLPN, driver identity, or face image, in compliance with a contractual agreement.

Method 400 may include determining, by a processor of system 100, whether there was a match to the VLPN and/or face (i.e., identity) stored in the profile 122, at block 417. If the determination, at block 417, is “YES,” the method 400 may proceed to block 418. At block 418, method 400 may include notifying the user of the results of the match through their mobile communication device. In this instance, the amount of the parking fee may also be sent to the user.

Method 400 may include debiting or charging, by a processor of system 100, their (i.e., user) account (i.e., credit card or banking information) using the payment method of record in the registered passenger profile 122, at block 420. Method 400 may include paying, by a processor of system 100, the hotel, resort, lodging entity, or a corresponding parking entity 71 (FIG. 1B), at block 422. Block 422 may include causing, by a processor of system 100, a financial institution to send funds through a banking automated clearing house (ACH) network to an account for the hotel, resort, lodging entity or corresponding parking entity 71 (FIG. 1B). Alternately, the method 400 may record the use of the service and the amount of the parking fee.

If the determination, at block 417, is “NO”, the method 400 may proceed to block 424 where the traveler may be notified of the results of the match through their mobile communication device. Method 400, from block 417, may proceed to block 403 to end the process.

Returning to block 411, the system 100 with permission of the user, may track the location of their mobile communication device. The GUIs of system 100 may automatically, or allow the user to ask the system, to find a parking spot, such as for an event, at block 411.

Method 400 may include identifying, by a processor of the system 100, a location of the parking spot (i.e., parking lot or parking garage), at block 413. The identifying of a location of a parking spot may include causing a display, by a processor of the system of a location on a map displayed on a display screen that displays a current location of the user's mobile communication device. The processor of the system 100 may use the current location data of the mobile communication device to indicate the proximity of the parking spot and directions to the parking spot. In one or more embodiments, the processor of the system 100 may use the current location data of the mobile communication device to indicate the proximity of a plurality of parking spots and directions to the parking spots. The plurality of parking spots may be ranked by proximity to the current location of the user. The plurality of parking spots may be ranked by proximity to the location of the event. The plurality of parking spots may be ranked by parking fee. The metadata such as the proximity data, parking fee, and directions may be overlaid on the map.

FIG. 4B illustrates a flowchart of a method 430 for accessing B-Type messages for travelers using contactless parking payments in accordance with an embodiment. The B-Type messages are generated by the BHS 63B (FIG. 1B) and may be stored in a computing system associated with an airline carrier on which a passenger travels, for example. In one or more embodiments, the system 100 may receive the B-Type messages and sort the messages based on a master travel manifest.

In one or more embodiments, method 430 may include matching, by a processor of system 100, a B-Type message to a registered traveler in a master travel manifest 109 having a registered passenger record created from a registered passenger profile 122 for multi-mode travel management, at block 432. The B-Type message may be stored in B-Type message database 107. In this instance, the matching may include matching at least one of: the passenger name, a PNR number, or an IATA bag tag number. For example, the passenger may not be using the baggage handling service and transporting their own luggage. In one or more embodiments, the passenger may allow the baggage handling service to take their luggage items for transport or special handling to a cruise ship while staying in a hotel a night or more prior to embarking on a voyage.

Method 430 may include determining, by a processor of system 100, that the B-Type message is a terminating baggage source message for a destination airport, at block 434. If the determination, at block 434, is “NO” the method 430 ends at block 436.

If the determination, at block 434, is “YES” the B-Type message indicates that the luggage item is terminating its journey from the perspective of the current airport. However, the registered passenger may have a hotel reservation and/or a rental car reservation and traveling independently of their luggage item. The reservations may have been obtained from the corresponding reservation computing systems or by querying the computing systems using the PMM information. In this instance, method 430 may loop to FIG. 4A, at block 402 to determine if the registered passenger is registered for contactless parking payment.

The method of FIG. 4B may be used for travelers using an airline leg of travel followed by a hotel stay. The method of FIG. 4A may be used alone such as in the case when a traveler uses their own car or a rental car to travel along a leg of travel to a hotel, resort or lodging entity. The master manifest may include one or more master manifests. A master manifest may include a manifest for travelers traveling by an air carrier. A master manifest may include a manifest for travelers traveling by train. A master manifest may include a manifest for travelers traveling by a bus. A master manifest may include a manifest for travelers traveling by a ground vehicle, such as a rental car. A master manifest may include a manifest for travelers having a reservation with a lodging entity, cruise ship or other vehicle of travel.

### Luggage Item Manifest Record

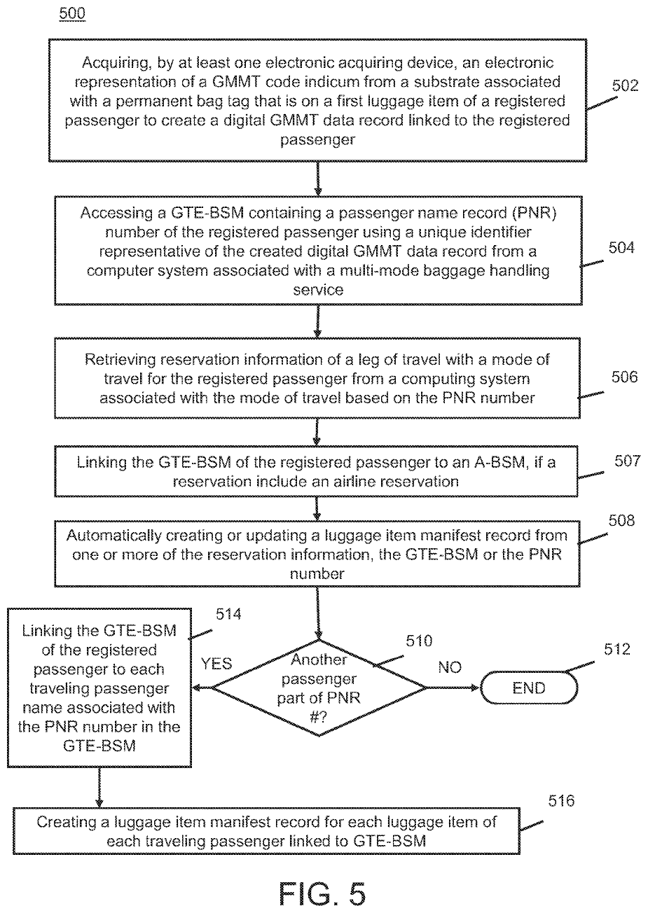

FIG. 5 illustrates a flowchart of method 500 for generating and/or updating a luggage item manifest record in accordance with an embodiment. Method 500 may include, at block 502, acquiring, by at least one electronic acquiring device, a representation of a global multi-mode travel (GMMT) code indicum on a substrate associated with a permanent bag tag that is on a first luggage item of a registered passenger to create a digital GMMT data record linked to the registered passenger. The GMMT code indicum may be compatible with an IATA license plate.

The method 500 may include, at block 504, accessing, by a processor, a GTE-BSM containing a passenger name record (PNR) number of the registered passenger using a unique identifier representative of the created digital GMMT data record from a computer system associated with a multi-mode baggage handling service.

The method 500 may include, at block 506, retrieving, by the processor, reservation information of a leg of travel with a mode of travel for the registered passenger from a computing system associated with the mode of travel based on the PNR number.

In one or more embodiments, block 506 may include retrieving, by the processor, check-in information of a return leg of travel of the registered passenger with a designated return travel carrier using information associated with the PNR number. The luggage item manifest record may be populated with the retrieved check-in information of the return leg of travel.

In one or more embodiments, the steps of block 506 may include retrieving, by the processor, the reservation information of a leg of travel with a mode of travel for the registered passenger from a computing system associated with the mode of travel based on the PNR number.

The steps at block 506 may include one or more of: querying, by the processor, a reservation system associated with the airline company for a destination airport location of a baggage travel journey; querying, by the processor, a reservation system associated with the hotel company for a hotel reservation location for the baggage travel journey; and querying, by the processor, a reservation system associated with the cruise line company for a cruise reservation location for the baggage travel journey. The querying of the reservation system of the PMM travel information and any reservation data found may be used to build the baggage travel journey record, shown in FIGS. 11A-11C.

The steps of block 506 may include populating the baggage travel journey record with at least one of the destination airport location information, the hotel reservation location information, and the cruise reservation location information. In one or more embodiments, the reservation information may include an airline reservation.

Method 500 may include, at block 507, linking, by the processor, the GTE-BSM of the registered passenger to at least one airline baggage source message (A-BSM) for each luggage item including the first luggage item associated with the registered passenger in the GTE-BSM, wherein each luggage item has a corresponding A-BSM. The A-BSM includes an IATA license plate number for the luggage item of the registered passenger.

The steps of block 507 may include accessing, by the processor, an airline baggage source message (A-BSM) stored in a memory device coupled to a computer system associated with an airline travel carrier; merging one or more fields of the A-BSM into the GTE-BSM; and storing, indexing, or addressing the GTE-BSM with the merged fields of the A-BSM in the computer system of the multi-mode baggage handling service. While the foregoing is directed to linking with messages of an airline carrier, the disclosure is not limited thereto and may encompass appending other message types or information obtained from databases from other modes of travel or vehicles of travel.

Method 500 may include populating, by the processor, the luggage item manifest record with one or more of the destination airport location, the hotel reservation location, or the cruise reservation location. Other modes of travel may include trains, buses and/or ferry vehicles.

Method 500 may include, at block 508, automatically creating, by the processor, a luggage item manifest record from one or more of the reservation information, the GTE-BSM, or the PNR number.

Method 500 may include, at block 510, determining, by the processor, whether another passenger is part of or associated with the PNR number in addition to the registered passenger's name. If the determination, at block 510, is “NO,” method 500 may end at block 512. If the determination, at block 510, is “YES,” method 500 may include, at block 514, linking, by the processor, the GTE-BSM of the registered passenger to each traveling passenger name associated with the PNR number in the GTE-BSM.

In the scenario where the reservation information includes an airline reservation, the steps at block 514, may include linking, by the processor, the GTE-BSM of the registered passenger to each airline baggage source message (A-BSM) for each luggage item of each traveling passenger name (non-registered passenger) associated with the PNR number in the GTE-BSM, wherein each luggage item has a corresponding A-BSM. For other vehicles of travel, other messages may be appended to the GTE-BSM for each traveling passenger name associated with the PNR number.

The method 500 may include, at block 516, creating, by a processor, a luggage item manifest record for each luggage item of each traveling passenger linked to the GTE-BSM. The luggage item manifest record may include the name of the registered passenger and each non-registered passenger.

The luggage item manifest record may be merged into a passenger manifest record of a manifest. In one or more embodiments, the manifest may be associated with a mode of travel (i.e., vehicle of travel).

### Check-In Originating Leg of Travel

FIG. 6A illustrates system 600 for digitizing luggage custody and luggage check-in in accordance with an embodiment. System 600 may be part of system 100, in one or more embodiments. System 600 may include those element/components below dashed line B-B. However, the system may also include the global bag tag 230 affixed to the passenger's luggage item, which is shown above the dashed line B-B.

System 600 may include at least one first processor 610 and at least one second processor 626 in wired or wireless communications with each other. The at least one second processor 626 may be connected to tangible, non-transitory memory storage device 690. System 600 may include at least one baggage storage location 634 to temporarily store luggage items. System 600 may include other computing devices 648 to acquire bag tag identifiers or other information affixed to the luggage item as will be described later. The second processor 626 may communicate with at one computing system of computing systems 628 via network 624, such as the Internet or a public communications network. The second processor 626 may communicate with other computing systems that the passenger has reservations with for a leg of travel.

In one or more embodiments, system 600 may interface with system 100 to receive the P-BTI and to link to information in the registered passenger profile 122 (FIGS. 1A-1B). The terms “registered passenger profile,” “registered traveler profile” and “registered user profile” may be used interchangeably herein. For the multi-mode of travel journey, the luggage item 614 tagged with the global bag tag 230 may be picked up at any designated location entered by the registered passenger 616, for example. This may be entered using a graphical user interface on a computing device or mobile communication device.

The first processor 610 may be a scanner or acquiring device to scan the P-BTI 236 or 236′ on the global bag tag 230 where a representation of the P-BTI 236 on a substrate is acquired. The first processor 610 may capture an image of the registered passenger's driver's license 982 (FIG. 9B) or identification (ID) 620 to verify the identity of the registered passenger. For trains, buses, and cruise ships, luggage items may not require check-in within a certain window. Therefore, luggage items may be taken to baggage storage location 634 before taking the luggage items to the destination location for loading on a train, bus, or cruise ship. However, for airline carrier modes of travel, check-in windows are regulated for both the passenger and the luggage item.

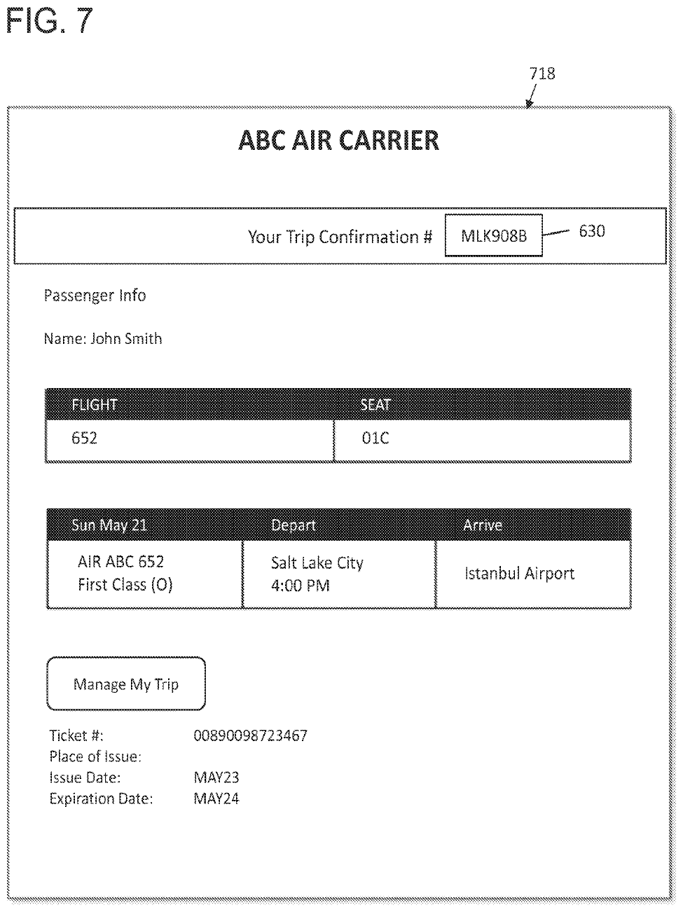

In one or more embodiments, the first processor 610 may receive PNR number 630 or other identifier from a confirmed itinerary 718 (FIG. 7) for a flight with at least one airline carrier. The itinerary or reservation data may be stored in PNR database 63C. The first processor 610 may receive information that confirms an identify of the passenger associated with the PNR number from the confirmed itinerary 718 to pick up and transport luggage associated with the PNR number to a baggage location 634 from a passenger location 605. The confirmed itinerary 718 (FIG. 7) may be created by computer systems 628 (i.e., reservation system 62 FIG. 1B) associated with an air carrier or travel management system (TMS), for example. In one or more embodiments, the confirmed itinerary may be for other modes of travel where the PNR number is generated by other reservation systems described herein or a TMS. Each reservation system may have a PNR database with reservation information. The PNR database 63C may include check-in information of a return leg of travel of the registered passenger with a designated return travel carrier. The return leg of travel data may be accessed using the PNR number and instructions from an airline carrier.

In one embodiment, system 600 includes an imaging device in communication with the first processor 610. The imaging device and first processor 610 may be integrated into a single device, such as a smart phone, mobile communication device, tablet, notebook, or other camera-enabled portable computing device. The imaging device may capture an image of each luggage item (LI) 614 (hereinafter referred to as “LI images 606”) associated with the P-BTI 612, prior to departing passenger location 605.

In one embodiment, the imaging device may capture an image of an identification instrument 620 (hereinafter referred to as “ID image 604”) issued to the passenger. The user of the first processor 610 and imaging device may verify the identification of the passenger to reconcile with the PNR number 630 and P-BTI 612. The PNR number 630 may be associated with at least one person. However, at the time of pickup of at least one luggage item 614, only one individual in the PNR number may need to be verified. In one or more embodiments, all the passengers need to be present, and all identifications of adult passengers verified.

The first processor 610 may communicate with the second processor 626 the PNR number 630, the verification 602, the ID image 604, the LI images 606, geo location (LOC) information 608, and P-BTI 612 (i.e., P-BTI 236 or 236′) in bracket 632. By way of non-limiting example, the smart phone or other mobile computing device may include a Global Positioning System (GPS) receiver to receive signals from a GPS to identify the location of the first processor 610. The digitized information in bracket 632 may be used to eliminate the need for a printed valet tag for tagging the luggage item. The verification 602 may include the verification of the identity of the registered passenger, for example. The verification 602 may include a verification of other information such as a confirmation of purchase of a ticket or other tickets for travel with a vehicle of travel.

Verification 602 may include validating the identity of a passenger using a state-issued eligible driver's license or identification in a TSA approved digital wallet on a mobile communication device. In one or more embodiments, a passenger may download a TSA approved digital ID application. TSA.gov provides examples of mobile driver's license and digital identification requirements for APPLE WALLET, GOOGLE WALLET, and SAMSUNG WALLET. Other applications are through a state's DMV, such as the California DMV Wallet Application. Still further other applications may be available by an airline carrier, such as the AMERICAN AIRLINE Digital ID Application.

The confirmation may include a confirmation for reservations. The verification 602 may include the verification of the identity of non-registered passengers, for example, that are listed in a PNR database and associated with the PNR number. This may include verification of their identity and in one or more embodiments, a confirmation of purchase of a ticket or other tickets for travel. The verification process may include performing facial recognition based on the image of the registered passenger and a stored image of the registered passenger. The verification process may use Department of Motor Vehicle (DMV) records, or other authenticating facial recognition database to authenticate the identity of a person. In one or more embodiments, other biometric data may be used, such as fingerprints, retinal scans, etc.

Baggage location 634 may house other luggage items 638 and 686. Luggage item 686 may be provided with a tracking device 680. Luggage item 638 may be provided with a tracking device 642. By way of a non-limiting example, when the window for each luggage item is open for check-in, the tracking device may be activated by computing device 648, via signal 650, to locate the particular luggage item, where the tracking device 642 or 680 may send an audible alert or sound or visible indicator. The luggage item may be checked in with a DCS 63A (FIG. 1B) (i.e., computer systems) associated with an airline carrier using Internet communication or public communication utilities infrastructure.

Tracking devices 642 and 680 are examples of temporarily assigned tracking devices. These tracking devices may be programmed with the GMMT bag tag number, for example, and/or the PNR number. Any of the luggage items of a group may be programmed with the GMMT bag tag number or the PNR number.

FIGS. 6B-6D illustrates a flowchart of a method for checking-in a passenger and/or generating a luggage item manifest in accordance with an embodiment.

With specific reference to FIG. 6B, method 660 may include acquiring, by an electronic acquiring device, representation of a global multi-mode travel (GMMT) code indicum associated with a global bag tag on a substrate that is on a first luggage item of a registered passenger to create a digital GMMT data record linked to the registered passenger, at block 662.

Method 660 may include accessing, by at least one processor, the GTE-BSM containing a PNR number of the registered passenger using a unique identifier representative of the digital GMMT data record from a computer system associated with a multi-mode baggage handling service, at block 664.

Method 660 may include retrieving, by at least one processor, check-in information of a leg of travel of the passenger with a designated travel carrier using information associated with the PNR number, at block 666.

Method 660 may include checking in, by at least one processor, the first luggage item with the designated travel carrier based on the retrieved check-in information for the leg of travel, at block 668. The check-in process may vary depending on the type of vehicle of travel. For example, the check-in for a leg of travel via a cruise ship may be different than the process for checking in for a leg of travel via an air carrier. The process for checking in with an air carrier is described in relation to FIG. 10B. An example process 668′, for checking in with an air carrier for a return flight, is described in relation to FIG. 6C. Checking in for a cruise ship may require providing a passport, driver's license, a Real ID, a birth certificate, or other proof of citizenship as required by each country's government.

Method 660 may include automatically creating, by a processor, a luggage item manifest record from the digital GMMT data record and the PNR number, at block 670. The luggage item manifest record may include data for check-in of a leg of travel of the luggage item with the designated travel carrier. The check-in data varies based on the vehicle of travel.

In one or more embodiments, the luggage item manifest record may be merged or populated into a VOT manifest. This may be part of a check-in process for a particular VOT. The VOT check-in process may confirm a ticket is purchased. The VOT check-in process may confirm an identity of a passenger.

With specific reference to FIG. 6C, process 668′ may include determining, at block 672, whether the check-in is a return flight check-in. If the determination is “NO,” the process 668′ may end at block 676. If the determination at block 672 is “YES,” process 668′ may include, at block 674, electronically acquiring, by the electronic acquiring device, a representation of an originating airline bag tag identifier (A-BTI) associated with or printed on a printed bag tag from an originating airline carrier that is on the first luggage item of the registered passenger to create a digital A-BTI data record linked to the originating airline carrier. The A-BTI includes an IATA license plate and the A-BTI data record is representative of the IATA license plate number. The acquiring device may scan a barcode on the IATA bag tag or another marker with the IATA license plate number to convert the barcode to a digital license plate number. The step for creating a luggage item manifest record, at block 670, may include using information from the digital A-BTI data record and the PNR number.

Process 668′ may include, at block 678, checking in, by at least one processor, the first luggage item or passenger and the first luggage item with the designated return travel carrier based on the retrieved or stored return flight data, after scanning the IATA bag tag to obtain the return flight from a PNR database, for example, associated with an airline travel carrier. The process can check in other luggage items with the same process.

Process 668′ may include, at block 679, causing, by at least one processor, a printing device to print an IATA bag tag for the return flight with the designated return travel carrier. When the luggage item is checked in, the DCS may generate the IATA bag tag for the return flight. However, scanning one of the originating IATA bag tag or the GMMT bag tag may be used to print the IATA bag tag for the return flight at a later time using a graphical user interface.

The check-in process can be repeated for non-registered passengers, as described in relation to FIGS. 10B-10C. Thus, the process of FIG. 6C may be performed for those non-registered passengers that include an IATA bag tag from the originating flight. The process can be repeated for additional luggage items.

With specific reference to FIG. 6D, block 664 may include various steps shown in FIG. 6D. Method 660 or the process of block 664′ may include obtaining from an electronic acquiring device a representation of the acquired global multi-mode travel (GMMT) code indicum associated with a global bag tag on a substrate that is on a first luggage item of a registered passenger to create a digital GMMT data record linked to the registered passenger, at block 663A.

Method 660 or the process of block 664′ may include electronically acquiring, by at least one processor, a representation of at least one preferential multi-mode (PMM) travel code indicum representative of at least one PMM travel code on a substrate associated with the bag tag on the first luggage item to create a digital PMM data record linked to the registered passenger, at block 663B.

Method 660 or the process of block 664′ may include receiving an electronic communication, from the acquiring device, by a processor, the communication including tracking information that includes a geolocation data associated with the acquiring device, time, date and the GMMT data record or PMM data record, at block 663C.

Method 660 or the process of block 664′ may include accessing, by the at least one processor, PMM travel information associated with the digital PMM data record in a database of the computer system associated with the multi-mode baggage handling service, at block 665.

Method 660 or the process of block 664′ may include logging, by at least one processor, the tracking information in a registered passenger profile or a travel history database of the registered passenger, at block 665′.

FIG. 7 illustrates an example confirmed itinerary 718 for an air flight in accordance with an embodiment. The confirmed itinerary 718 includes at least one of a PNR number 630, a passenger name, flight reservation information, and a purchased ticket number.

FIG. 8 illustrates an airline baggage source message (A-BSM) 800 for an airline carrier. The airline carriers generate and/or store one or more B-Type messages. One or more of the B-Type messages may be generated by a BHS 63B (FIG. 1B) as the luggage items are transported and tracked through an airport environment. The B-Type messages may include one or more of baggage transfer message (BTM), baggage source message (BSM), baggage processed message (BPM), baggage unload message (BUM), baggage not seen message (BNS), baggage control message (BCM), baggage manifest message (BMM) and baggage request (BRQ). The IATA bag tag number is part of the baggage messages. The system 100 may store or have access to those B-Type messages generated on the travel days by the BHS 63B (FIG. 1B) for the airline carriers for those registered passengers and associated non-registered passengers to also assist in the recovery of anomalous luggage items.

A-BSM 800 may be communicated in teletex or other communication methods. It should be understood that each airline carrier has their own A-BSM format. The A-BSM being accessed should have a passenger name record (PNR) number. The PNR number may include alphanumeric characters. An A-BSM is an IATA compatible BSM created by an airline carrier computing system such as when a passenger checks in for their flight and may indicate the intention of checking in a luggage item, for example. An A-BSM is created by an airline carrier computer system such as when a passenger checks in for their flight at the airline carrier counter, for example.

The A-BSM is a BSM, which is a B-Type message. The “A” is used to distinguish between a global BSM created by system 100. A B-Type message may include a plurality of data fields that include coded characters. For example, the coded characters may include one of American Standard Code for Information Interchange (ASCII) code, Baudot, and Padded Baudot, for example. The Baggage Information Messages or the B-Type messages code and format is described for example in the “Recommended Practice 1745 Baggage Information Messages” by IATA, in the Passenger Services Resolution Manual, June 2010, 30^{th} Edition, pgs. 1110-1205.

The B-Type message may include field or line 802 that includes a header. For example, the header may be labeled “BSM,” which represents the heading of the beginning of an A-BSM. The field or line 804 may include a line preface “.V/” followed by a set of alphanumeric characters. By way of non-limiting example, the line preface “.V/” may denote version and supplemental data. For example, supplement data may include a transfer station in an airline environment. The .V/data field may indicate whether the B-Type message, such as a BSM, is a terminating BSM. The .V/data field includes after the “/” a digit that indicates a data dictionary version number. The next character may be a baggage source indicator denoted by a “L” to denote Local, a “T” to denote Transfer, an “X” to denote Terminating, or a “R” to denote Remote. The baggage source indicator is followed by a three-digit airport code. In this example, the BSM is a transfer BSM with version number 1 and an airport code of JFK.

The field or line 806 may include a line preface “.F/” followed by a set of alphanumeric characters that represent the outbound flight number and date. The alphanumeric characters may be separated by a symbol “/”. For example, the data “22MAY” may represent the date of arrival. The code “IST” represents Istanbul Airport.

The field or line 808 may include a line preface “.I/” followed by a set of alphanumeric characters that represent the Inbound flight number and date. The alphanumeric characters may be separated by a symbol “/”. For example, the data “12MAY” may represent the date of departure. The code “SLC” represents Salt Lake City Airport.

The field or line 812 may include a line preface “.N/” followed by a set of numbers, some of which represent the A-BTI that is printed on an IATA bag tag. The field or line 810 may include a line preface “.P/” followed by a set of characters, which represent the passenger's name. The first name may be separated by the last name by a symbol “/”.

The field or line 818 may include a line preface “.L/” followed by a set of alphanumeric characters, which represent the passengers name record (PNR) number. The PNR number also refers to a locator. The field or line 820 may include an end of message indicator, such as “ENDBSM.”

Between lines 802 and 820, there may be other fields or lines, such as fields 814 and 816. The field or line 814 has a preface “.S/” and is reconciliation data. The field or line 816 has a preface of “.W/” related to the weight, pieces, dimension, and type data of the luggage item. Since, airline B-Type messages are known in the art. No further description of B-Type messages will be described. Some of the fields/lines are mandatory and others are optional depending on the B-Type message.

The example A-BSM 800 is provided for descriptive purposes and is not meant to be limiting in any way. Each airline may have changes to the airline BSM. The B-Type messages have mandatory fields but some fields can be varied at the discretion of the air carrier.

FIG. 9A illustrates global tracking expanded baggage source message (GTE-BSM) 900 (i.e., GTE-BSM 141) in accordance with an embodiment. FIG. 9B illustrates a global tracking expanded baggage source message (GTE-BSM) linking structure 950 in accordance with an embodiment. The GTE-BSM linking structure 950 will be described together with FIG. 9A. The GTE-BSM linking module 173 may be configured to link together the information as described in the GTE-BSM linking structure 950 by addressing, indexing, and storing information, which information may be accessible by scanning the global bag tag of a registered passenger during a travel journey and/or and IATA bag tag if at least one leg of travel used an air travel carrier.

GTE-BSM 900 may be permanent as it follows the same registered passenger for a predetermined useful life in a range of one month up to 10 years, one month up to 20 years, or upon death or until death, for example, with the same name, and P-BTI. The information of GTE-BSM 900 may be updated with new reservation information associated with a new PNR number, for each new trip. By way of a non-limiting example, new reservation information may include inbound and outbound information for a flight, lodging entity information, or other multi-mode travel information, including information related to a cruise ship voyage, a bus reservation or a train reservation. The fields of GTE-BSM 900 are not limited to airline information. Instead, the GTE-BSM of the GTE-BSM linking structure 950 may include multi-vehicle travel information. The GTE-BSM may be used for the first leg of travel with priority to a leg of travel that is carried out by an air carrier, for example. The GTE-BSM template (hereinafter referred to as “BSM template”) may vary depending on the vehicle of travel (VOT). Not all fields are needed if an airline carrier is not used in any of the legs of travel during a current travel journey end to end, for example. The GTE-BSM may not need certain fields normally in an A-BSM, only those fields with pertinent information for tracking and handling of luggage items may be needed and retained. A BSM template for other vehicles of travel, information pertaining to the location, time of check-in, time of departure, gate, station, etc. may be needed.

The B-Type message may include field or line 902 that includes a header. For example, the header may be labeled “GTEBSM,” which represents the heading of the beginning of GTE-BSM 900. The field or line 904 may include a line preface “.V/” followed by a set of alphanumeric characters. By way of non-limiting example, the line preface “.V/” may denote version and supplemental data. For example, the supplement data may include a transfer station in an airline environment. For example, the supplement data may include a transfer station in an airline environment. The .V/data field may indicate whether the B-Type message, such as a BSM, is a terminating BSM. The .V/data field includes after the “/” a digit that indicates a data dictionary version number. The next character may be a baggage source indicator denoted by a “L” to denote Local, a “T” to denote Transfer, an “X” to denote Terminating, or a “R” to denote Remote. The baggage source indicator may be followed by a three-digit airport code. The GTE-BSM may use the baggage source indicator in a similar manner as in an IATA B-Type message. However, in one or more embodiments, if the traveler is not traveling by airplane but another vehicle of travel, the three-digit airport code may be substituted for another coding scheme to reflect the vehicle of travel or vehicle of transportation. The VOT code may be created using both digits and alphabets. In one or more embodiments, the VOT code may include more than 2 or 3 digits.

The field or line 906 may include a line preface “.F/” followed by a set of alphanumeric characters that represent the outbound flight number and date. The alphanumeric characters may be separated by a symbol “/”. In lieu of a flight number, a train number, voyage number or bus number may be used.

The field or line 908 may include a line preface “.I/” followed by a set of alphanumeric characters that represent the inbound flight number and date. The alphanumeric characters may be separated by a symbol “/”. In lieu of a flight number, a train number, voyage number or bus number may be used.

The field or line 912 may include a line preface “.N/” followed by a set of numbers, some of which represent the digital BTI data record of the A-BTI for the luggage item of the registered passenger. The field or line 910 may include a line preface “.P/” followed by a set of characters, which represent the passenger's name. The first name may be separated from the last name by a symbol “/”.

The field or line 918 may include a line preface “.L/” followed by a set of alphanumeric characters, which represent the passengers name record (PNR) number. The PNR number also refers to a locator. The field or line 920 may include an end of message indicator, such as “ENDGTEBSM.”

Between lines 902 and 920, there may be other fields or lines, such as fields 914 and 916. The field or line 914 has a preface “.S/” and is reconciliation data. The field or line 916 has a preface of “.W/” related to the weight, pieces, dimension, and type data of the luggage item. Since, airline B-Type messages are known in the art. No further description of B-Type messages will be described.

GTE-BSM 900 may include field or line 922 that has a preface “.Z/” for example, for the GMMT bag tag number. The GMMT bag tag number may be “000123456/111.” The code “000” may be an assigned IATA code for a non-flying airline. However, other codes may be used. The sequence “123456” is the passenger's bag number, for example. The code “111” may represent the PMM code. The “/” may separate the two numbers or may be omitted.

GTE-BSM 900 may include the GMMT bag tag number in the “.Z/” field or another available field. GTE-BSM 900 of GTE-BSM linking structure 950 may include fields in a BSM outside of the airline infrastructure for adding current location data 984 to a field from a tracking device 40 affixed to the luggage item. The tracking device 40 may receive primary ID (PID) data from a baggage handling device as described in relation to FIG. 16A. The tracking device ID may be stored in the GTE-BSM 900 of GTE-BSM linking structure 950 with the location data.

GTE-BSM 900 may include fields in a BSM outside of the airline infrastructure for adding a link or a locator number to banking information, for example. GTE-BSM 900 may include fields in a BSM outside of the airline infrastructure for adding a link or locator number to personal information such as information from a driver's license 982, as shown in FIG. 9B.

The term “link” as used herein may include a hypertext transfer protocol (HTTP) or hypertext transfer protocol secure (HTTPS), for example. GTE-BSM 900 may be communicated using various protocols such as, without limitation, transmission control protocol/internet protocol (TCP/IP), file transfer protocol (FTS), hypertext transfer protocol (HTTP), hypertext transfer protocol secure (HTTPS), secure socket layer (SSL), secure file transfer protocol (SFTP), and user datagram protocol (UDP). Data may be indexed or addressed using a hypertext link.

In one or more embodiments, if any of the vehicles of travel is an air carrier, GTE-BSM 900 is updated and merged with A-BSM data once the luggage item is checked in with the airline carrier. The airline carrier may take priority over other vehicles of travel. The reason for this is that the originating hardcopy bag tag, denoted as 960 in FIG. 9B of the GTE-BSM linking structure 950, with a printed A-BTI 961 or RFID bag tag displaying an IATA bag tag number (i.e., A-BTI), may be used to obtain return flight information, if needed. The originating hardcopy (airline) bag tag with a printed A-BTI or RFID bag tag may be used as a secondary linking mechanism for non-registered passengers in a group linked to the registered passenger. The originating hardcopy bag tag, denoted as 960 in FIG. 9B, may also display a PNR number. This PNR number may be used to access PNR data from a database connected to a computer system associated with an airline carrier. The PNR data in PNR database 63C (FIGS. 1B and 6A) may include reservation data.

The GTE-BSM linking module 173 may include programming instructions which when executed may cause the GTE-BSM 900, in one or more embodiments, to have one or more temporary baggage source messages (T-BSMs) 146 linked thereto, as shown in dashed box 990 in the GTE-BSM linking structure 950. The T-BSM 146 may include similar fields as the GTE-BSM, except the field or line 902 includes a header “TBSM.” Additionally, the field or line 918 may include a line preface “.L/” followed by a set of alphanumeric characters, which represent the passengers name record (PNR) number. The PNR number may be the same or different than the PNR number of the registered passenger.

The field or line 910 may include a line preface “.P/” followed by a set of characters, which represent the non-registered passenger's name. The field or line 912 may include a line preface “.N” followed by a set of numbers, some of which represent the digital BTI data record of the A-BTI for the luggage item of the non-registered passenger. The A-BTI in the T-BSM 146 may be printed on the originating hardcopy bag tag 965 affixed to a luggage item of the non-registered passenger. In one or more embodiments, the T-BSM 146 may be populated with airline carrier information when at least one vehicle of transportation is an airline carrier.

Since, the T-BSM 146 may be linked to the GTE-BSM 900, anytime the originating hardcopy bag tag 965 is scanned, the scanning device or acquiring device provides the baggage handler information about the group but may be limited to the appropriate non-registered passenger. For example, for a cruise ship, the baggage handler may be provided with the room number for the specific non-registered passenger, when scanning the originating hardcopy bag tag 965. This may save valuable resources by recycling the airline's printed originating hardcopy bag tag 965 for other vehicles of travel.

If the flights are the same, then the other information would be the same. However, if flights differ, then the information in the T-BSM 146 may differ.

The T-BSM may include the GMMT bag tag number in the “.Z/” field or another available field. This links the T-BSM to the GTE-BSM 900 of the registered passenger. The fields may use other prefixes as allowed for by IATA regulations. The fields may use a two- or three-digit character prefix such as “.XXX/” where X represents a character.

System 100 may include a vehicle of travel (VOT)-BSM generator 149 (FIG. 1A) that may include programming instructions which when executed may create a VOT-BSM. The VOT-BSM may be assigned to the registered passenger and linked to GTE-BSM 900. Each VOT-BSM may be created for each additional leg of travel and used to build the travel journey record, including arrival and departure times and dates, as well as location. The VOT-BSM may include its own PNR number or may be linked to a single PNR number or a Super PNR number.

The VOT-BSM 151 for the registered passenger may include the GMMT bag tag number in the “.Z/” field or another available field. This may link the VOT-BSM 151 to the GTE-BSM 900 of the registered passenger of the GTE-BSM linking structure 950. In one or more embodiments, the PNR number may be a PMM code or a travel membership number that links to a leg of travel reservation for a current travel journey. The field or line 910 may include a line preface “.P/” followed by a set of characters, which represent the registered passenger's name. If the VOT does not have a luggage item bag tag number, the field or line 912 may include a line preface “.N/” followed by a set of numbers, some of which represent the digital BTI data record of the A-BTI for the luggage item of the registered passenger or may duplicate the GMMT bag tag number. In one or more embodiments, the three-digit airport code may be substituted for another coding scheme to reflect the vehicle of travel or vehicle of transportation.

Box 995 denoted in a dashed line includes at least one VOT-BSM 151 that is linked to GTE-BSM 900 of GTE-BSM linking structure 950. Because each of T-BSMs 146 for each non-registered passenger may also be traveling with the registered passenger on one or more VOTs, one or more VOT-BSMs, denoted by dashed box 995′ in the GTE-BSM linking structure 950, may be created via VOT generator 149 for each non-registered passenger and linked to their corresponding T-BSM 146. The PNR number may be the same as the registered passenger or different. However, the VOT location, date window and time window should be the same such that the reservations generally overlap.

In one or more embodiments, the registered passenger may have a longer reservation stay than at least one non-registered passenger.

The data from the T-BSM and the VOT-BSM are stored in a member's travel history and may be linked as part of the GTE-BSM linking structure 950. The non-registered passenger may have their travel history stored as well for use in data analytics for future trips, resource allocation, and advertisements.

Because a registered passenger may check-in more than one luggage item, when checking in the luggage item of a registered passenger, an extra luggage BSM, referred to as “gte-BSM” 955, may be created. Here for distinction, a lowercase “gte” is used. Gte-BSM 955 may include similar fields to the GTE-BSM 900. In this case, the field or line 912 may include a line preface “.N/” followed by a set of numbers, some of which represent the digital BTI data record of the A-BTI for the additional luggage item of the registered passenger. The originating hardcopy (IATA) bag tag 962 may have the A-BTI for the additional luggage item and may be affixed to the luggage item as required by the air carrier, for example. In some instances, the air carrier bag tags may be RFID bag tags. The RFID display in e-ink may display the A-BTI, which can be scanned by a scanner or may be received by an RFID reader. The “.Z/” field may include the GMMT bag tag number. In one or more embodiments, the RFID reader acquires an RF signal to acquire an electronic representation of the A-BTI.

The non-registered passenger may also check-in more than one luggage item. In this instance, one or more T-BSMs 146 may be created for each non-registered passenger.

The description herein describes the IATA B-type message code formatting for the GTE-BSM. However, based on the description herein, other coding formats and schema may be used to create unique identifiers, structured message formats, and electronic link mediums to link luggage items together across multiple vehicles of travel and communicated using Transport Control Protocol (TCP)/Internet Protocol (IP) communication technology and other communication protocols available now and in the future.

Each of the T-BSM, gte-BSM, and/or VOT-BSM may be populated with the corresponding passenger's name, link to the GMMT bag tag number, and a PNR number or Super PNR number. Each of the T-BSM, gte-BSM, and VOT-BSM may be updated with travel leg information or reservation data, and location data, as the corresponding luggage item embarks on a travel journey parallel and/or independent to its owner.

FIGS. 10A-10C illustrate a flowchart of method 1000 for generating a global tracking expanded baggage source message (GTE-BSM) for a registered passenger and/or a T-BSM for a current travel journey for one or more non-registered passengers in accordance with an embodiment. A current travel journey may have one or more vehicles of travel (VOT). Method 1000 is described in relation to GTE-BSM 900 of FIG. 9A and the GTE-BSM linking structure 950 of FIG. 9B.

Method 1000 may include, at block 1002, obtaining, by a processor, a GTE-BSM template and populating the GTE-BSM 900 (FIG. 9A) with information related to the P-BTI, at block 1004. The GTE-BSM may include the P-BTI and the registered passenger's name. Block 1001 includes blocks 1002 and 1004, which may be performed when the global bag tag is created. Other fields of the GTE-BSM 900 (FIG. 9A) may be updated for each and every travel journey of the registered passenger. For the sake of brevity, the templates for the BTM may include structures for storing or arranging information necessary for tracking and handling luggage items along an end-to-end travel journey using multiple modes of travel or transportation.

Method 1000 may include, at block 1006, obtaining, by a processor, a PNR number for a current travel journey.

Method 1000 may include, at block 1008, accessing, by a processor, a computer system of a reservation system associated with the PNR number to obtain a passenger list and travel journey information.

Method 1000 may include, at block 1010, determining, by a processor, whether there is a match for the registered passenger with a passenger in the passenger list associated with the PNR number. If the determination, at block 1010, is “NO,” the method 1000 ends at block 1012. This means the registered passenger is not associated with the PNR number, or the PNR may be a wrong number. System 100 may store programming instructions to access pre-stored instructions for accessing PNR data from a computer system associated with source (travel carrier or PMM travel information) of the PNR number.

If the determination, at block 1010, is “YES,” method 1000 may include populating, by a processor, the GTE-BSM template with the PNR number, at block 1014. Method 1000 may include, at block 1016, obtaining, by a processor, one or more VOTs from the PNR number for the baggage travel journey record.

Method 1000 may include, at block 1018, populating, by a processor, the GTE-BSM with inbound (arrival) and/or outbound (departure) information for the luggage item for the first VOT from the PNR number, if available. A travel journey may include multiple VOTs. The GTE-BSM may be populated with the first VOT that will occur in a time sequence of vehicles of travel. In one or more embodiments, the GTE-BSM may include information merged from non-airline reservation information but subsequently updated with merged data from an A-BSM of a registered passenger, as will be discussed later.

The GTE-BSM may be expanded to include other fields or notes. Furthermore, the GTE-BSM may be updated during a current travel journey. For example, during luggage items and/or passenger's travel on an airline carrier, the field of the GTE-BSM may be merged with the A-BSM. Added fields may be used to add other vehicles of travel (VOTs) or links to VOT-BSMs. In one or more embodiments, GTE-BSM 900 may have the original hardcopy bag tag number from the IATA license plate in the “.N/” field 912 if one of the VOTs is an air carrier. The “.Z/” field or other designated field may have the GMMT bag tag number.

Method 1000 may include, at block 1019, determining whether there is an airline reservation. If the determination, at block 1019, is “NO,” method 1000 may proceed to block 1046 of FIG. 10C. If the determination, at block 1019, is “YES,” method 1000 may proceed to block 1020 of FIG. 10B.

Referring now to FIG. 10B, method 1000 may include, at block 1020, determining, by a processor, whether the passenger checked in with an airline. For example, in one or more embodiments, when a registered passenger is traveling via an air carrier, they should check-in with the airline carrier within a check-in window. For the baggage handling service to check-in the luggage item in the check-in window, the airline carrier may require the passenger to be checked in prior to checking in the luggage item(s). If the determination, at block 1020, is “NO,” method 1000 may check in the passenger, at block 1022. Method 1000 may include, at block 1025, sending to the passenger a communication that includes their boarding pass and/or a message indicating they have been checked in to their flight. Block 1025 may proceed to block 1026.

The check-in process at blocks 1022 or 1026 is also described in relation to FIG. 6A. For example, when the passenger and/or their luggage item is/are checked in, such as for an originating flight on an air carrier, the identity of the passenger may need to be verified, as described in FIG. 6A and/or the purchase of a ticket confirmed. Regardless of whether the passenger and/or their luggage is/are checked in from home, lodging entity, resort, or cruise ship or a flight (originating or return), the identity of the passenger may need to be verified.

When the passenger designates a luggage item to be checked in, it may cause a computer system associated with the airline carrier to create an A-BSM that includes an IATA bag tag number. This process may send, by the computer system associated with the airline carrier, a boarding pass to the passenger. Consequently, if the determination, at block 1020, is “YES,” method 1000 may include, at block 1024, accessing an A-BSM associated with a computer system of an airline carrier with a passenger name of the checked in passenger and one of a PNR number or airline reservation information, for example. The A-BSM may include inbound and outbound flight information that can be extracted and added to the GTE-BSM for the current travel journey.

Method 1000 may include, at block 1026, checking in the luggage item for the registered passenger using information from the A-BSM.

Method 1000 may include, at block 1028, obtaining the A-BTI from an A-BSM associated with a computer system of an airline carrier and merging the data from the A-BSM into GTE-BSM 900, for example, when the passenger is a registered passenger.

Method 1000 may include, at block 1030, accessing, by a processor, return flight information with a designated airline carrier based on one of a PNR number or airline reservation information and adding the return flight information to a luggage item manifest record. Method 1000 may include, at block 1032, causing, by a processor, a printer to print an originating IATA bag tag for the checked in luggage item.

Method 1000 may include counting, by a processor, the checked in luggage items, at block 1034.

The registered passenger may want to check in more than one luggage item. This would require each luggage item to be checked in. Therefore, method 1000 may include, at block 1036, determining whether there is another luggage item. If the determination, at block 1036, is “YES,” method 1000 may include repeating blocks 1024, 1026, 1028, 1030, and 1032 for each extra luggage item (XL) to be checked by the registered passenger. In the scenario of an extra luggage item, at block 1028, method 1000 may include obtaining the A-BTI from an A-BSM associated with a computer system of an airline carrier and merging the data from the A-BSM into a gte-BSM, for example, when the passenger is a registered passenger. Here the new A-BTI is inserted into the “.N/” field 912 but in a gte-BSM. The gte-BSM is linked to the GTE-BSM of the registered passenger. Linking to the GTE-BSM is described in relation to block 507.

If the determination, at block 1036, is “NO,” method 1000 may include determining, at block 1038, whether there is another non-registered (NR) passenger in group.

The registered passenger may be a lead passenger of the PNR number, but it is not required. For example, a parent may travel with children. Data associated with the PNR number may list the children and parents. The registered passenger may be a parent. Method 1000 allows other luggage items to be tracked and handled using the P-BTI of the registered passenger. System 100 may link non-registered passengers with a PNR number that is different from the PNR number of the registered passenger, such as for pickup and delivery of luggage items to a cruise ship voyage, resort or lodging destination by the group that include the non-registered passengers and the registered passenger.

Method 1000 may also check-in non-registered passengers and their luggage items or just their luggage items. This is accomplished by blocks 1020, 1022, 1024, 1026, 1028, 1030, and 1032 but for the non-registered passenger. In this instance, when the A-BTI information is obtained, instead of merging the data into the GTE-BSM, the data is merged into a T-BSM. The T-BSM is linked to the GTE-BSM of the registered passenger.

If the determination, at block 1038, is “YES,” the method 1000 may include creating a T-BSM and linking to the GTE-BSM of the registered passenger, at block 1040. Block 1040 may loop back to block 1020 and at block 1042, where method 1000 may include tracking non-registered passenger name, luggage item, and PNR number.

If we determination, at block 1038, is “NO,” the method 1000 may include proceeding to block 1046 of FIG. 10C.

With reference to FIG. 10C, many travel journeys include two vehicles of travel. The first vehicle of travel may be a mode of transportation, such as an airplane, train, bus, ferry, cruise ship or rental car. The second vehicle of travel may be a lodging entity. In some instances, the mode of transportation may also provide a vehicle of travel such as a lodging entity. In other instances, the travel journey may include a single vehicle of travel.

Method 1000 may include, at block 1046, determining whether there is another VOT for the current travel journey. If the determination, at block 1046, is “NO,” method 1000 may end at block 1048. If the determination, at block 1046, is “YES,” method 1000 may proceed to block 1050 where a VOT-BSM may be created and linked to the GTE-BSM for the registered passenger or a T-BSM for the non-registered passenger. Example operations for block 1050 are set forth below.

At block 1050, method 1000 may include, at block 1052, obtaining a VOT-BSM template for VOT; at block 1054, populating the VOT-BSM with information related to the VOT reservation; and at block 1056, linking the VOT-BSM with GTE-BSM if the passenger is the registered passenger or the T-BSM if the passenger is a non-registered passenger.

Method 1000 may include, at block 1058, determining whether there is another non-registered passenger. If the determination, at block 1058, is “YES,” method 1000 may loop back to the beginning of block 1050 and repeat blocks 1052, 1054 and 1056. If the determination, at block 1058, is “NO,” method 1000 may include determining whether there is another VOT, at block 1060. If the determination, at block 1060, is “NO,” method 1000 may end at block 1062. If the determination, at block 1060, is “YES,” method 1000 may repeat block 1050 for the next VOT, where block 1050 includes block 1052, 1054 and 1056, previously described.

Method 1000 may include, at block 1064, determining whether there is another non-registered passenger. If the determination, at block 1064, is “YES,” method 1000 may loop back to the beginning of block 1050 and repeat blocks 1052, 1054 and 1056. If the determination, at block 1064, is “NO,” method 1000 may include loop back to block 1060.

Once all the vehicles of travel have been entered into a BSM template and linked to the GTE-BSM for the registered passenger and any non-registered passengers of their party, method 1000 may end at block 1062.

FIGS. 11A-11C illustrate baggage travel journey records (BTJRs) in accordance with an embodiment. The BTJRs may create one or more records for a luggage item manifest.

FIG. 11A illustrates a BTJR 1154A created for a registered passenger for a round trip travel journey using multiple modes of travel in accordance with an embodiment. The passenger may receive communications via the message communicator 178 to a mobile communications device designated by the passenger or other computing device. A message may be sent by text, email, or computer-generated communication. The messages may indicate the status updates described herein.

The system uses scanners or other acquiring devices to acquire the P-BTI (FIG. 2B) from the global bag tag 230. The scanner may be part of a system described in U.S. Pat. No. 11,682,241, titled “RETURN LEG REMOTE PASSENGER CHECK-IN”, issued Jun. 20, 2023, incorporated herein by reference. The scanner may be dockside, at a vehicle of travel, or carried by luggage delivery and handling personnel and configured to scan barcodes, such as at least the P-BTI and communicate the P-BTI to system 100. The system may update the BTJR 1154A, 1154B and 1154C with acknowledgement of the presence of the luggage item of a passenger that is ready to embark on any vehicle of travel in their currently listed PNR, for example. The system uses scanners or other acquiring devices to acquire a representation of the originating hardcopy bag tag identifier (OH-BTI) associated with or printed on a printed bag tag from an originating airline carrier or an IATA bag tag license plate for use by computing devices.

With each scan, the scanner or acquiring device communicates to the system the location of the scanner and acquiring device and the P-BTI. The message to the system may include time and date data, as well. For those scanners or acquiring devices with GPS or location determination capability, the GPS data or other location data may be sent to the system to identify the location of the luggage item. The GPS data from the scanner or acquiring device is compared to expected map location data to correlate the expected location (EL) in the BTJR with point of scan (POS). When there is correlation between the EL and the POS, the indicator boxes described below may be caused to change color, symbol, or status.

In one or more embodiments, the passenger's mobile communication device or personal computing device may include a graphical user interface (GUI) which is configured to access the BTJR, such as BTJR 1154A, 1154B, or 1154C, to be apprised of the current location and/or status of their luggage item.

In one or more embodiments, the luggage item may have a tracking device 40 attached thereto. Such tracking devices may include a display device to display details of the BTJR. The passenger may have access to location data associated with the tracking device 40.

The BTJR 1154A may include one or more luggage handling fields 1102, 1104, 1106, 1108, 1110, 1112, 1114, 1116, 1118, 1120, 1122, 1124, 1126, 1128, and 1130. Each field includes an indicator box 1101 on a first side of the field. Each indicator box may be caused to indicate the status of the luggage item when the P-BTI on the global bag tag 230 is scanned. For example, scanning the P-BTI on the global bag tag on arrival or for departure may cause the indicator box 1101 to display an icon or color representative of the status. A first color or icon may indicate an expected luggage item that has not been scanned in for arrival or departure. A second color or icon may indicate an expected luggage item has been scanned on arrival or departure. A third color or icon may indicate an “in route” status between expected locations. Other colors and icons may be used to indicate other status conditions.

A luggage handling field provides instructions on a display device on how the luggage item should be handled, such as pick up or delivery. In some instances, the luggage item may need to be sent through Customs, for example.

Each luggage handling field may include varying icons 1132 on a second side opposite the first side of the field. The icons 1132 may distinguish the different locations and modes of travel or vehicle of travel the luggage item is to travel through on its journey, whether parallel or independently, relative to its owner. By way of a non-limiting example, the icons 1132 are for illustrative purposes only and are not meant to be limiting in any way. The BTJR may be displayed on a display device associated with a computing device, scanner, acquiring device, or web server of system 100.

To prevent overcrowding, some of the fields may be omitted. For example, possible additional fields associated for pickup and delivery of luggage items dockside of a cruise ship at fields 1118 and 1120 denoted in bracket 1140 are described in relation to FIG. 11B. For example, fields 1118 and 1120 may include luggage handling fields 1152, 1153, 1156, 1158 and 1160 as described below in FIG. 11B.

In an example, the registered passenger may have requested pickup of the luggage item from a designated address, such as without limitation, a home address, as denoted in field 1102. Once the luggage delivery and handling personnel processes the luggage item and/or passenger, the P-BTI may be scanned on the global bag tag 230. This may cause the indicator box 1101 to change color or display an icon representative of the status update.

By way of non-limiting example, the system 100 may check-in the luggage item for a flight on ABC airline. Personnel processing the check-in of the luggage item may scan the P-BTI on the global bag tag 230. This may cause the indicator box 1101 to change color or display an icon representative of the status.

In one or more embodiments, the system may update the status in field 1104 automatically when the luggage item is checked in by electronically receiving a communication with an IATA bag tag license plate, for example. The system may update the status in field 1104 automatically when the luggage item is checked in by printing an IATA bag tag for the flight.

As the status is updated in the BTJR 1154A, messages may be sent to the passenger. In one or more embodiments, the passenger may be checked in by the system, as well.

Once the luggage delivery and handling personnel processes the luggage item and/or passenger for check-in with the airline, the P-BTI may be scanned on the global bag tag 230. This may cause the indicator box to change color or display an icon representative of the status in field 1104. The luggage item and passenger may be checked in up to 24 hours prior to departure on a flight, for example.

Once the luggage delivery and handling personnel deliver the luggage item to the originating airport/airline for the flight, the P-BTI may be scanned on the global bag tag 230. This may cause the indicator box to change color or display an icon representative of the status in field 1106. The BTJR 1154A may receive updates on the flight. The indicator box in field 1108 may display a color or icon representative of changes in itinerary for the flight's arrival. Likewise, the indicator box in field 1106 may display a color or icon representative of changes in itinerary for the flight's departure or cancellation.

Once the luggage delivery and handling personnel picks up the luggage item from the destination airport/airline of the flight, the P-BTI may be scanned on the global bag tag 230. This may cause the indicator box to change color or display an icon representative of the status in field 1110 to denote the pickup of the luggage item from the location. The status may also represent further transportation or “in route” such as to a hotel, for example.

Once the luggage delivery and handling personnel deliver the luggage item to a next vehicle of travel, such as a hotel, the P-BTI may be scanned on the global bag tag 230. This may cause the indicator box to change color or display an icon representative of the status in field 1112. The reservation status may also be communicated to the passenger and any changes including the time for checkout, in field 1114. By way of non-limiting example, fields 1112 and 1114 may be used as a luggage item manifest record for a lodging entity.

Once the luggage delivery and handling personnel picks up the luggage item from the hotel, the P-BTI may be scanned on the global bag tag 230. This may cause the indicator box to change color or display an icon representative of the status in field 1116 to denote the pickup of the luggage item for a location. The status may also represent further transportation or “in route” such as to a hotel, for example.

The operation of fields 1118 and 1120 will become evident from the description below in FIG. 11B. By way of non-limiting example, fields 1118 and 1120 may be used as a luggage item manifest record for a lodging entity or VOT.

Once the luggage delivery and handling personnel picks up the luggage item from the cruise ship, the P-BTI may be scanned on the global bag tag 230. This may cause the indicator box to change color or display an icon representative of the status in field 1122 to denote the pickup of the luggage item from a location. In this example, the passenger may return home via a return flight with a designated travel carrier.

In one or more embodiments, the system may update the status in field 1124 automatically when the luggage item is checked in by receiving an IATA bag tag license plate, for example. The system may update the status in field 1124 automatically when the luggage item is checked in by printing an IATA bag tag, for example, for the flight.

As the status is updated in the BTJR 1154A, messages may be sent to the passenger. In some examples, the passenger may be checked in by the system as well. The message may include the IATA license plate and/or an IATA barcode with the IATA license plate representative of a receipt indicating the luggage item has been checked in with the airline flight.

Once the luggage delivery and handling personnel processes the luggage item and/or passenger for check-in with the airline, the P-BTI may be scanned on the global bag tag 230. This may cause the indicator box to change color or display an icon representative of the status in field 1124. The luggage item and passenger may be checked in up to 24 hours prior to departure on a flight.

The operation of fields 1126 and 1128 are similar to fields 1106 and 1108 previously described. Therefore, no further description will be provided.

Once the luggage delivery and handling personnel arrive at the location to pick up the luggage item from the airport, the P-BTI may be scanned on the global bag tag. This may cause field 1130 to indicate a status of the pickup of the luggage item from the airport for delivery to a designated address, such as a home address. This may cause field 1130 to indicate a status of the pickup of the luggage item from the airport.

Other fields may be provided for each location the luggage item is delivered to or picked up from. In this instance, when the luggage item is delivered to the home address or other designated address, the P-BTI may be scanned on the global bag tag. This may cause another field, such as field 1164 (FIG. 11B) to indicate a status of the delivery of the luggage item to the home address.

FIG. 11B illustrates a BTJR 1154B created for a registered passenger that has their luggage items delivered to a cruise voyage in accordance with an embodiment. The registered passenger will already have the P-BTI for use with any mode of travel. The description herein also applies to like luggage handling fields 1118 and 1120, in bracket 1140 of FIG. 11A.

In this instance, the BTJR 1154B may include a field 1156 for the embarkation of the cruise from the port for LMN Cruise Line. The field 1156 may reference the cabin number “1234.” Although the description in FIG. 11B is a travel journey on a cruise ship, the BTJR 1154B may also be created when a luggage item of a registered passenger is to be delivered to a resort, lodging entity, or other vehicle of travel, for example.

The message communicator 178 may identify when the cabin is ready for occupancy. Although the system 100 may not have delivered the luggage item to the cabin, the system 100 may still provide updated messages about the reservation status to the registered passenger, including delays in availability of the cabin.

The BTJR 1154B may include one or more luggage handling fields 1150, 1152, 1153, 1156, 1158, 1160, 1162, and 1164. Each field includes an indicator box 1151 on a first side of the field. Each indicator box may be caused to indicate the status of the luggage item when the P-BTI on the global bag tag 230 is scanned. For example, scanning the P-BTI on the global bag tag on arrival or for departure may cause the indicator box 1151 to display an icon or color representative of the status. A first color or icon may indicate an expected luggage item that has not been scanned in for arrival or departure. A second color or icon may indicate an expected luggage item that has been scanned in on arrival or departure. The field 1152 denotes the code “MNO”. This code is intended to be representative of a location code. However, an address may be used in its place. Other code formats may be used and should not be limited to three letters.

Each luggage handling field may include varying icons 1166 on a second side opposite the first side of the field. The icons 1166 may distinguish the different locations and modes of travel or vehicle of travel the luggage item is to travel through on its journey parallel or independently relative to its owner.

In some examples, the registered passenger has requested pickup of the luggage item from a designated address, such as without limitation, a home address, as denoted in field 1150. Once the luggage delivery and handling personnel processes the luggage item and/or passenger, the P-BTI may be scanned on the global bag tag. This may cause the indicator box 1151 to change color or display an icon representative of the status. When the luggage item arrives at the location of the cruise line (i.e., dockside), the P-BTI may be scanned on the global bag tag. This may cause the indicator box 1151 to change color or display an icon representative of the status.

When the luggage item arrives dockside, the global bag tag 230 may be scanned by a scanner or other acquiring device to acquire the P-BTI (FIG. 2B). The scanner may be dockside and configured to scan barcodes, such as at least the P-BTI and communicate the P-BTI to system 100. The system may update the BTJR 1154B with acknowledgement of the presence of the luggage item of a registered passenger that is ready to embark on a cruise listed in their currently listed PNR.

In an example, the luggage item may be handled by the delivery and handling personnel or other personnel to deliver the luggage item to the cabin, once the luggage item is delivered to the cabin, the scanner or acquiring device, scans the P-BTI and logs the location with system 100. This may cause field 1156 to indicate the status of the delivery of the luggage item to the cabin.

In an example, the luggage item may be handled by the delivery and handling personnel or other personnel to pick up the luggage item from the cabin, and once the luggage item is picked up from the cabin, the scanner or acquiring device scans the P-BTI and logs the location with system 100. Messages may be communicated to the registered passenger via a designated communication device of the location of the luggage item. This may cause field 1158 to indicate the status of the pickup of the luggage item from the cabin.

The security screening fields 1153 and 1160 will be described later. The security screening fields apply for those travel journeys where a border may be crossed, for example. In other embodiments, the screening by TSA may be added. For example, in a scenario of FIG. 11B, if the flight crossed borders, the security checks would be by Customs at the airport, for example.

Any scanner or barcode acquiring device on the cruise ship or dockside may be configured to communicate with the system 100 to log the location of the luggage item by acquiring the P-BTI from the global bag tag 230, such as by providing the location data of the scanner or acquiring device.

Additional luggage handling fields may be added in the BTJR 1154B anytime the P-BTI is scanned by a scanning device or acquiring device, where a communication is sent to system 100 with the P-BTI and the location data of the luggage item is communicated.

When the registered passenger disembarks the cruise ship, a scanner or barcode acquiring device may acquire a representation of the P-BTI from a substrate of the global bag tag 230 for use by computing devices. The location data may also be sent to system 100 to update the BTJR 1154B to show that the luggage item has departed from the location.

BTJR 1154B may include security screening fields 1153 and 1160. By way of a non-limiting example, a luggage item and/or passenger may be required to pass through Customs, a second mode of travel security screening location, or other government security screening point. The security check may be a designated location within or associated with the vehicle of transportation or vehicle of travel. The Customs station is a designated location in an airport, for example.

Any scanner or barcode acquiring device on the cruise ship or at the security screening point may be configured to communicate with the system 100 to log the location of the luggage item by acquiring a representation of the P-BTI from a substrate of the global bag tag 230, such as by providing the location data of the scanner or acquiring device. Furthermore, information associated with passing or failing the security screening may be sent to the system 100 and logged.

In some examples, the registered passenger may have requested pickup of the luggage item from a designated address, such as, without limitation, the address of the cruise ship, as denoted in field 1162. Once the luggage delivery and handling personnel arrive at the location to pick up the luggage item, the P-BTI may be scanned on the global bag tag. This may cause field 1162 to indicate a status of the pickup of the luggage item from the cruise ship. When the luggage item is delivered to the home address or other designated address, the P-BTI may be scanned on the global bag tag. This may cause field 1164 to indicate a status of the pickup of the luggage item from the cruise ship. By way of non-limiting example, fields 1162 and 1164 may be used as a luggage item manifest record for a delivery to a designated address, such as a home address, office address, or other address.

FIG. 11C illustrates a BTJR 1154C created for a luggage item of a registered passenger that arrives dockside for a cruise voyage in accordance with an embodiment. In this instance, the luggage item arrives dockside with a passenger and includes a global bag tag 230. In other words, delivery and handling personnel did not deliver the luggage item to the dockside. The BTJR 1154C may include a field 1174 for the embarkation of the cruise from the port. The field 1174 may reference the cabin number “1234.” Although the description in FIG. 11C describes travel on a cruise ship, the BTJR 1154C may also be created when a luggage item of a registered passenger arrives at a resort, lodging entity, or other vehicle of travel, for example.

The BTJR 1154C includes one or more luggage handling fields 1170, 1172, 1174, 1176, 1178 and 1180. Each field includes an indicator box 1171 on a first side of the field. Each indicator box may be caused to indicate the status of the luggage item when the P-BTI on the global bag tag 230 is scanned. For example, scanning the P-BTI on the global bag tag on arrival or for departure may cause the indicator box 1171 to display an icon or color representative of the status. In one or more embodiments, the field 1170 is created when the luggage item arrives and the GMMT bag tag is scanned. This luggage item may not have arrived by the passenger using a cab, UBER, LYFT, or other ground transportation without being checked in to the system previously. The BTJR 1154C may have been generated in advance if the system 100 received the voyage reservations in advance. Alternately, the BTJR 1154C may be generated on-the-fly upon arrival at a vehicle of travel or vehicle of transportation. Upon departure from security at field 1178, the GMMT bag tag may be scanned to log the departure of the luggage item from the security and cruise ship.

Each luggage handling field may include varying icons 1182 on a second side opposite the first side of the field. The icons 1182 may distinguish the different locations and modes of travel or vehicle of travel the luggage item is to travel through on its journey parallel or independently relative to its owner.

When the luggage item arrives dockside, the global bag tag 230 may be scanned by a scanner or other acquiring device to acquire the P-BTI (FIG. 2B). The scanner may be dockside and configured to scan barcodes, such as at least the P-BTI, and communicate the barcodes (e.g., the P-BTI) to system 100. The system may update the BTJR 1154C with acknowledgement of the presence of the luggage item of a registered passenger that is ready to embark on a cruise listed in their currently listed PNR.

When the registered passenger disembarks the cruise ship, a scanner or barcode acquiring device may acquire a representation of the P-BTI from a substrate of the global bag tag 230 for use by computing devices. The location data may also be sent to system 100 to update the BTJR 1154C to show that the luggage item has departed from the location.

BTJR 1154C may include security check fields 1172 and 1178. By way of a non-limiting example, a luggage item and/or passenger may be required to pass through Customs, a second mode of travel security screening location, or other government security screening point. Any scanner or barcode acquiring device on the cruise ship or at the security screening point may be configured to communicate with the system 100 to log the location of the luggage item by acquiring a representation of the P-BTI from a substrate of the global bag tag 230, such as by providing the location data of the scanner or acquiring device. Furthermore, information associated with passing or failing the security screening may be sent to the system 100 and logged.

In view of the foregoing, the global bag tag can be used to log the arrival and departure of luggage items to and from any mode of travel without the luggage item traveling on an airplane during an end-to-end travel journey.

In view of the foregoing, the global bag tag can be used to log the arrival and departure of luggage items to and from any mode of travel without the luggage item traveling on an airplane prior to arriving at the mode of travel.

In view of the foregoing, the system and methods described herein link a global multi-mode travel (GMMT) bag tag number to at least one travel membership number for a registered passenger to access reservation information associated with the at least one vehicle of travel associated with the at least one travel membership number of the registered passenger. This allows the system and method to collect reservation information, in a registered passenger profile linked to the GMMT bag tag number, for a current travel journey of at least one luggage item to travel independently of or parallel to the registered passenger. The system and method may build a baggage travel journey record (BTJR) for pickup and delivery of the at least one luggage item based on the collected reservation information, the BTJR being linked to the GMMT bag tag number.

The system and method may link one or more luggage items of the registered passenger to the GMMT bag tag number and a PNR number for a current travel journey.

The system and method may link one or more luggage items of non-registered passengers of a group sharing a PNR number with the registered passenger, for example. The travel reservation data of the non-registered passengers may be linked by the GMMT bag tag, the group's PNR number and in some instances, a non-discarded IATA bag tag placed on the luggage item.

FIGS. 13A-13B illustrate a flowchart of a method 1300 for missing, lost, rerouted, delayed, or mishandled luggage item recovery management in accordance with an embodiment. As used herein an anomalous luggage item may be missing, lost, rerouted, delayed, or mishandled. The luggage item recovery manager 180 (FIG. 1B) may be configured to perform one or more of the following blocks of method 1300 to electronically locate and/or recover an anomalous luggage item and manage rerouting of the recovered anomalous luggage item. The luggage item may be associated with a registered passenger, or a non-registered passenger associated with a GTE-BSM linking structure 950 by matching the passenger name in any of the GTE-BSM fields, gte-BSM fields, or T-BSM fields. For an anomalous luggage item missing while traveling using other vehicles of travel, the data in the VOT-BSM fields would be used.

Method 1300 may include, at block 1302, generating, by a processor, a master travel manifest. The master travel manifest 109 (FIG. 1A) may include those passengers traveling on a current day. The passengers may include registered passengers. Once the travel manifest 109 is generated at block 1302, method 1300 may proceed to block 1304 and 1310. In one or more embodiments, the luggage item may not be traveling by air carrier. Consequently, B-Type messages may not be received from an air carrier.

As the day proceeds and the GTE-BSM structures 950 may be formed with non-registered passengers, the master travel manifest may be updated. For example, as the passengers check into flights or other VOTs, the master manifest may be updated. In the instance of an air carrier, the A-BSM may be collected first to determine outbound flight data.

The A-BSM when a luggage item is checked in provides “routine” routing information of an expected route taken by a luggage item. The .V/data field 804 includes a baggage source indicator “T” to denote Transfer. The baggage source indicator is followed by a three-digit airport code of “JFK.” The field 806 of FIG. 8 represents the outbound flight number, airline code, and date “22MAY.” The airline code “IST” represents Istanbul Airport. The field 808 is an Inbound flight number, airline code, and date “12MAY.” The airline code “SLC” represents Salt Lake City Airport.

In this instance, the luggage item will be routed through BHSs of the airports with codes “SLC,” “IST,” and “JFK.” The transfer function is provided by the baggage source indicator in the .V field. This is an international flight and the luggage item may need to be screened by security. This is still a routine process. Each BHS has machines with airport locations. The luggage item may be placed in containers that include RFID chips that can be scanned by machines of the BHS at a particular airport. All of the scanning activities of the BHS may be tracked and stored in memory by a computer system of the BHS or a computer system associated with an air travel carrier. For example, information associated with a luggage item traveling on an airline may be stored in memory and accessible by a computer system associated by the air travel carrier regardless of which BHS scanned the luggage item.

Method 1300 may include, at block 1304, receiving, by a processor of system 100, at least one B-Type message. The B-Type message may also be used in other methods described herein such as without limitation as described in FIG. 4B.

Method 1300 may include, at block 1306, sorting, by a processor of system 100, the B-Type messages for reference indicators that represent a possible non-routine routed luggage item. The processor(s) (i.e., web server 112) of system 100 search or sort for a reference to a possible non-routine routed luggage item in B-Type messages. The method 1300 may sort for reference indicators in BNSs for outbound flights from the master travel manifest 109, at block 1307A, for example. The reference indicators of possible non-routine routed luggage items may cause the luggage item to be an anomalous luggage item. Reference indicators may include airport codes. The routine route may identify certain airport codes in the BSM information. Receiving information with airport codes different from the routine route airport codes may be an indication of a non-routing route.

For example, the processor(s) (i.e., web server 112) of system 100 may look for any baggage not seen messages for passengers in the master travel manifest 109. In order to save processing time, the received or accessed BNSs may be focused on outbound flight data for passenger's associated with the baggage handling service using the GMMT bag tag. Once the A-BSM is received, the IATA bag tag number is obtained for identifying those B-Type messages to search or sort through.

A still further reference indicator to a possible non-routine routed luggage item in a B-Type message may be found in a BPM, at block 1307B. For example, the BPM may include bag not seen reference indicators. The BPM may include reference indicators for irregularities under field .B. The BPM may include reference indicators that represent other non-routine routing of a luggage item. The BPM includes various fields, such as field .J for communicating data about scanners that scan the luggage items, and include that date, time, and location. The BPM data may be used to backtrack the route or to track the current location of an anomalous luggage item. The BHS may include data of scanners, date of scan and location data for finding the route a luggage item took after a luggage items route diverged from a normal or routine route to a non-routine route. A non-routine route can be caused by many factors, such as delays in flights, equipment malfunctions, inclement weather, damaged bag tags, and more that are unforeseen.

Another reference to a possible non-routine routed luggage item in B-Type messages may be a reference indicator for irregular operation and/or involuntary rerouting, in a BTM, at block 1307C. This may be represented in a B-Type message in the field “.E/IROP” for example, from a BTM. A still further reference to a possible non-routine routed luggage item in a B-Type message may be a reference to an unaccompanied baggage denoted in a field “.E/UNAC. A still further reference to a possible non-routine routed luggage item in a B-Type message may include reference to the reference indicator for rerouting of the luggage item denoted as “.E/RRTE.” The reference indicators may represent information that can be considered for an anomalous luggage item that is not following the routine route to the final destination. Delays in arrival of a luggage item can significantly impact the travel experience and pleasure experience by its owner especially if the passenger is embarking on a cruise voyage or traveling a long distance from the airport.

Another reference indicator representative of a possible non-routine routed luggage item in a B-Type message may include a reference for re-tagging a luggage item denoted as “E/STCK,” which may be found in a BSM.

As can be appreciated, there are numerous scenarios where a combination of data in B-type message(s) may indicate a non-routine routed luggage item which may cause the luggage item to be anomalous. Delayed luggage for those passengers embarking on a cruise ship can be devastating to the overall enjoyment of the passenger. The method herein intends to identify possible luggage items, which may be routed in a non-routine manner so that it can be identified early on in the travel process. Based on time of scanning, the system 100 may determine that the luggage item may be delayed.

The B-Type message may be received from a computer system associated with an air carrier, the BHS 63B (FIG. 1B) or other computing system that receives and stores B-Type messages. The received B-Type messages may include A-BSM messages associated with passengers in the manifest 109. As described above, as the passenger(s) begins their journey, their luggage item may receive an IATA bag tag for attachment to the luggage item or already have an RFID bag tag. The A-BSM may provide outbound flight information.

Method 1300 may include, at block 1308, matching, by a processor of system 100, travel information (passenger name, IATA bag tag number, and/or PNR number) from the master travel manifest 109 to passenger name, IATA bag tag number, and/or PNR number in the B-Type message. In one or more embodiments, block 1308 may be performed before block 1306.

Method 1300 may include, at block 1312 of FIG. 13B, determining, by a processor of system 100, whether a match related to a reference indicator for a non-routine routed luggage item has been detected for any passenger in the master travel manifest. If the determination, at block 1312, is “NO,” the method may loop back onto the beginning of block 1312. If the determination, at block 1312, is “YES,” the method 1300 may include finding/tracking the luggage item, by conducting a find luggage item process, at block 1314. The luggage item finder 181 will be described in more detail in relation to FIG. 14.

Returning to block 1310, a determination may be made is the luggage item is missing or anomalous. If the determination, at block 1310, is “NO,” the method may loop back onto the beginning of block 1310. If the determination, at block 1310, is “YES,” the method may proceed to block 1314.

The BHS 63B (FIG. 1B) or other airport scanners or RFID readers interacting with the luggage item may determine that a luggage item did not load onto an air carrier. See “Recommended Practice 1745 Baggage Information Messages” by IATA, in the Passenger Services Resolution Manual, June 2010, 30^{th} Edition, incorporated herein by reference. In one or more embodiments, the IATA bag tag or other bag tag mechanism may be damaged and not readable or malfunctioning, which may be a cause for non-routine routing. In other embodiments, scanners may scan the location of the luggage item at a location, which is not routine, as the luggage item may have been loaded on the wrong air travel carrier and arrived at the wrong airport.

At block 1314, once a reference indicator for non-routine routing of a luggage item has been detected, routing information from the BHS and/or B-Type messages before or after the occurrence of the reference indicator may be retrieved and analyzed, by a processor of the system 100, for locating and tracking the luggage item.

Method 1300 may include determining, by a processor of the system 100, an adjusted arrival time at an intended final destination, at block 1316, for the tracked luggage item on a non-routine route path. The intended final destination may be for both the tracked luggage item and the associated passenger or just the tracked luggage item. The difference in final destination may vary depending on the time it takes to find the luggage item, the location at the time the luggage item if found and the distance to bring the found luggage item to meet up with the passenger from the non-routine route path.

Method 1300 may include notifying, by a processor of the system 100, the passenger associated with the luggage item of the current status of the luggage item, at block 1318. The passenger may be alerted of the current status and any status changes of the lost luggage item, found luggage item and/or rerouted luggage item until the passenger receives the luggage item.

Method 1300 may include determining, by a processor of the system 100, a scheduled delivery location of the luggage item at the time of arrival, at block 1320, from the current BTJR schedule. The processor(s) of system 100 may be configured to review the BTJR of the luggage item for the current travel journey to determine the locations to be picked up and delivered. Using data from the BTJR, including past deliveries and/or pickups, current location of the luggage item, a current location of the passenger or lodging entity where the passenger will return at the end of the day, may be used for rerouting the found/tracked luggage item, for example, to rendezvous with the passenger.

Method 1300 may include adjusting, by a processor of the system 100, the BTJR based on changes in the adjusted time of arrival due to the time difference from the intended time of arrival with passenger according to an original schedule and/or any delays, a current time, a mode of transportation to reroute the found/tracked luggage item, and the new time of arrival to rendezvous the luggage item with the passenger on the passenger's route, at block 1322.

Method 1300 may include confirming, by a processor of the system 100, the luggage item match at the time of pickup for delivery, at block 1324. This may include scanning an IATA bag tag to match the IATA license plate to the IATA license plate number in the profile 122. Alternately, the global bag tag may be scanned to match the GMMT bag tag number with the GMMT bag tag number in the profile 122. Still further, an image of the luggage item may be comparing a stored image of the luggage item in the profile 122. Method 1300 may include notifying the passenger of luggage item arrival and/or delivery, at block 1326.

FIG. 14 illustrates a flowchart of a method of block 1304 (hereinafter referred to as “method 1304”) for finding an anomalous luggage item in accordance with an embodiment. The luggage item finder 181 may be configured to find anomalous luggage items according to the steps of FIG. 14. The blocks of FIG. 14 are specific to an air carrier. However, some of the blocks may be used for other travel carriers.

Method 1304 may include determining, at block 1402, by a processor of system 100, whether a tracking device 40 is available on the luggage item. If the determination, at block 1402, is “NO,” method 1304 may proceed to block 1412. If the determination, at block 1402, is “YES,” method 1304 may include retrieving, by a processor of the system 100, location data 984 from the tracking device 40, at block 1404. The location data 984 is linked to the luggage item through the IATA license plate and the GMMT bag tag number on the global bag tag affixed to the luggage item.

Method 1304 may include determining, by a processor of the system 100, whether the luggage item is found at block 1406. If the determination, at block 1406, is “NO,” method 1304 proceeds to block 1412. If the determination, at block 1406, is “YES,” method 1304 proceeds to block 1416 as will be described in more detail later.

Method 1304 may include retrieving, by a processor of system 100, B-Type message data of the BHS for the IATA bag tag number associated with a luggage item matched in a B-Type message, associated with the IATA luggage item or GMMT bag tag number, at block 1412. In other words, system 100 may retrieve any B-Type messages or machine readings prior to or after the B-Type message with a reference indicator representative of a non-routine routed luggage item to find where the luggage item was last recorded or is currently being recorded. The routing of the luggage item may be due to a damaged or a missing IATA bag tag, for example. The BHS includes scanners for scanning the barcodes of the IATA bag tag. The BHS may include RFID readers to receive an RFID signal representative of the IATA bag tag.

The BHS 63B (FIG. 1B) creates many B-Type messages as the luggage item is tracked and routed. A respective B-Type message may include tracking information of the luggage item generated by a BHS 63B (FIG. 1B) prior to or after the creation of a B-Type message that has a detected reference indicator, for example. The tracking information in certain B-Type messages provides location information of where the luggage item was scanned, in the past and the future. This information can be useful in backtracking and tracking the route path the luggage item traveled. This information may be useful in tracking the path the luggage item traveled to its current location, although the wrong location or a rerouted location.

For training purposes, the information of scanners, B-Type messages, reference indicators, and/or BHS information may be used to find patterns to find cause and effect.

Method 1304 may include finding, by a processor, a route to the anomalous luggage item, at block 1414, that brings the luggage item to an intended destination or rendezvous with the passenger. The route may be a back-on-track route. When finding, by a processor of the system 100, a route, the route may include travel in an air carrier and along BHS to a final destination. A back-on-track route may include other routes that remove the luggage item from an air carrier and use another mode of transportation of the luggage item.

The analysis to find the back-on-track route may be accomplished by using artificial intelligence (AI) algorithms using the data from the retrieved B-Type messages prior to or after the occurrence of reference indicators of non-routine routing of the luggage item being detected by system 100. The data may include other information if the IATA bag tag is damaged or missing as the luggage item possibly could not be routed to the correct air carrier. The point of last scanning or the point of current scanning may determine a proximity for the lost luggage item to be fetched. The luggage item route data analyzer 182 may analyze the data from the B-Type message database 107, flight information, and/or location data from a tracking device 40 to develop a route to find the luggage item or find a back-on-track route to bring the anomalous luggage item to a destination to rendezvous with a travel path of the passenger.

Method 1340 may include generating, by a processor, a claim for an anomalous luggage item, at block 1416. Once the luggage item is lost and its proximity determined, a claim may be generated. In one or more embodiments, baggage handlers may searched for and retrieve the anomalous luggage item in an airport based on the retrieved B-Type message data.

Method 1304 may include generating, by a processor, delivery instructions for a claim, at block 1418. Once the actual location of the found luggage item is found, system 100 may determine a delivery location for the luggage item to be sent based on the current BTJR 154 (FIG. 1B). The delivery instructions may include coordination with the passenger depending on whether any of their legs of travel have changed on the current travel journey.

Method 1304 may include submitting, by a processor, the claim to a VOT, at block 1420.

Method 1304 may include notifying, by a processor, the passenger of claim submission, at block 1422. System 100 may use the passenger's email address, telephone number of a mobile communication device or other communication medium to communicate confirmation of receipt of the claim submission. System 100 may also send an alert or a communication to the passenger about the claim submission to the VOT.

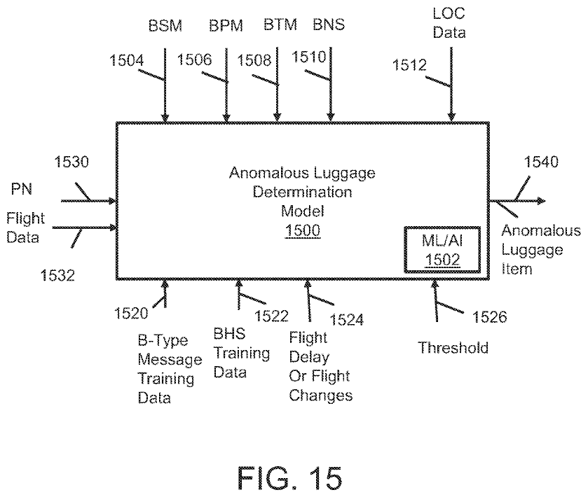

FIG. 15 illustrates a diagram of an anomalous luggage item determination model. The model 1500 may receive data related B-Type messages. By way of non-limiting reference, model 1500 may receive reference indicators associated with one or more BSMs on line 1504, BPMs on line 1506, BTMs on line 1508, or a BNS on line 1510. While there is a single line, it should be understood that various information for each message may need to be entered including date, fields, airport data, flight information, and more. The original A-BSM may be used to predict an expected route for the luggage item that is within routine limits. The reference indicators from BPM data, BTM data or BNS data may be used to predict non-routine routes.

Model 1500 may receive location data on line 1512 if the luggage item has a tracking device 40. In embodiments, with location data, reliance on tracking B-Type message data may be weighted less than location data from the tracking device once a reference indicator of a non-routine route has been detected.

Model 1500 may receive B-Type message training data on line 1520 indicative of reference indicators that are routine and reference indicators that are non-routine. Model 1500 may receive BHS training data on line 1522 related to scanners and other devices associated with BHSs of airports. Model 1500 may receive current flight delays or flight changes on line 1524 from airlines or airports. Model 1500 may receive a variable threshold on line 1526. Depending on the next leg of travel of the journey, the threshold of deviation between the current route and the routine route may vary depending on the type of next leg of travel and location of the next leg of travel. For example, embarkation on a cruise ship can be very costly to deliver delayed or lost luggage after a passenger has embarked on a voyage.

Model 1500 may receive a passenger name (PN) on line 1530, for example. In one or more embodiments, the model 1500 may receive a PNR number or an IATA license plate number on line 1530. Model 1500 may receive the flight data on line 1532 to derive the routine route using the originating BSM. Model 1500 may use various machine learning or artificial intelligence algorithms to: 1) predict a routine route of the luggage item, and/or 2) predict a non-routine route of the luggage item to find an anomalous luggage item. In one or more embodiments, the non-routine route may need to deviate from the routine route by a predetermined amount of time and/or predetermined amount of distance.

Model 1500 may output information representative of an anomalous luggage item on line 1540. The output information may include the flight data, the IATA license plate number, passenger name, and/or PNR number. The output information may include location information of the non-routine route, time difference between the expected routine route and the current non-routine route. The threshold by distance may be represented in miles, airport codes, or city codes. The threshold by time may be represented by days, hours, minutes and seconds.

The machine learning (ML) or artificial intelligence (AI) algorithms 1502 may include neural networks, Bayesian networks, Tree-based models, supervised learning algorithms, and reinforcement learning algorithms. In one or more embodiments, the ML/AI algorithms may use classification models based on the reference indicators.

As used herein, the term “model” and/or “machine learning model” shall have its ordinary technical meaning referring broadly to various types of machine learning models as understood by a person of ordinary skill in the art. Various types of machine learning models are each suited to different kinds of task and have relative advantages and disadvantages. Representative machine learning models may include, for example, (1) supervised learning, (2) unsupervised learning, (3) semi-supervised learning, (4) reinforcement learning, and (5) deep learning. Each of these models is broadly discussed below in conjunction various sub-types and more detailed implementations of the same. In embodiments in accordance with the disclosure herein, the various types of models described below may be combined and altered to suit the particular task at hand.

### Machine Learning Algorithms

Supervised Learning: Supervised learning machine learning algorithms are trained using labeled data, i.e., input data that is tagged with the correct output. The model learns to predict the output from the input data. There are several different sub-types of supervised learning models, for example, (1) linear regression, (2) logistic regression, (3) decision trees, (4) random forest, (5) support vector machines, and (6) neural networks.

Linear Regression: Linear Regression machine learning algorithms may be useful for predicting a continuous outcome variable based on one or more predictor variables. These types of algorithms models the relationship between the dependent and independent variables by fitting a linear equation to observed data.

Logistic Regression: Logistics Regression machine learning algorithms may be useful for predicting the probability that a given instance belongs to a particular class.

Decision Trees: Decision tree models may use a tree-like graph of decisions to make predictions. In various embodiments implementing decision tree models, such algorithms may be useful for both regression and classification tasks.

Random Forest: Random forest machine learning algorithms may include an ensemble of decision trees, typically used to improve the predictive accuracy and control over-fitting.

Support Vector Machines (SVMs): Support vector machine learning algorithms may be particularly well suited to determining and/or solving various issues surrounding the classification of problems and objects. These types of algorithms are effective in high dimensional spaces and they work by finding the hyperplane that best separates classes in the feature space.

Neural Networks: This type of machine learning algorithm is often used as a catch all to refer to various type of algorithms. The term “neural network” is inspired by the structure of the human brain, and these models are particularly effective for complex problems like image and speech recognition. They can model nonlinear relationships and learn complex patterns in data. For example, image analysis training and determination.

Unsupervised Learning: These algorithms are used when the training data is not labeled. The system tries to learn the patterns and the structure from the data. Examples of Unsupervised Learning algorithms are described below.

Clustering Algorithms (e.g., K-Means, Hierarchical Clustering): Used to group data points into clusters such that data points in the same cluster are more similar to each other than to those in other clusters.

Principal Component Analysis (PCA): A technique used to emphasize variation and bring out strong patterns in a dataset. It's often used to make data easy to explore and visualize.

Autoencoders: A type of neural network used to learn efficient representations of data, typically for the purpose of dimensionality reduction.

Additional machine learning algorithms are described below.

Semi-Supervised Learning: These algorithms fall between supervised and unsupervised learning since they use both labeled and unlabeled data for training.

Reinforcement Learning: This type of machine learning uses a system of rewards and penalties to compel the computer to solve a problem by itself. It's used in various applications, such as in training models to play video games and for robotic hands to grasp objects.

Deep Learning: A subset of machine learning where neural networks particularly those with many layers (deep networks) are used. It's particularly powerful for processing unstructured data like images and text. Examples of Deep Learning models are described below.

Convolutional Neural Networks (CNNs): Primarily used in image recognition and processing, they are capable of capturing spatial and temporal dependencies in an image through the application of relevant filters.

Recurrent Neural Networks (RNNs): Suitable for processing sequential data, like time series or natural language, due to their ability to store information about previous inputs using their internal memory.

Each of these models and algorithms has its own strengths and weaknesses, making them suitable for different types of data and problems. The choice of algorithm often depends on the size, quality, and nature of the data, the task to be performed, and the computational resources available.

FIG. 16A illustrates a block diagram of a tracking device 1640 (i.e., tracking device 40 or 40′) in accordance with an embodiment. Tracking device 1640 may include subscriber identity module (SIM) card 1641, a GPS-GSM tracking components 1642 and antenna ANT. The GPS-GSM tracking components 1642 may be configured to perform cell tower positioning via GSM/Cellular positioning protocol 1656, WI-FI positioning via WI-FI positioning protocol 1652, GNSS positioning via GNSS positioning protocol 1658, and BLUETOOTH positioning via BLUETOOTH positioning protocol 1654. In one or more embodiments, subscriber identity of the SIM card 1641 may be associated with a baggage handling service, luggage tracking service, an air travel carrier or vehicle of travel. In one or more embodiments, the subscriber identity of the SIM card 1641 may be associated with a passenger. The GPS-GSM tracking components 1642 may include at least one processor. Tracking device 1640 may include at least one processor 1644.

The tracking device 1640 may be routed within buildings along a journey above ground and/or underground, which may cause a GNSS-denied environment. Consequently, the tracking device 1640 may provide location information in a GNSS-denied environment. However, for use outside of the airport infrastructure, the tracking device 1640 may have GNSS access. Consequently, the tracking device 1640 may be able to provide location information derived from GNSS data.

While GSM or cellular networks are readily available, these networks do not have 100% global coverage. For example, in a building underground, cellular communications may be blocked. Depending on a building's construction or nearby buildings, communications within a building may be blocked or intermittent. Consequently, because luggage items travel through buildings and underground, as well as outside, a tracking device may need to be able to obtain location information using various methodologies and adapt to its surroundings and situational communication parameters.

In one or more embodiments, the tracking device 1640 may use available RF access points, which may include BLUETOOTH access points and/or WI-FI access points, as will be described later.

In an example, the tracking device 1640 may include an RFID unit 1643 configured to communicate using RFID frequencies. By way of non-limiting example, a tracking device 1640 with an RFID unit 1643 may be configured to communicate with RFID receivers of the baggage handling system. Some baggage handling systems have RFID receivers to read or receive an RFID signal from an IATA compatible RFID bag tag.

In one or more embodiments, the tracking device 1640 may serve as an RFID bag tag that is IATA compatible while within an airport infrastructure but also provide tracking capabilities outside of the airport infrastructure.

Tracking device 1640 may include at least one digital certificate 1646. In an embodiment, a digital certificate 1646 may be an organization level digital certificate, where the organization level digital certificate allows the encryption and decryption of organization level information. By way of non-limiting example, the organization level digital certification may be for interacting with a Kiosk 1710 (FIG. 17A) of an airline carrier and/or a BHS device 1760 (FIG. 17B). Tracking device 1640 may include a digital certificate 1646 to allow a passenger's mobile device to pair with the tracking device 1640. Tracking device 1640 may include a digital certificate 1646 to communicate with various communication platforms.

Tracking device 1640 may include a display 1648 with a display screen, power source, and memory 1650. The memory 1650 may store BSM information 1660. The BSM information 1660 may include at least one of GMMT bag tag number 1662, PNR number 1664, or IATA license plate number (IATA LPN) 1666. The BSM information 1660 may be extracted from a GTE-BSM, an originating A-BSM or a terminating BSM depending on when the tracking device is assigned to the luggage item. In one or more embodiments, the memory 1650 may be loaded with itinerary information 1674. For example, itinerary information 1674 may include a PNR number, a reservation number or other confirmation number for a vehicle of travel.

In one or more embodiments, the power source may be a battery with one or more battery saving modes. A first battery saving mode may be based on a detected altitude of the tracking device. A second battery saving mode may be based on a detected speed of the tracking device. For example, when the tracking device is in a plane while in flight, the tracking device may be turned off or placed in a sleep mode. A third battery saving mode may be based on a selected mode of communication of the tracking device. For example, a BLUETOOTH communication protocol may use less power than other communication protocols. As a result, the tracking device may select a communication protocol to save battery power.

In one or more embodiments, the display 1648 may be configured to display stored information. By way of non-limiting example, the display 1648 may display the IATA license plate number and the corresponding IATA license plate. The display 1648 may be compatible with an RFID bag tag.

In one or more embodiments, the BSM information 1660 may include information printed on an IATA compatible bag tag, including inbound flight information, outbound flight information, a PNR number, passenger name, etc. as described in relation to FIG. 8.

In one or more embodiments, a surface of tracking device 1640 may include the GMMT bag tag number 1662. In one or more embodiments, the display may display the GMMT bag tag number 1662.

In an example, the memory 1650 may store a primary ID (PID) 1668 created by a baggage handling system via BHS device 1760 (FIG. 17B). The primary ID may be a pseudo ID sent from the baggage handling system to the security screening machine 1762 (FIG. 17B), for example. In an example, the primary ID 1668 may be a TSA compatible number required to be sent by the baggage handling system to the security screening machine 1762 to identify the luggage item.

In an example, the memory 1650 may store a passenger personal identifiable information (PII) 1670. The PII 1670 may include a date of birth of the passenger associated with the passenger. In an example, PII 1670 may include a driver's license, a social security number, a passport identifier, or a government-issued identification number. In one or more embodiments, the primary ID and/or passenger personal identifiable information may be retrieved from the tracking device for use in obtaining a security screening image stored in a cloud storage system, so that the security screening image may be retrieved and reanalyzed by a security screening station.

Access to memory 1650 may be controlled by different authentication procedures. For example, pairing with a Kiosk may be different than pairing with a mobile device of the owner (i.e., passenger) of the luggage item.

In an example, the tracking device 1640 may operate in an RFID mode where the display 1648 may display the IATA license plate and other IATA compatible information for IATA RFID bag tags.

In an example, the memory 1650 may store various applications 1672, as will be described in FIGS. 16B, 16C, 16D and 16E, for performing different modes of operation. The applications 1672 may include software, hardware, firmware, or a combination thereof. The applications 1672 include programming modules configured to be executed by a processor to perform the functions and operations described below.

The tracking device may be configured to communicate with one or more service devices to cause different types of service devices to perform a function as will be evident from the description below.

FIG. 16B illustrates a block diagram of a contactless bag tag printing manager 1680B in accordance with an embodiment. FIG. 17A illustrates a block diagram for contactless luggage bag tag printing process 1700A using a tracking device in accordance with an embodiment. Currently, a checked in passenger may walk up to Kiosk 1710 to print their IATA bag tag. In one example, the passenger may enter their PNR number or itinerary confirmation number using keys 1716, which may be displayed on screen 1712. Alternately, a passenger may have already checked in themselves using an airline application and requested to digitally check in their luggage items. In this instance, the passenger receives a boarding pass with a QR code or other code. At the Kiosk 1710, the passenger places their mobile device 1701 under scanner 1714. However, it can be challenging to get the scanner to capture the QR code or other code to be scanned. Generally, the passenger's hands are full of personal belongings, including purse, jacket, coat, or a carry-on luggage item.

The contactless bag tag printing manager 1680B may include a tracker-to-printer pairing unit 1682B and an authenticator 1684B. The contactless bag tag printing manager 1680B may include a print code sequence communicator 1686B. The print code sequence may be a PNR number or another code sequence sent from memory of the tracking device to a Kiosk 1710 (FIG. 17A), for example, to cause a printer to print an IATA bag tag for a passenger. The contactless bag tag printing manager 1680B may include the PNR number or other code sequence required by an air travel carrier. In this instance, the PNR number or other code sequence for printing may be a travel application number. In one or more embodiments, the Kiosk may print a ticket or other tags for other vehicle of travel.

The pairing unit 1682B may use a BLUETOOTH pairing, for example, to pair with a BLUETOOTH enabled unit 1720. The BLUETOOTH enabled unit 1720 may be configured to pair with the tracking device with the strongest signal strength. For example, the luggage item 1750 may be placed directly in front of the Kiosk 1710. The authenticator 1684B may require a certain digital certificate to allow for the BLUETOOTH pairing with the Kiosk 1710 and the tracking device 1640, for security purposes.

Kiosk 1710 include a processor 1705 and printer 1718. In this instance, the PNR number or another code sequence may be a travel application number that is used to control a function of the Kiosk 1710. The processor 1705 may receive the travel application number to authorize the printing of an IATA bag tag.

In one or more embodiments, the Kiosk 1710 may be in an airport or remote location that processes luggage item for affixing IATA bag tags.

In one or more embodiments, the tracking device 1640 may include a button or mechanism to activate the sending of the code to the Kiosk or other printing device to print an IATA bag tag.

In one or more embodiments, the tracking device 1640, while independent of the mobile communication device of the passenger P, may be configured to receive information from or control signal from a mobile communication device 1701 of a passenger through a graphical user interface.

In one or more embodiments, the tracking device 1640 may receive information from a mobile communication device to program the memory with BSM information or a travel application number.

FIG. 16C illustrates a block diagram of a security screening manager 1680C in accordance with an embodiment. The security screening manager 1680C will be described in combination with FIG. 17B. FIG. 17B illustrates a diagram for pseudo ID (i.e., primary ID) recording process 1700B using a tracking device 1640 in accordance with an embodiment. In an example, the memory 1650 may store a pseudo ID (i.e., PID 1668) created by a baggage handling system via BHS device 1760 (FIG. 17B) and provided to a security screening machine 1762 (FIG. 17B).

The security screening manager 1680C may include a tracker-to-BHS device pairing unit 1682C and an authenticator 1684C. The pairing unit 1682C may use a BLUETOOTH pairing, for example. The authenticator 1684C may require a certain digital certificate to allow for the BLUETOOTH pairing with the BHS device 1760 (FIG. 17B) and the tracking device on luggage item 1750, for security purposes. When the tracking device/luggage item are in proximity to the BHS device 1760 entering the security screening machine 1762, the BHS device and tracking device may pair together. The BHS device may be programmed to communicate to the tracking device the primary ID, pseudo ID, or other TSA compatible numbers to identify the luggage item entering a security screening machine.

In an example, the IATA LPN communicator 1686C may communicate the IATA LPN to the BHS device 1760 (FIG. 17B) prior to receiving the primary ID, pseudo ID, or other TSA compatible number. In this instance, the IATA LPN may serve as a travel application number. The primary ID, pseudo ID, or other TSA compatible number may be received by the PID receiver 1688C. The received PID is then stored in memory of the tracking device.

FIG. 16D illustrates a block diagram of a mobile-to-tracker pairing manager 1680D in accordance with an embodiment. The mobile-to-tracker pairing manager 1680D may include a tracker-to-mobile pairing unit 1682D and an authenticator 1684D. The mobile-to-tracker pairing manager 1680D may include a print code sequence receiver 1688D and a personal identifiable information receiver 1690D. In one or more embodiments, the passenger may be communicate a print code sequence via data entry using a display of the tracking device or through wireless communications to the tracking device. In one or more embodiments, the passenger may communicate personal identifiable information via data entry using a display of the tracking device or through wireless communications to the tracking device. The personal identifiable information may be stored using an authentication protocol to authenticate the identity of the user or passenger.

The mobile-to-tracker pairing manager 1680D may include a travel information communicator 1686D that is configured to communicate any BSM or itinerary information stored in memory. The information may be sent to the display or sent by wireless communications.

FIG. 16E illustrates a block diagram of a non-routine reference indicator detection manager 1680E in accordance with an embodiment. The non-routine reference indicator detection manager 1680E may include a tracker-to-second device pairing unit 1682E and an authenticator 1684E. The second device may include a device in a baggage handling system.

The non-routine reference indicator detection manager 1680E may include reference indicator receiver 1688E and a non-routine reference indicator detector 1690E. Reference indicators may include airport codes. The original BSM information may include reference indicators of a routine route for the flight. Receiving reference indicators from within the airport that represent non-routine indicators as described herein may be detected.

The non-routine reference indicator detection manager 1680E may include a notification communicator 1692E configured to communicate a notification of a non-routine route in response to detecting one or more non-routine reference indicators.

FIG. 17C illustrates a diagram for a process 1700C to communicate location information from a Global Navigation Satellite System (GNSS) platform in accordance with an embodiment. Satellites 1765C denote a GNSS communicating with a tracking device 1640 affixed to luggage item 1750. The tracking device 1640 may communicate location information with cell tower 1767C. The cell tower may communicate the location information via network 1775 with computing device 1763C configured to track the luggage item via the tracking device 1640. The network 1775 may be the Internet or public utility communication network.

FIG. 17D illustrates a diagram of a process 1700D of the tracking device 1640 to communicate location information with at least one radio frequency (RF) access point in accordance with an embodiment. In the diagram, the RF access points are denoted as 1777A, 1777B, 1777C, and 1777D. The tracking device 1640 may be closest to RF access point 1777B to pair with and send location information through network 1775 to computing device 1763C (FIG. 17C). The tracking device may select RF access point 1777B based on signal strength, in one or more embodiments.

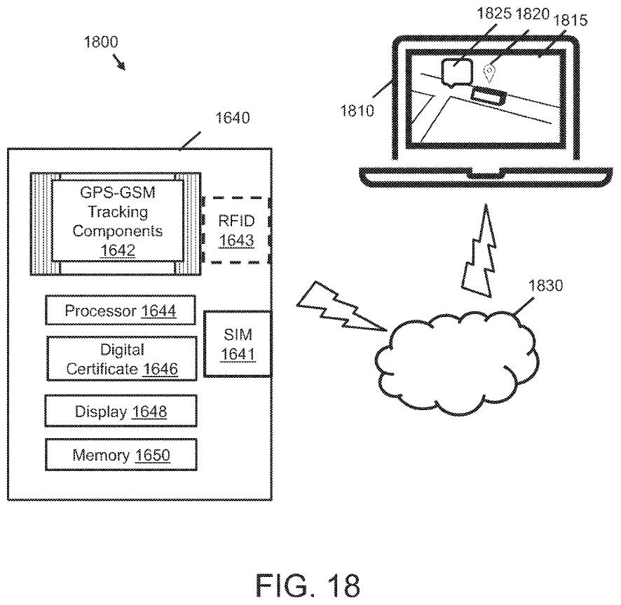

FIG. 18 illustrates a block diagram of a tracking system 1800 in accordance with an embodiment. The tracking system 1800 may include a plurality of tracking devices 1640 in communication with a tracking station 1810 (i.e., computing device) via network 1830. Network 1830 may be the Internet or other public utility communications network.

The tracking station 1810 may include a display 1815 that displays a location of a tracking device denoted by locator 1820. The tracking station 1810 may display a comment window 1825 associated with the locator 1820. The comment window 1825 may include a notification of non-routine route due to non-routine reference indicator detection. The comment window 1825 may include an address or location information. The location information may include refined information that includes building level, floor, room number, building number, and more. The location information may include information associated with nearby or surrounding Internet of Things (IoT) devices, mobile communication devices, or other RF access points.

FIG. 12 is a block diagram illustrating an electronic device in a network environment according to one or more embodiments. As used herein the electronic device 1201 may include a tracking device 40, a computing device 50, a web server 112, a component of reservation systems 60, 62, 64, 66, 68 and 70, a component of TMS 74, acquiring device 195, processor 610, at least one second processor 626, computer systems 628 and computing devices 648, for example.

The systems described herein may be implemented via one or more electronic devices operating in a network environment. For example, an electronic device 1201 (e.g., computing device 50) in a network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In a certain embodiment, at least one of the components (e.g., the connecting terminal 1278) may be omitted from the electronic device 1201, or one or more other components may be added in the electronic device 1201. In a certain embodiment, some of the components (e.g., the sensor module 1276, the camera module 1280, or the antenna module 1297) may be implemented as a single component (e.g., the display module 1260). The processor 1220 may execute, for example, software (e.g., a program 1240) to control at least one other component (e.g., a hardware or software component) of the electronic device 1201 coupled with the processor 1220 and may perform various data processing or computation. According to an embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing a record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250 or output the sound via the sound output module 1255 or a headphone of an external electronic device (e.g., an electronic device 1202) directly (e.g., wired) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wired) or wirelessly. According to an embodiment, the interface 1277 may include, for example, a high-definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to an embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mmWave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large-scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to one or more embodiments, the antenna module 1297 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a specified high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the specified high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra-low-latency services using, e.g., distributed computing or mobile edge computing. In another embodiment, the external electronic device 1204 may include an internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology. In an embodiment, electronic devices 1202 and/or 1204 may be a printing device. The printing device may be an engraving device, etching device, computer assisted design (CAD) manufacturing device, a three-dimensional printing device, laser printing device, or other printing devices.

The electronic device according to one or more embodiments may be one of various types of electronic devices. The electronic devices may include, for example, a portable communication device (e.g., a smartphone), a computer device, a portable multimedia device, a portable medical device, a printer, a camera, a wearable device, or a home appliance. According to an embodiment of the disclosure, the electronic devices are not limited to those described above.

The embodiments described herein are described with reference to the attached figures wherein like reference numerals are used throughout the figures to designate similar or equivalent elements. The figures are not drawn to scale and they are provided merely to illustrate aspects disclosed herein. Several disclosed aspects are described herein with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

Various embodiments as set forth herein may be implemented as software (e.g., a program 1240) including one or more instructions that are stored in a storage medium (e.g., an internal memory 1236 or an external memory 1238) that is readable by a machine (e.g., an electronic device 1201). For example, a processor (e.g., a processor 1220 of an electronic device 1201) of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to various embodiments of the disclosure, a method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store, or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

The electronic device 1201 may include accelerometers (ACC) and/or gyroscopes 1282, Global Positioning System (GPS) 1280 and/or an Inertial Navigation Unit (INU) 1284 to determine its own location.

Aspects of the embodiments are described below with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by machine-readable program instructions.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general-purpose computer, but rather the special purpose computer programmed to perform the disclosed algorithm.

A general-purpose computer, or microprocessor, may be programmed to carry out the algorithm/steps for creating a new machine. The general-purpose computer becomes a special purpose computer once it is programmed to perform particular functions pursuant to instructions from program software of the embodiments described herein. The instructions of the software program that carry out the algorithm/steps electrically change the general-purpose computer by creating electrical paths within the device. These electrical paths create a special purpose machine for carrying out the particular algorithm/steps.

Unless otherwise defined, all terms (including technical and scientific terms) used herein have the same meaning as commonly understood by one of ordinary skill in the art to which embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In particular, unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such data storage, transmission or display devices.

“Communication media” typically comprise computer readable instructions, data structures, program modules, or other data in a modulated data signal, such as carrier wave or other transport mechanism. The communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, infrared, and other wireless media. Combinations of any of the above are also included within the scope of computer readable medium.

Alternatively, or in addition, any of the functions and programming modules described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products, System-on-a-chip systems, Complex Programmable Logic Devices, and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices, otherwise known as non-transitory devices. The features of the embodiments described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaming console, wearable device, an IoT device, and the like).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the Abstract is provided to allow the public to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

It will be understood that when an element is referred to herein as being “connected” with or to another element, it can be directly or indirectly connected to the other element, wherein the indirect connection includes “connection via a wireless communication network”.

Throughout the description, when a member is “on” another member, this includes not only when the member is in contact with the other member, but also when there is another member between the two members.

Herein, the expression “at least one of a, b [and/or]c” indicates “only a,” “only b,” “only c,” “both a and b,” “both a and c,” “both b and c,” or “all of a, b, and c.”

While the various example methods described herein may depict a particular sequence of operations, such sequences may be altered without departing from the scope of the present disclosure. For example, some of the operations depicted may be performed in parallel or in a different sequence that does not materially affect the function of the methods. In other examples, different components of an example device or system that implements the methods may perform functions at substantially the same time or in a specific sequence. In one or more embodiments, blocks of the sequence may be omitted or added.

What is claimed is:

1. A method comprising:
generating, by at least one of at least one processor, a global multi-mode travel (GMMT) bag tag number for a luggage item of a registered passenger, wherein the GMMT bag tag number comprises a permanently assigned license plate compatible with International Air Transport Association (IATA) regulations for a duration that expires after a predetermined useful life;
generating, by at least one of the at least one processor, a global tracking expanded baggage source message (GTE-BSM) comprising the GMMT bag tag number and a passenger name of the registered passenger; and
forming, by a printing device, a GMMT code indicum representative of the GMMT bag tag number on a substrate configured to be affixed to the luggage item.

2. The method of claim 1, further comprising:
receiving, by at least one of the at least one processor, current journey information representative of at least one travel membership number for the registered passenger, a passenger name record (PNR) number for the registered passenger, or an itinerary confirmation (IC) number for the registered passenger; and
building, by at least one of the at least one processor, a baggage travel journey record based on the current journey information for the luggage item of the registered passenger, wherein the baggage travel journey record comprises a luggage delivery location and a luggage pickup location.

3. The method of claim 2, further comprising:
determining, by at least one of the at least one processor, a number of luggage items associated with the registered passenger for the current journey information; and
linking, by at least one of the at least one processor, the GMMT bag tag number to each luggage item associated with the registered passenger for the current journey information.

4. The method of claim 2, further comprising:
accessing, by at least one of the at least one processor, a database associated with the at least one travel membership number, the PNR number, or the IC number to obtain other passenger names associated with the current journey information of the registered passenger; and
linking, by at least one of the at least one processor, the GMMT bag tag number with the other passenger names associated with the current journey information.

5. The method of claim 4, wherein the building, by at least one of the at least one processor, the baggage travel journey record based on the current journey information comprises:
building, by at least one of the at least one processor, the baggage travel journey record based on the current journey information for luggage items of the other passenger names.

6. The method of claim 1, further comprising:
receiving, by at least one of the at least one processor, preferential multi-mode (PMM) travel information from a computing device of the registered passenger; and
generating, by at least one of the at least one processor, a database of stored passenger information associated with the luggage item identifying the PMM travel information linked to the GMMT bag tag number,
wherein the generating, by at least one of the at least one processor, the GMMT bag tag number, further comprises:
generating, by at least one of the at least one processor, at least one PMM travel code.

7. The method of claim 6, wherein the forming, by the printing device, the GMMT code indicum on the substrate further comprises:
forming, by the printing device, at least one PMM travel code indicum representative of the at least one PMM travel code in series with or adjacent to the GMMT code indicum on the substrate.

8. The method of claim 6, wherein the PMM travel information comprises one or more travel management system numbers of the registered passenger or an online travel booking engine number of the registered passenger.

9. The method of claim 6, wherein the PMM travel information comprises one or more travel membership numbers of the registered passenger.

10. The method of claim 9, wherein the one or more travel membership numbers comprise one or more of:
a frequent flyer number of an airline company;
a hotel membership number of a hotel company;
a rental car membership number of a rental car company; and
a cruise line membership number of a cruise line company.

11. The method of claim 10, further comprising:
receiving, by at least one of the at least one processor, current journey information representative of a travel membership number, a PNR number or an itinerary confirmation number; and
building, by at least one of the at least one processor, a baggage travel journey record based on the PMM travel information and the current journey information.

12. The method of claim 11,
wherein the building of the baggage travel journey record based on the PMM travel information comprises one or more of:
querying, by at least one of the at least one processor, a reservation system associated with the airline company for a destination airport location of a baggage travel journey;
querying, by at least one of the at least one processor, a reservation system associated with the hotel company for a hotel reservation location for the baggage travel journey; and
querying, by at least one of the at least one processor, a reservation system associated with the cruise line company for a cruise reservation location for the baggage travel journey, and
wherein the method further comprises:
populating, by at least one of the at least one processor, the baggage travel journey record with one or more of the destination airport location, the hotel reservation location, or the cruise reservation location.

13. The method of claim 1, wherein the duration is renewable.

14. The method of claim 1, wherein the predetermined useful life is coextensive with a lifetime of the registered passenger.

15. A system comprising:
at least one processor; and
at least one non-transitory, tangible memory communicatively coupled to the at least one processor, the at least one memory storing at least one instruction,
wherein the at least one processor is configured to execute the at least one instruction to:
generate a global multi-mode travel (GMMT) bag tag number for a luggage item of a registered passenger, wherein the GMMT bag tag number comprises a permanently assigned license plate compatible with International Air Transport Association (IATA) regulations for a duration that expires after a predetermined useful life,
generate a global tracking expanded baggage source message (GTE-BSM) that includes the GMMT bag tag number and a passenger name of the registered passenger, and
cause a printing device to form a GMMT code indicum representative of the GMMT bag tag number on a substrate to be affixed to the luggage item.

16. The system of claim 15, wherein the at least one processor is further configured to execute the at least one instruction to:
receive current journey information representative of at least one travel membership number for the registered passenger, a passenger name record (PNR) number for the registered passenger, or an itinerary confirmation (IC) number for the registered passenger, and
build a baggage travel journey record based on the current journey information for the luggage item of the registered passenger, wherein the baggage travel journey record comprises a luggage delivery location and a luggage pickup location.

17. The system of claim 16, wherein the at least one processor is further configured to execute the at least one instruction to:
determine a number of luggage items associated with the registered passenger for the current journey information, and
link the GMMT bag tag number to each luggage item associated with the registered passenger for the current journey information.

18. The system of claim 16, wherein the at least one processor is further configured to execute the at least one instruction to:
access a database associated with the at least one travel membership number, the PNR number, or the IC number to obtain other passenger names associated with the current journey information of the registered passenger, and
link the GMMT bag tag number with the other passenger names associated with the current journey information.

19. The system of claim 18, wherein the at least one processor is further configured to execute the at least one instruction to:
build the baggage travel journey record based on the current journey information for luggage items of the other passenger names.

20. The system of claim 15, wherein the at least one processor is further configured to execute the at least one instruction to:
receive preferential multi-mode (PMM) travel information from a computing device of the registered passenger,
generate a database of stored passenger information associated with the luggage item identifying the PMM travel information linked to the GMMT bag tag number, and
generate at least one PMM travel code contemporaneously with the generation of the GMMT bag tag number.

21. The system of claim 20, wherein the at least one processor is further configured to execute the at least one instruction to:
cause the printing device to form at least one PMM travel code indicum representative of the at least one PMM travel code in series with or adjacent to the GMMT code indicum on the substrate.

22. The system of claim 20, wherein the PMM travel information comprises one or more travel management system numbers of the registered passenger or an online travel booking engine number of the registered passenger.

23. The system of claim 20, wherein the PMM travel information comprises one or more travel membership numbers of the registered passenger.

24. The system of claim 23, wherein the one or more travel membership numbers comprise one or more of:
a frequent flyer number of an airline company,
a hotel membership number of a hotel company,
a rental car membership number of a rental car company, and
a cruise line membership number of a cruise line company.

25. The system of claim 24, wherein the at least one processor is further configured to execute the at least one instruction to:
receive current journey information representative of at least one travel membership number, a PNR number, or an itinerary confirmation number, and
build a baggage travel journey record based on the PMM travel information and the current journey information.

26. The system of claim 25, wherein the at least one processor is further configured to execute the at least one instruction to:
build the baggage travel journey record based on the PMM travel information by:
querying a reservation system associated with the airline company for a destination airport location of a baggage travel journey,
querying a reservation system associated with the hotel company for a hotel reservation location for the baggage travel journey, and
querying a reservation system associated with the cruise line company for a cruise reservation location for the baggage travel journey, and
wherein the at least one processor is further configured to execute the at least one instruction to:
populate the baggage travel journey record with one or more of the destination airport location, the hotel reservation location, or the cruise reservation location.

27. The system of claim 15, wherein the duration is renewable.

28. The system of claim 15, wherein the predetermined useful life is coextensive with a lifetime of the registered passenger.

29. A non-transitory computer readable medium having instructions stored therein, which when executed by at least one processor cause the at least one processor to execute a method comprising:
generating, by at least one of the at least one processor, a global multi-mode travel (GMMT) bag tag number for a luggage item of a registered passenger, wherein the GMMT bag tag number comprises a permanently assigned license plate compatible with International Air Transport Association (IATA) regulations for a duration that expires after a predetermined useful life;
generating, by at least one of the at least one processor, a global tracking expanded baggage source message (GTE-BSM) comprising the GMMT bag tag number and a passenger name of the registered passenger; and
forming, by a printing device, a GMMT code indicum representative of the GMMT bag tag number on a substrate configured to be affixed to the luggage item.

30. The non-transitory computer readable medium of claim 29, wherein the method further comprises:
receiving, by the processor, current journey information representative of at least one travel membership number for the registered passenger, a passenger name record (PNR) number for the registered passenger, or an itinerary confirmation (IC) number for the registered passenger; and
building, by at least one of the at least one processor, a baggage travel journey record based on the current journey information for the luggage item of the registered passenger, wherein the baggage travel journey record comprises a luggage delivery location and a luggage pickup location.

31. The non-transitory computer readable medium of claim 30, wherein the method further comprises:
determining, by at least one of the at least one processor, a number of luggage items associated with the registered passenger for the current journey information; and
linking, by at least one of the at least one processor, the GMMT bag tag number to each registered luggage item of the registered passenger for the current journey information.

32. The non-transitory computer readable medium of claim 30, wherein the method further comprises:
accessing, by at least one of the at least one processor, a database associated with the at least one travel membership number, the PNR number, or the IC number to obtain other passenger names associated with the current journey information of the registered passenger; and
linking, by at least one of the at least one processor, the GMMT bag tag number with the other passenger names associated with the current journey information.

33. The non-transitory computer readable medium of claim 32, wherein the building, by at least one of the at least one processor, the baggage travel journey record based on the current journey information comprises:
building, by at least one of the at least one processor, the baggage travel journey record based on the current journey information for luggage items of the other passenger names.

34. The non-transitory computer readable medium of claim 29, wherein the method further comprises:
receiving, by at least one of the at least one processor, preferential multi-mode (PMM) travel information from a computing device of the registered passenger; and
generating, by at least one of the at least one processor, a database of stored passenger information associated with the luggage item identifying the PMM travel information linked to the GMMT bag tag number;
wherein the generating, by at least one of the at least one processor, the GMMT bag tag number, further comprises:
generating, by at least one of the at least one processor, at least one PMM travel code.

35. The non-transitory computer readable medium of claim 34, wherein the forming, by the printing device, the GMMT code indicum on the substrate further comprises:
forming, by the printing device, at least one PMM travel code indicum representative of the PMM travel code in series with or adjacent to the GMMT code indicum on the substrate.

36. The non-transitory computer readable medium of claim 34, wherein the PMM travel information comprises one or more travel management system numbers of the registered passenger or an online travel booking engine number of the registered passenger.

37. The non-transitory computer readable medium of claim 34, wherein the PMM travel information includes one or more travel membership numbers of the registered passenger.

38. The non-transitory computer readable medium of claim 33, wherein the one or more travel membership numbers comprise one or more of:
a frequent flyer number of an airline company;
a hotel membership number of a hotel company;
a rental car membership number of a rental car company; and
a cruise line membership number of a cruise line company.

39. The non-transitory computer readable medium of claim 38, wherein the method further comprises:
receiving, by at least one of the at least one processor, current journey information representative of at least one travel membership number, a PNR number or an itinerary confirmation number; and
building, by at least one of the at least one processor, a baggage travel journey record based on the PMM travel information and the current journey information.

40. The non-transitory computer readable medium of claim 35,
wherein the building of the baggage travel journey record based on the PMM travel information comprises one or more of:
querying, by at least one of the at least one processor, a reservation system associated with the airline company for a destination airport location of a baggage travel journey;
querying, by at least one of the at least one processor, a reservation system associated with the hotel company for a hotel reservation location for the baggage travel journey; and
querying, by at least one of the at least one processor, a reservation system associated with the cruise line company for a cruise reservation location for the baggage travel journey, and
wherein the method further comprises:
populating, by at least one of the at least one processor, the baggage travel journey record with one or more of the destination airport location, the hotel reservation location, or the cruise reservation location.

41. The non-transitory computer readable medium of claim 29, wherein the duration is renewable.

42. The non-transitory computer readable medium of claim 29, wherein the predetermined useful life is coextensive with a lifetime of the registered passenger.

43. A method comprising:
electronically acquiring, by at least one electronic acquiring device, an electronic representation of a global multi-mode travel (GMMT) code indicum from a substrate associated with a global bag tag on a first luggage item of a registered passenger to create a digital GMMT data record linked to the registered passenger, wherein the GMMT code indicum is an International Air Transport Association (IATA) compatible license plate;
accessing, by a first processor, a global tracking expanded baggage source message (GTE-BSM) containing a passenger name record (PNR) number of the registered passenger using a unique identifier representative of the digital GMMT data record from a computer system associated with a multi-mode baggage handling service;
receiving, by the first processor, information that confirms an identity of the registered passenger associated with the PNR number; and
linking, by at least one second processor in communication with the first processor, the GTE-BSM of the registered passenger to each different airline baggage source message (A-BSM) associated with each different luggage item associated with a traveling passenger name associated with the PNR number in the GTE-BSM.

44. The method of claim 43, further comprising:
checking in, by at least one of the at least one second processor, the first luggage item of the registered passenger within a check-in window, for a leg of travel with an air carrier; and
causing, by at least one of the at least one second processor, creation of an originating IATA license plate for the first luggage item associated with the leg of travel with the air carrier.

45. The method of claim 44, wherein each A-BSM is an IATA compatible baggage source message (BSM).

46. The method of claim 44, further comprising:
accessing, by at least one of the at least one second processor, a database associated with the PNR number to obtain names of non-registered passengers associated with current journey information of the registered passenger;
generating, by at least one of the at least one second processor, separate temporary baggage source messages (T-BSMs) respectively corresponding to each separate luggage item of each non-registered passenger based on the PNR number; and
linking the separate T-BSM corresponding to each separate luggage item of each non-registered passenger to the GTE-BSM.

47. The method of claim 46, further comprising:
checking-in, by at least one of the at least one second processor, each different luggage item of the non-registered passengers identified in the database associated with the PNR number, wherein each different luggage item associated with the non-registered passengers has a different A-BSM; and
causing, by at least one of the at least one second processor, a printing device to print an IATA luggage bag tag with a created IATA license plate for each checked-in luggage item of the non-registered passengers.

48. The method of claim 43, wherein the receiving, by the first processor, the information that confirms the identity of the registered passenger comprises:
capturing, by an imaging device in communication with the first processor, an image of the registered passenger; and
performing facial recognition based on the image of the registered passenger and a stored image of the registered passenger.

49. The method of claim 48, further comprising:
capturing, by the imaging device in communication with the first processor, an image of each separate luggage item of other traveling passenger names associated with the PNR number, prior to departing a luggage pickup location.

50. The method of claim 43, further comprising, prior to the electronically acquiring:
registering, by at least one of the at least one second processor, a passenger with the multi-mode baggage handling service; and
generating, by at least one of the at least one second processor, a GTE-BSM comprising a passenger name of the registered passenger and the unique identifier, wherein the unique identifier comprises a GMMT bag tag number representative of the GMMT code indicum,
wherein the GMMT bag tag number comprises a permanently assigned license plate compatible with an IATA license plate format for a duration that expires after a predetermined useful life.

51. The method of claim 43, further comprising:
automatically creating, by at least one of the at least one second processor, a luggage item manifest record from the digital GMMT data record and the PNR number.

52. The method of claim 50, wherein the duration is renewable and the predetermined useful life is in a range of one month to 10 years or one month to 20 years.

53. The method of claim 50, wherein the predetermined useful life is coextensive with a lifetime of the registered passenger.

54. A system comprising:
at least one processor; and
at least one non-transitory, tangible memory communicatively coupled to the at least one processor, the at least one memory storing at least one instruction,
wherein the at least one processor is configured to execute the at least one instruction to:
obtain, from at least one electronic acquiring device, an electronic representation of a global multi-mode travel (GMMT) code indicum associated with a global bag tag on a first luggage item of a registered passenger to create a digital GMMT data record linked to the registered passenger, wherein the GMMT code indicum is an International Air Transport Association (IATA) compatible license plate;
access a global tracking expanded baggage source message (GTE-BSM) containing a passenger name record (PNR) number of the registered passenger using a unique identifier representative of the digital GMMT data record from a computer system associated with a multi-mode baggage handling service;
receive information that confirms an identify of the registered passenger associated with the PNR number; and
link the GTE-BSM of the registered passenger to each different airline baggage source message (A-BSM) for each different luggage item associated with a traveling passenger name associated with the PNR number in the GTE-BSM.

55. The system of claim 54, wherein the at least one processor is further configured to execute the at least one instruction to:
check in the first luggage item of the registered passenger within a check-in window, for a leg of travel with an air carrier; and
cause creation of an originating IATA license plate for the first luggage item associated with the leg of travel with the air carrier.

56. The system of claim 55, wherein each A-BSM is an IATA compatible baggage source message (BSM).

57. The system of claim 55, wherein the at least one processor is further configured to execute the at least one instruction to:
access a database associated with the PNR number to passenger names of non-registered passengers associated with current journey information of the registered passenger;
generate separate temporary baggage source messages (T-BSMs) respectively corresponding to each separate luggage item of each non-registered passenger based on the PNR number; and
link the separate T-BSMs corresponding to each separate luggage item of each non-registered passenger to the GTE-BSM.

58. The system of claim 57, wherein the at least one processor is further configured to execute the at least one instruction to:
check in each separate luggage item of the non-registered passengers identified in the database associated with the PNR number; and
cause a printing device to print an IATA luggage bag tag with a created IATA license plate for each checked-in luggage item of the non-registered passengers.

59. The system of claim 54, wherein the information that confirms an identify of the registered passenger comprises an image of the registered passenger captured by an imaging device in communication with the at least one processor, and
wherein the at least one processor is further configured to execute the at least one instruction to:
perform facial recognition based on the image of the registered passenger and a stored image of the registered passenger.

60. The system of claim 59, wherein the at least one processor is further configured to execute the at least one instruction to:
receive, from the imaging device in communication with the at least one processor, a captured image of each luggage item of the traveling passenger name associated with the PNR number, prior to departing a luggage pickup location.

61. The system of claim 54, wherein the at least one processor is further configured to execute the at least one instruction to, prior to the obtaining the electronic representation of the GMMT:
register a passenger with the multi-mode baggage handling service; and
generate a GTE-BSM comprising a passenger name of the registered passenger and the unique identifier, wherein the unique identifier comprises a GMMT bag tag number representative of the GMMT code indicum, and
wherein the GMMT bag tag number comprises a permanently assigned license plate compatible with an IATA license plate format for a duration that expires after a predetermined useful life.

62. The system of claim 57, wherein the at least one processor is further configured to execute the at least one instruction to:
automatically create a luggage item manifest record from the digital GMMT data record and the PNR number.

63. The system of claim 61, wherein the duration is renewable and the predetermined useful life is in a range of one month to 10 years or one month to 20 years.

64. The system of claim 61, wherein the predetermined useful life is coextensive with a lifetime of the registered passenger.

65. A non-transitory computer readable medium having instructions stored therein, which when executed by at least one processor cause the at least one processor to execute a method comprising:
obtaining, from at least one electronic acquiring device, an electronic representation of a global multi-mode travel (GMMT) code indicum from a substrate associated with a global bag tag on a first luggage item of a registered passenger to create a digital GMMT data record linked to the registered passenger, wherein the GMMT code indicum is an International Air Transport Association (IATA) compatible license plate;
accessing, by a first processor, a global tracking expanded baggage source message (GTE-BSM) containing a passenger name record (PNR) number of the registered passenger using a unique identifier representative of the digital GMMT data record from a computer system associated with a multi-mode baggage handling service;
receiving, by the first processor, information that confirms an identity of the registered passenger associated with the PNR number; and
linking, by at least one second processor in communication with the first processor, the GTE-BSM of the registered passenger to each different airline baggage source message (A-BSM) associated with each different luggage item associated with a traveling passenger name associated with the PNR number in the GTE-BSM.

66. The non-transitory computer readable medium of claim 65, wherein the method further comprises:
checking in, by at least one of the at least one second processor, the first luggage item of the registered passenger within a check-in window, for a leg of travel with an air carrier; and
causing, by at least one of the at least one second processor, creation of an originating IATA license plate for the first luggage item associated with the leg of travel with the air carrier.

67. The non-transitory computer readable medium of claim 66, wherein each A-BSM is an IATA compatible baggage source message (BSM).

68. The non-transitory computer readable medium of claim 66, wherein the method further comprises:
accessing, by at least one of the at least one second processor, a database associated with the PNR number to obtain names of non-registered passengers associated with the current journey information of the registered passenger;
generating, by at least one of the at least one second processor, separate temporary baggage source messages (T-BSMs) respectively corresponding to each separate luggage item of each non-registered passenger based on the PNR number; and
linking the separate T-BSM corresponding to each separate luggage item of each non-registered passenger to the GTE-BSM.

69. The non-transitory computer readable medium of claim 68, wherein the method further comprises:
checking in, by at least one of the at least one second processor, each separate luggage item of the non-registered passengers identified in the database associated with the PNR number wherein each luggage item associated with the non-registered passengers has a different A-BSM; and
causing, by at least one of the at least one second processor, a printing device to print an IATA luggage bag tag with a created IATA license plate for each checked-in luggage item of the non-registered passengers.

70. The non-transitory computer readable medium of claim 65, wherein the receiving, by the first processor, the information that confirms the identity of the registered passenger comprises:
receiving, from an imaging device in communication with the first processor, a captured image of the registered passenger; and
performing facial recognition based on the captured image of the registered passenger and a stored image of the registered passenger.

71. The non-transitory computer readable medium of to claim 70, wherein the method further comprises:
receiving, from the imaging device in communication with the first processor, a captured image of each different luggage item of the traveling passenger name associated with the PNR number, prior to departing a luggage pickup location.

72. The non-transitory computer readable medium of claim 65, wherein the method further comprises, prior to the obtaining:
registering, by at least one of the at least one second processor, a passenger with the multi-mode baggage handling service; and
generating, by at least one of the at least one second processor, a GTE-BSM comprising a passenger name of the registered passenger and the unique identifier, wherein the unique identifier comprises a GMMT bag tag number representative of the GMMT code indicum, and
wherein the GMMT bag tag number comprises a permanently assigned license plate compatible with an IATA license plate format for a duration that expires after a predetermined useful life.

73. The non-transitory computer readable medium of claim 65, wherein the method further comprises:
automatically creating, by at least one of the at least one second processor, a luggage item manifest record from the digital GMMT data record and the PNR number.

74. The non-transitory computer readable medium of claim 72, wherein the duration is renewable and the predetermined useful life is in a range of one moth to 10 years or one month to 20 years.

75. The non-transitory computer readable medium of claim 72, wherein the predetermined useful life is coextensive with a lifetime of the registered passenger.

76. A system comprising:
at least one processor; and
at least one non-transitory, tangible memory communicatively coupled to the at least one processor, the at least one memory storing at least one instruction,
wherein the at least one processor is configured to execute the at least one instruction to:
link a global multi-mode travel (GMMT) bag tag number to at least one travel membership number for a registered passenger to access reservation information associated with at least one vehicle of travel associated with the at least one travel membership number;
collect reservation information in a registered passenger profile linked to the GMMT bag tag number for a current travel journey of at least one luggage item to travel independently of or parallel to the registered passenger; and
build a baggage travel journey record (BTJR) for pickup and delivery of the at least one luggage item based on the collected reservation information, wherein the BTJR is linked to the GMMT bag tag number.

77. The system of claim 76, further comprising:
an electronic acquiring device configured to acquire an electronic representation of the GMMT bag tag number on a substrate of a permanent bag tag on a first luggage item of the at least one luggage item,
wherein the at least one processor is further configured to execute the at least one instruction to:
obtain from the electronic acquiring device the electronic representation of the GMMT bag tag number;
retrieve information from at least one luggage handling field of the BTJR associated with the GMMT bag tag number; and
cause a display device to display the the retrieved information.

78. The system of claim 77, wherein the permanent bag tag comprises a GMMT code indicum comprising the GMMT bag tag number, and wherein the GMMT bag tag number is compatible with an International Air Transport Association (IATA) license plate.

79. The system of claim 78, wherein the GMMT code indicum comprises at least one code that is representative of the at least one travel membership number.

80. The system of claim 76, wherein the at least one travel membership number comprises one or more of:
a frequent flyer number of an airline company;
a hotel membership number of a hotel company;
a rental car membership number of a rental car company; or
a cruise line membership number of a cruise line company.

81. The system of claim 80, wherein the at least one processor is further configured to execute the at least one instruction to:
collect the reservation information by performing one or more of:
querying a reservation system associated with the airline company for a destination airport location of a baggage travel journey;
querying a reservation system associated with the hotel company for a hotel reservation location for the baggage travel journey; or
querying a reservation system associated with the cruise line company for a cruise reservation location for the baggage travel journey; and
populate the BTJR with one or more of the destination airport location, the hotel reservation location, or the cruise reservation location.

82. The system of claim 76, further comprising:
an electronic acquiring device configured to acquire an electronic representation of the GMMT bag tag number from a permanent bag tag on a first luggage item of the at least one luggage item, and to send the electronic representation of the GMMT bag tag number, location data, and a time stamp of the electronic acquiring device to the registered passenger profile,
wherein the location data is representative of a current location of the first luggage item at the time the GMMT bag tag number is acquired.

83. The system of claim 76, wherein the at least one processor is further configured to execute the at least one instruction to:
perform data analytics to push advertisements to a mobile communication device associated with the registered passenger.

84. The system of claim 76, wherein the at least one processor is further configured to execute the at least one instruction to:
link the GMMT bag tag number to an International Air Transport Association (IATA) license plate number for a leg of travel in the current travel journey; and
link the GMMT bag tag number to a passenger name record (PNR) number of a reservation system for the leg of travel associated with the current travel journey.

85. The system of claim 76, wherein the at least one processor is further configured to execute the at least one instruction to:
assign a tracking device to a first luggage item of the at least one luggage item of the registered passenger.

86. A method comprising:
linking, by at least one of at least one processor, a global multi-mode travel (GMMT) bag tag number to at least one travel membership number for a registered passenger to access reservation information associated with at least one vehicle of travel associated with at least one travel membership number;
collecting, by at least one of the at least one processor, reservation information, in a registered passenger profile linked to the GMMT bag tag number, for a current travel journey of at least one luggage item to travel independently of or parallel to the registered passenger; and
building, by at least one of the at least one processor, a baggage travel journey record (BTJR) for pickup and delivery of the at least one luggage item based on the collected reservation information, wherein the BTJR is linked to the GMMT bag tag number.

87. The method of claim 86, further comprising:
obtaining from an electronic acquiring device, by at least one of the at least one processor, an electronic representation of the GMMT bag tag number on a permanent bag tag;
retrieving, by at least one of the at least one processor, information from at least one luggage handling field of the BTJR associated with the GMMT bag tag number; and
causing, by at least one of the at least one processor, a display device to display the retrieved information.

88. The method of claim 87, wherein the permanent bag tag comprises a GMMT code indicum that comprising the GMMT bag tag number, and wherein the GMMT bag tag number is compatible with an International Air Transport Association (IATA) license plate.

89. The method of claim 88, wherein the GMMT code indicum comprises at least one code that is representative of the at least one travel membership number.

90. The method of claim 86, wherein the at least one travel membership number comprises one or more of:
a frequent flyer number of an airline company;
a hotel membership number of a hotel company;
a rental car membership number of a rental car company; or
a cruise line membership number of a cruise line company.

91. The method of claim 90, wherein the collecting the reservation information comprises:
querying, by at least one of the at least one processor, a reservation system associated with the airline company for a destination airport location of a baggage travel journey;
querying, by at least one of the at least one processor, a reservation system associated with the hotel company for a hotel reservation location for the baggage travel journey; or
querying, by at least one of the at least one processor, a reservation system associated with the cruise line company for a cruise reservation location for the baggage travel journey; and
wherein the method further comprises:
populating, by at least one of the at least one processor, the BTJR with one or more of the destination airport location, the hotel reservation location, or the cruise reservation location.

92. The method of claim 86, further comprising:
obtaining, by at least one of the at least one processor, an electronic representation of the GMMT bag tag number acquired by an electronic acquiring device, wherein the GMMT bag tag number is associated with a permanent bag tag on a first luggage item of the at least one luggage item of the registered passenger, location data, and a time stamp of the electronic acquiring device to the registered passenger profile,
wherein the location data is representative of a current location of the first luggage item at the time the GMMT bag tag number is acquired.

93. The method of claim 86, further comprising:
performing, by at least one of the at least one processor, data analytics to push advertisements to a mobile communication device associated with the registered passenger.

94. The method of claim 86, further comprising:
linking, by at least one of the at least one processor, the GMMT bag tag number to an International Air Transport Association (IATA) license plate number for a leg of travel in the current travel journey; and
linking, by at least one of the at least one processor, the GMMT bag tag number to a passenger name record (PNR) number of a reservation system for the leg of travel associated with the current travel journey.

95. The method of claim 86, further comprising:
assigning, by at least one of the at least one processor, a tracking device to a first luggage item of the at least one luggage item of the registered passenger.

96. A non-transitory computer readable medium having instructions stored therein, which when executed by at least one processor cause the at least one processor to execute a method comprising:
linking, by at least one of at least one processor, a global multi-mode travel (GMMT) bag tag number to at least one travel membership number for a registered passenger to access reservation information associated with at least one vehicle of travel associated with at least one travel membership number;
collecting, by at least one of the at least one processor, reservation information, in a registered passenger profile linked to the GMMT bag tag number, for a current travel journey of at least one luggage item to travel independently of or parallel to the registered passenger; and
building, by at least one of the at least one processor, a baggage travel journey record (BTJR) for pickup and delivery of the at least one luggage item based on the collected reservation information, wherein the BTJR is linked to the GMMT bag tag number.

97. The non-transitory computer readable medium of claim 96, wherein the method further comprises:
obtaining from an electronic acquiring device, by at least one of the at least one processor, an electronic representation of the GMMT bag tag number on a permanent bag tag;
retrieving, by at least one of the at least one processor, information from at least one luggage handling field of the BTJR associated with the GMMT bag tag number; and
causing, by at least one of the at least one processor, a display device to display the retrieved information.

98. The non-transitory computer readable medium of claim 97, wherein the permanent bag tag comprises a GMMT code indicum that comprising the GMMT bag tag number, and wherein the GMMT bag tag number is compatible with an International Air Transport Association (IATA) license plate.

99. The non-transitory computer readable medium of claim 98, wherein the GMMT code indicum comprises at least one code that is representative of the at least one travel membership number.

100. The non-transitory computer readable medium of claim 96, wherein the at least one travel membership number comprises one or more of:
a frequent flyer number of an airline company;
a hotel membership number of a hotel company;
a rental car membership number of a rental car company; or
a cruise line membership number of a cruise line company.

101. The non-transitory computer readable medium of claim 100,
wherein the collecting the reservation information comprises:
querying, by at least one of the at least one processor, a reservation system associated with the airline company for a destination airport location of a baggage travel journey;
querying, by at least one of the at least one processor, a reservation system associated with the hotel company for a hotel reservation location for the baggage travel journey; or
querying, by at least one of the at least one processor, a reservation system associated with the cruise line company for a cruise reservation location for the baggage travel journey; and
wherein the method further comprises:
populating, by at least one of the at least one processor, the BTJR with one or more of the destination airport location, the hotel reservation location, or the cruise reservation location.

102. The non-transitory computer readable medium of claim 96, wherein the method further comprises:
obtaining, by at least one of the at least one processor, an electronic representation of the GMMT bag tag number acquired by an electronic acquiring device, wherein the GMMT bag tag number is associated with a permanent bag tag on a first luggage item of the at least one luggage item of the registered passenger, location data, and a time stamp of the electronic acquiring device to the registered passenger profile,
wherein the location data is representative of a current location of the first luggage item at the time the GMMT bag tag number is acquired.

103. The non-transitory computer readable medium of claim 96, wherein the method further comprises:
performing, by at least one of the at least one processor, data analytics to push advertisements to a mobile communication device associated with the registered passenger.

104. The non-transitory computer readable medium of claim 96, wherein the method further comprises:
linking, by at least one of the at least one processor, the GMMT bag tag number to an International Air Transport Association (IATA) license plate number for a leg of travel in the current travel journey; and
linking, by at least one of the at least one processor, the GMMT bag tag number to a passenger name record (PNR) number of a reservation system for the leg of travel associated with the current travel journey.

105. The non-transitory computer readable medium of claim 96, wherein the method further comprises:
assigning, by at least one of the at least one processor, a tracking device to a first luggage item of the at least one luggage item of the registered passenger.
